(19) United States
(12) Patent Application Publication
(10) Pub. No.: US 2025/0311667 A1
(43) Pub. Date: Oct. 9, 2025

(54) Weed Whacker Attachment for a Riding Lawn Mower

(71) Applicant: Dennis DeLauter, Boulder, CO (US)

(72) Inventor: Dennis DeLauter, Boulder, CO (US)

(21) Appl. No.: 18/629,885

(22) Filed: Apr. 8, 2024

Related U.S. Application Data
(62) Division of application No. 17/175,560, filed on Feb. 12, 2021, now Pat. No. 11,980,128.
(60) Provisional application No. 62/975,720, filed on Feb. 12, 2020.

(51) Int. Cl. A01D 34/416; A01D 34/64; A01D 101/00

(52) U.S. Cl. CPC A01D 34/4165; A01D 34/64; A01D 2101/00

(57) ABSTRACT

A weed whacker attaches to the front of a riding lawn mower. The week whacker is attached to the riding lawn mower through a pivoting linkage, and is supported on castors which may be adjustable in height. The weed whacker may thereby traverse uneven terrain which differs from the terrain traversed by the riding lawn mower, continuing to provide an even cut over the terrain. The weed whacker draws its power from the riding lawn mower. The weed whacker may be shifted between the right and left sides of the riding lawn mower. The weed whacker may be controlled by the driver of the riding lawn mower, including unwinding additional cutting wire in response to a control signal from a controller used by the driver of the riding lawn mower.

### CROSS-REFERENCE TO RELATED APPLICATION

This application is a divisional of U.S. patent application Ser. No. 17/175,560, which was filed on Feb. 12, 2021, and entitled “Weed Whacker Attachment for a Riding Lawn Mower,” which claims the benefit of U.S. provisional patent application Ser. No. 62/975,720, which was filed on Feb. 12, 2020 and entitled “The weed whacker.”

### FIELD OF THE INVENTION

The present invention relates to lawn care. More specifically, a week whacker that attaches to the front of a lawn mower, and which can pivot with respect to the lawn mower to accommodate uneven terrain, is provided.

### BACKGROUND INFORMATION

Lawn mowing and weed whacking are typically performed as separate activities, with handheld weed whackers being used to trim grass in locations that may be difficult to reach with the blade of a lawn mower. There is a need for a weed whacker that can be operated simultaneously with operation of a riding lawn mower, by the operator of the riding lawn mower. There is a further need for this week whacker to automatically traverse uneven terrain, providing an even cut over uneven terrain as the riding lawn mower is used simultaneously.

### SUMMARY

The present invention is designed with a purpose to allow people to mow their lawn and perform precision trimming all in one pass completely redefining the way lawns have been mowed for decades. Some examples of the weed whacker remove human error by naturally adjusting to different angled terrain; moving separately from the lawn mower through multiple pivot points providing instantaneous adjustments, while keeping trimmer cut diameter parallel with the land which allows the operator to remotely fine tune (but not limited) taper cut angle, string length, speed (rpm) of cutting string, and rapid width extension to reach tight spaces without changing cutting direction of mower. Multiple locations built into the natural adjusting movement of some examples of the weed whacker provide shock absorbing impact points to protect and extend overall life cycle of the machine. Other examples of the week whacker include operator friendly adjustments to provide a variety of options and simple solutions to quickly change trimmer cut height, such as: quickly switch from right to left trimming/cut orientation, width adjustments to change the center of trimmer cut position relative to a variety of mower deck widths, and adjustable height and frame mounting brackets to fit a variety of different mowers, etc.

Some examples of the weed whacker are located conveniently at the front of the mower, which allows the operator to hold a natural posture, with eyes and head forward-keeping their line of sight in their mid-peripherals. Unlike traditional hand trimmers mounted to mower cutting decks or behind the mower/tractor, the weed whacker's front installation gives the operator the ability to hold a healthy head/neck posture to naturally absorb external forces one might experience while mowing a variety of terrain.

The weed whacker's design provides an “all in one” solution to tackle mowing jobs with less time; this is in part due to the following key components. One example includes a precision trimmer system capable of absorbing impacts while naturally coasting and adjusting cut angle-increases cut quality while also making precision trimming easier for operator. Another example includes a refined trimmer spool drive system that allows the user to extend and rewind string length by wireless/wired controls—this eliminates the need to manually adjust string length. A further example includes a refined caster assembly gives the operator the ability to rapidly adjust wheel height to mower deck height to allow the user to fine tune cut height quickly. Yet another example includes a system to adjust dimensions of the weed whacker by width adjustment and quick release locking pins. This width allows for quick install and use on various equipment. A further example includes a controller which allows for the operator to fine tune cutting mechanics and overall precision of weed whacker.

### BRIEF DESCRIPTION OF THE DRAWINGS

FIG. 1—Side view of the weed whacker and zero turn mower. Both the mower and The weed whacker operating on level ground with the trimming orientation set for right side cutting. External Trim Head in level cutting position A1a with both coaster assembly A2 casters A3a/A4a set to the highest cut height setting.

FIG. 2—Side view of the weed whacker and mower. Set up for right side cutting. Internal Trim Head in tapered cut position Alb with both casters set to highest height setting. Main A A13a is level with coaster assembly level A2a. Mower/Zero Turn A15 turn shown with electric brakes for steering C2d/C24 and stopping C13b.

FIG. 3—Front angle view of the weed whacker and mower set up for right side cutting A11r. Internal Trim Head A1a is in a level position with both casters A3a/A4a set to the highest height setting. Main A A13a is level, Coaster Assembly A2a is parallel with the mower A15 and Main A A13a.

FIG. 4—Rear angle view of the weed whacker set up on right side A11r of mower, demonstrating the weed whacker starting to go up a hill while zero turn is still on level land. Main A A13c is pivoted upward leading with caster A12c. Coaster assembly A2 is level with Main A A13.

FIG. 5—Front angle view of the weed whacker set up for right side cutting on mower. The weed whacker is starting to go up a hill leading with caster A12c while zero turn mower is still on level terrain. Coaster assembly A2 is parallel with main a A13c. FIG. 5 shows caster A12c and coaster casters A3a/A4a using lines to demonstrate ground movement for natural flow.

FIG. 6—Front angle view of the weed whacker mounted on its right side A11r of mower while starting to go down a hill while zero turn is still on level terrain. Main A A13b is pivoting downward leading with A12b while coaster assembly A2a is parallel with Main A A13b. Level user controlled cutting position A1a.

FIG. 7—Front angle view of the weed whacker on a mower in its left side cutting position A11l with coaster casters A3a/A4a in their highest position. The trim cut angle is even A1a with internal head. Main A A13a is level with mower A15 while coaster assembly A2a is level with main a A13a.

FIG. 8—Front angle view of the weed whacker on mower in a position that demonstrates an impact with a tree stump or large rock which would cause coaster to pivot extending spring S15b and raise a-arms A8b S30/S31. Main A A13 is level. This scenario would most likely happen on very uneven ground or if front coaster caster A3a grabs/snags an object such as tree stump, rock, deep hole, etc. By incorporating impact breaking points further explained in sections S & A, The weed whacker can absorb impacts without failing.

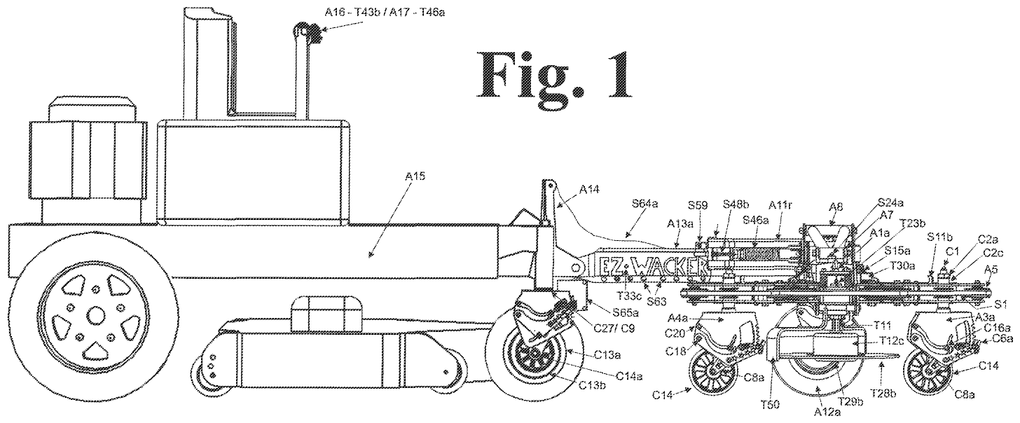

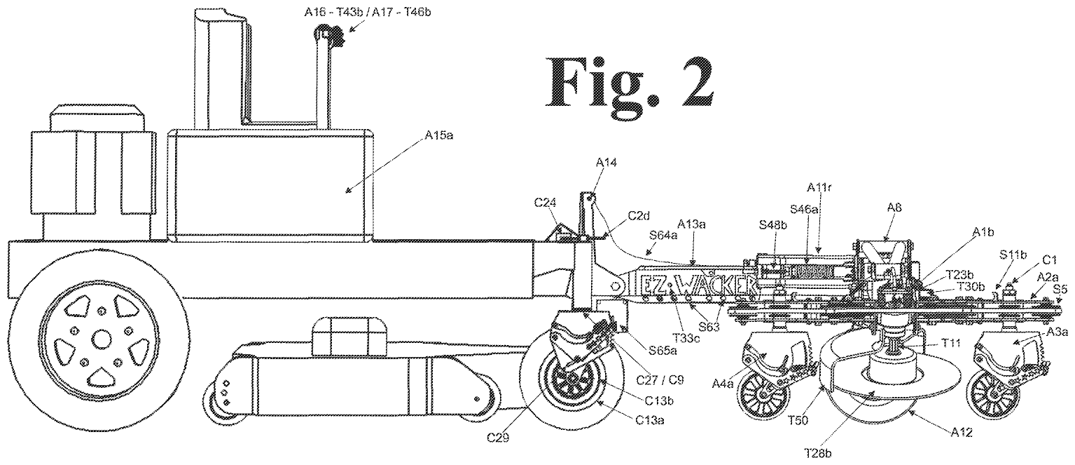

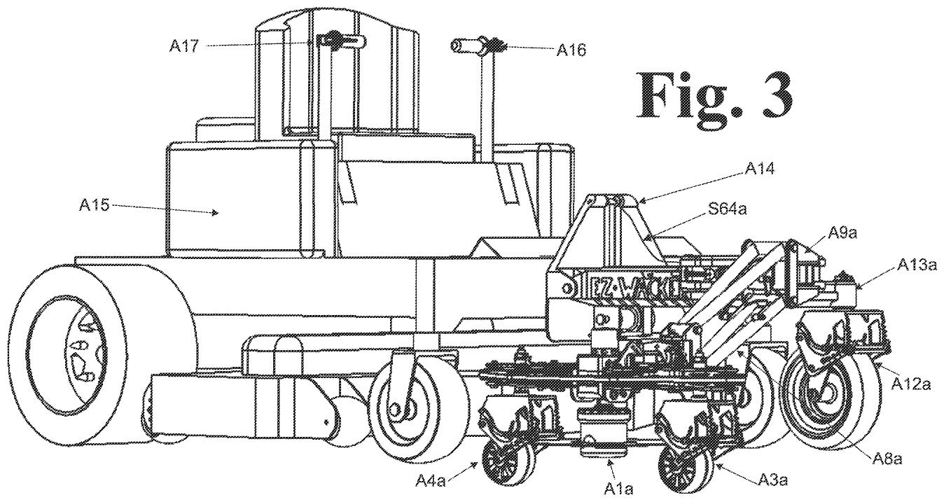

FIG. 9—Side view of the weed whacker on a mower in a position which demonstrates normal cutting position to storage/trailer/traveling mode lifted to resting point in near vertical position.
A.) Normal cutting position. Main A A13a is level with mower. Cable S64a is loose for winch S65.
B.) Main A A13d partially lifted off of ground with cable S64b from winch S65b mounted to mounting plate A14.
C.) Near vertical position for minimal wasted space in tight places, storage, transporting, or not in use. Winch S65 pulls cable S64c tight bringing Main A A13e into near vertical position.
D.) Example of mounting structure A14 which connects Main M A13 to mower A15. Demonstrates adjustable mounting holes S68 for matching tractor height frame to main caster height A12. Shows clear image of winch S65 and cable pulleys S66.

FIG. 10—Rear right side demonstrates the weed whacker with mower on a trailer in normal right side A11r cutting position with Main A A13a level with mower. Shows ability to load up on trailer without being in storage mode. Shows demonstration of trailer/transport charging A19.

FIG. 11—Front right side angle view of the weed whacker positioned on right side A11r of mower while loaded onto trailer A18 in storage/transport position as shown in FIG. 9c. Main A A13e is in near vertical position.

FIG. 12—Rear side angle view of the weed whacker mounted on right side A11r of mower on trailer A18 in storage/transport position as shown in FIG. 9C.

FIG. 13—Front angle view of the weed whacker on a quadricycle as shown in U.S. Pat. No. 8,764,040, which was issued to Dennis DeLauter on Jul. 1, 2014 (DeLauter Quadricycle). Highest cutting position is shown with a level cut angle. Main A (A13a) is level to quadricycle with coaster assembly A2 in the level position. The quadricycle allows user to lean into hillsides and get workout while cutting. Uses pedal/electric hybrid system.

FIG. 14—Front angle view of the weed whacker set at right side cut orientation A11r mounted on a DeLauter Quadricycle. The trim head is tilted to cut with a taper Alb. Main A A13a is level with the quadricycle and coaster assembly A2a is in its highest cut setting while being level with Main A A13a.

FIG. 15—Front angle view of the weed whacker on DeLauter Quadricycle. The trimmer is positioned to cut at an angle Alb while 4 wheel steering allows user to go around an object like a zero turn radius mower. By incorporating leaning into the turn while operating the quadricylce, the user does not have to rotate the wheel as far as non-leaning vehicle. Main A A13a is level with the quadricycle as coaster assembly A2a is level with the quadricycle as well.

FIG. 16—Top view of the weed whacker on a DeLauter Quadricycle with 4 wheel steering. Shows all 4 wheels of quadricycle rotating to allow zero turn like turning.

FIG. 17—Top view of the weed whacker and mower in a normal forward left side A11l cutting position. Level 1, 3, & 5 suspension are in the normal position.

FIG. 18—Top view of the weed whacker mounted on left side of mower with forward collision between coaster assembly A2 and main a caster A12. Example of object would be a pole, tree, boulder, etc. To prevent structural damage and give opportunity to operator to take control of mower, spring S46b compresses allowing suspension arms A10b to rotate towards mower A15 while keeping a-arms A8 parallel at all times so level 1, level 2, level 3, and level 4 suspension works properly.

FIG. 19—Top view of the weed whacker mounted on left side A11l of mower in a reverse collision with a pole or tree or other object in similar nature. To prevent damage level 5 suspension arms A10c/S47c rotates forward under tension from spring S48 which allows coaster assembly to extend forward to give operator an opportunity to get control of mower while assisting in pulling suspension arms S47 and A10 back into normal position as shown in FIG. 17.

FIG. 20—Top view diagram of 6 different possible collisions activating levels 1, 3, & 5 suspension in various combinations.
A.) Demonstrates a level 1 forward collision. A close up view can be found at FIG. 21D& FIG. 22B. An ideal situation would be a combination of level 1 FIG. 20A and FIG. 20D, which would allow the trimmer to pass by an object absorbing/deflecting impact while continuing to function cutting properly.
B.) Demonstrates a level 1 and level 3 forward collision. Combination of level 1 and level 3 suspension which spring S28e compresses making coaster assembly front caster A3 to move towards middle of mower putting coaster assembly in position A2j.
C.) Demonstrates a level 1, level 3, and level 5 collision activating 3 different levels of suspension absorbing impact to help prevent structural damage. Combination of level 1 suspension with belt S1b compressing S2bf while spring S28e of level 3 compresses putting coaster assembly in position A2j while main spring S46b compresses moving a-arms closer to mower A15.
D.) Demonstrates level 1 suspension during a forward or reverse collision. Pulley S2br compresses with belt S1 while level 3 and level 5 suspension stays in normal position.
E.) Demonstrates level 1, and level 3 suspension during a forward, reverse, or sideways slide impact. S2br compresses with belt S1b while level 3 spring S27d compress to put coaster assembly into position A2i. Spring S46a is in normal position.
F.) Demonstrates level 1, level 3, and level 5 suspension during a forward, reverse, or sideways slide impact. For a close up example refer to figures level 1 FIG. 21D & FIG. 22B, level 3 FIGS. 27D, 28D, & 29D and level 5 FIG. 38C, FIGS. 39C, & 40B. S2br compresses with level spring S27d compressing, while suspension arm S47 rotates away from mower extending spring S48c.

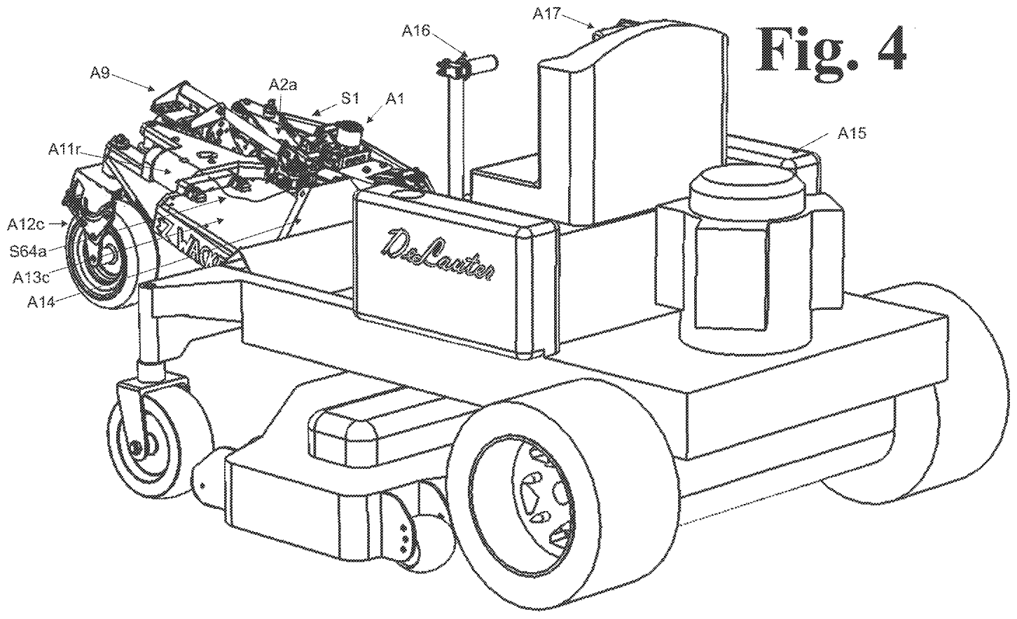

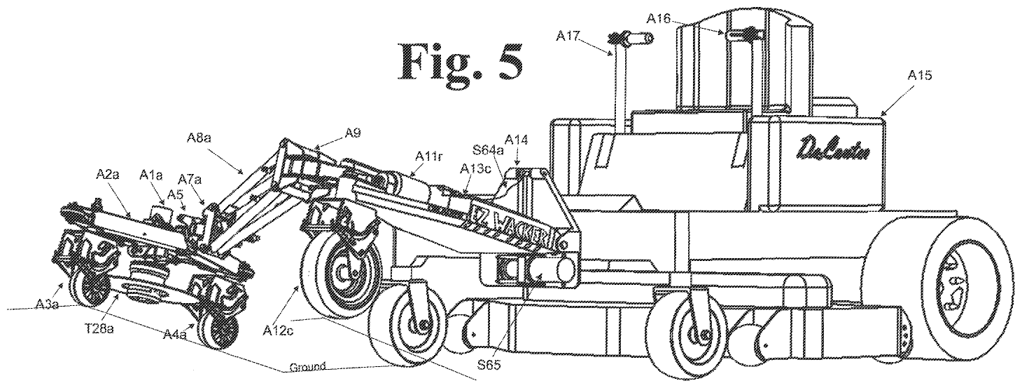

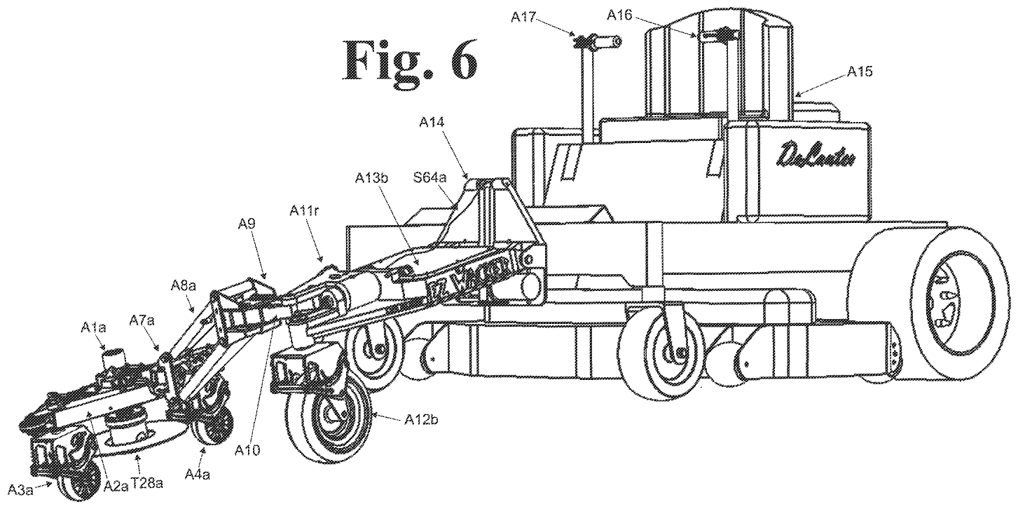

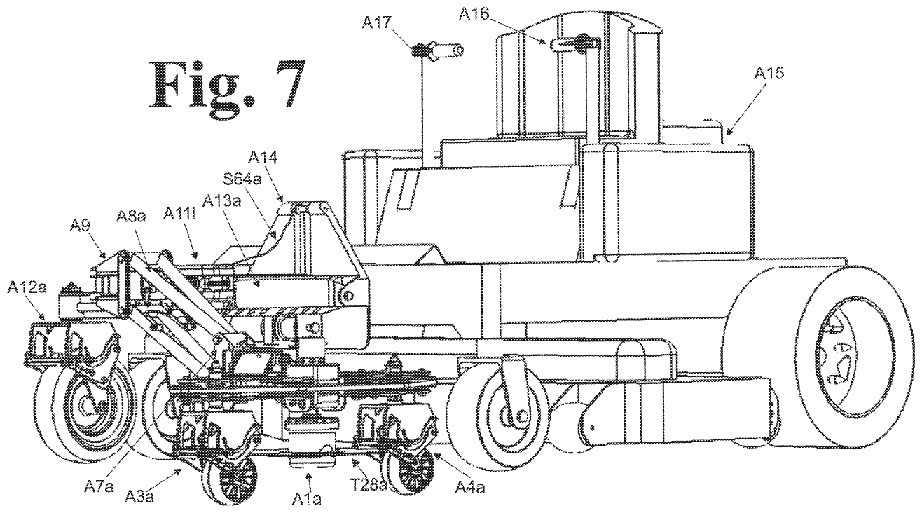

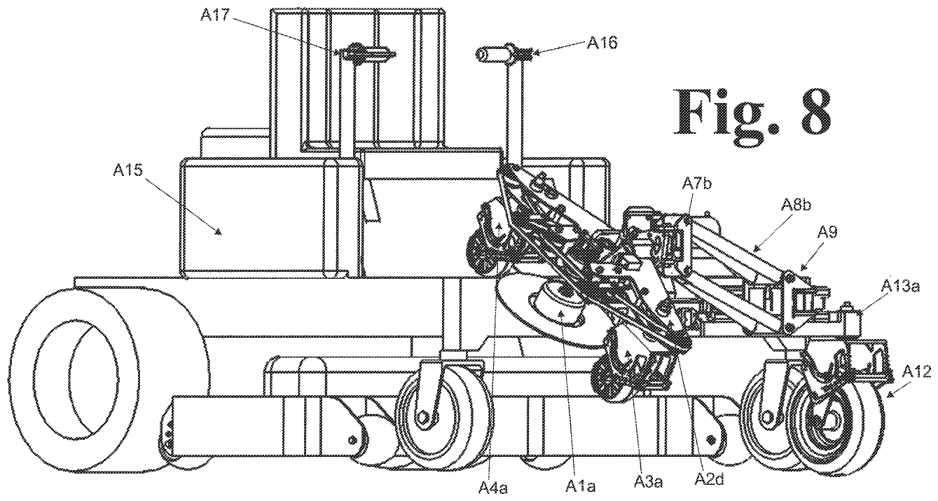

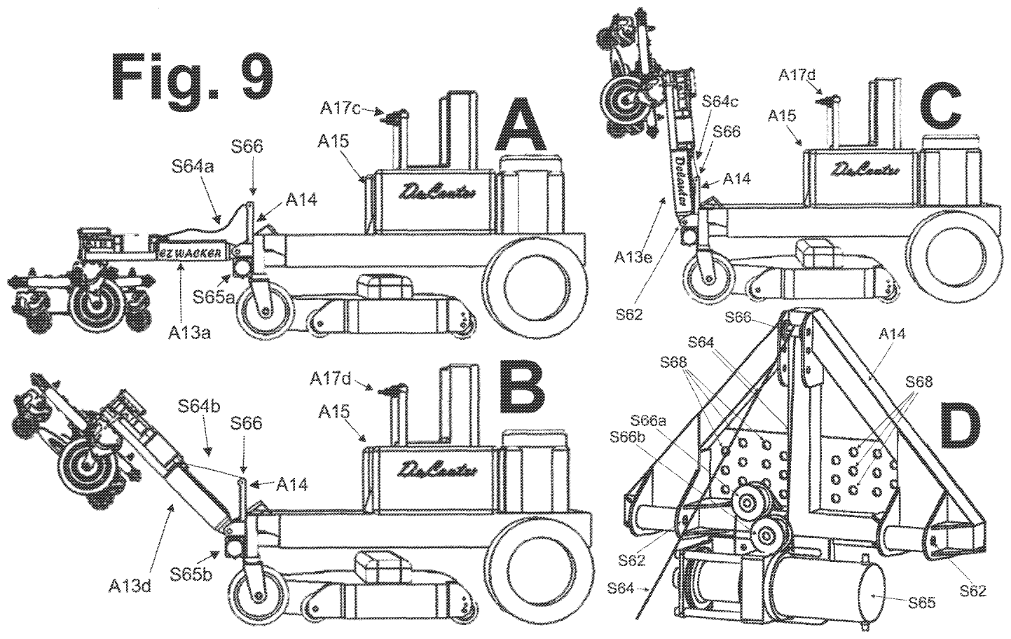

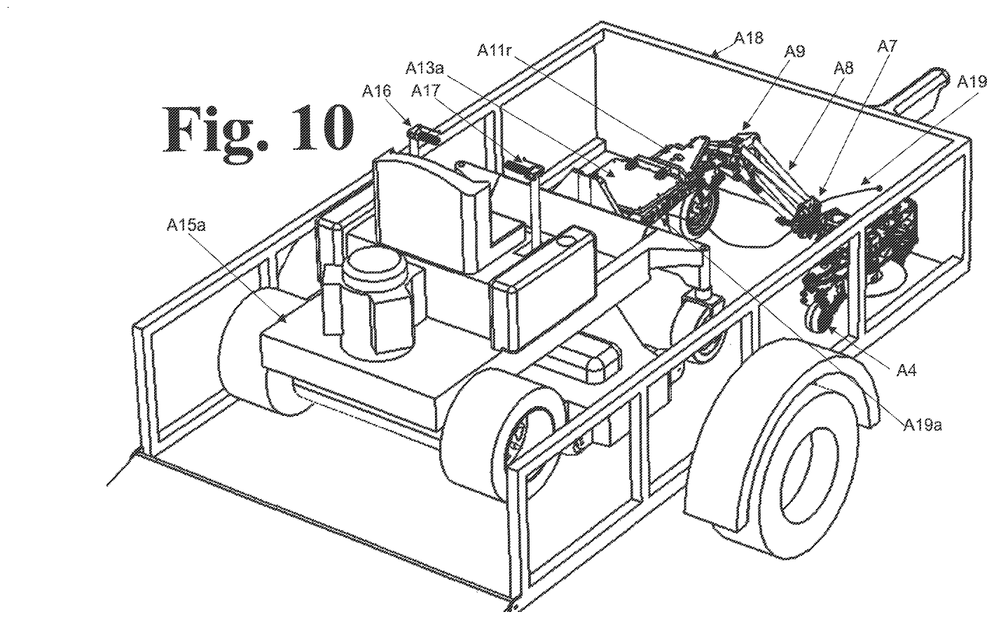

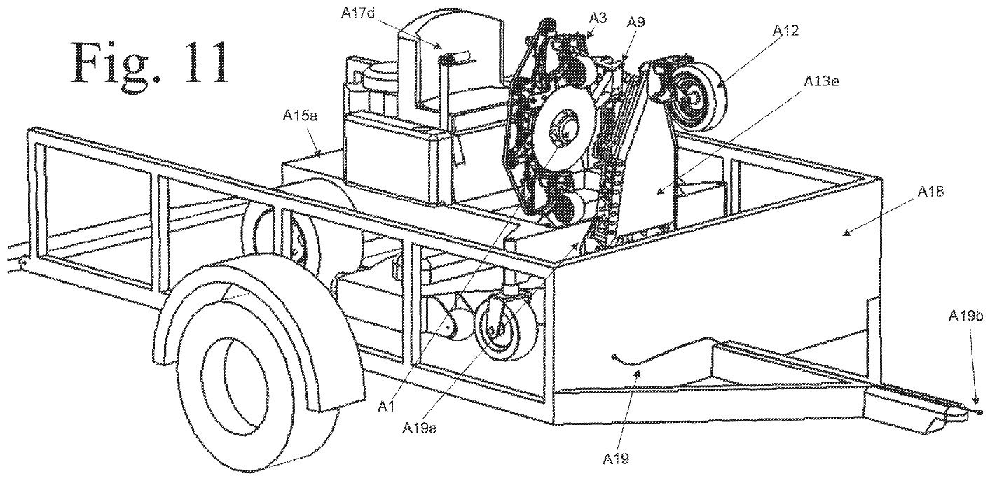

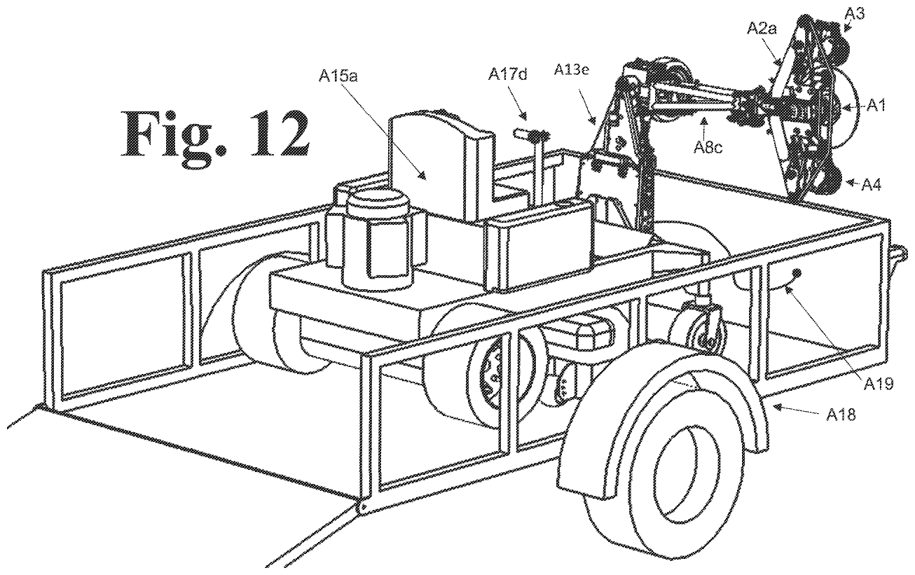

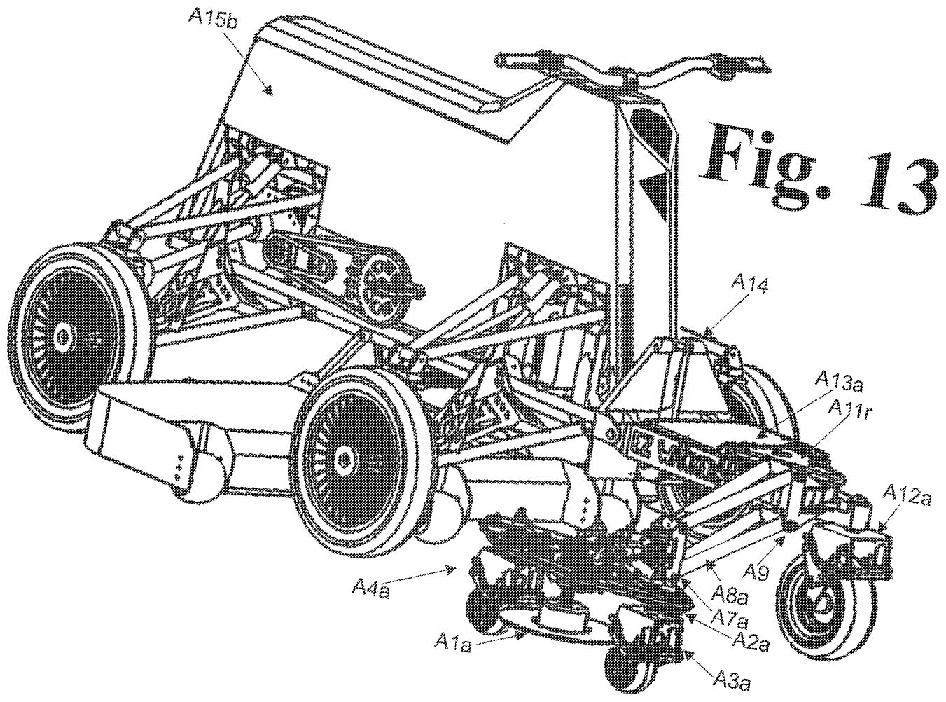

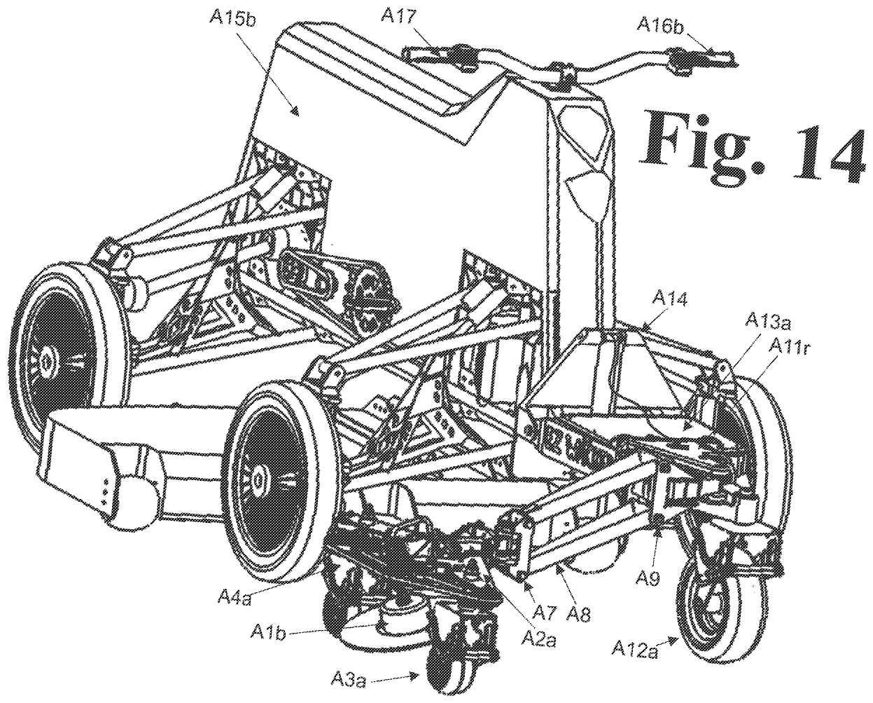

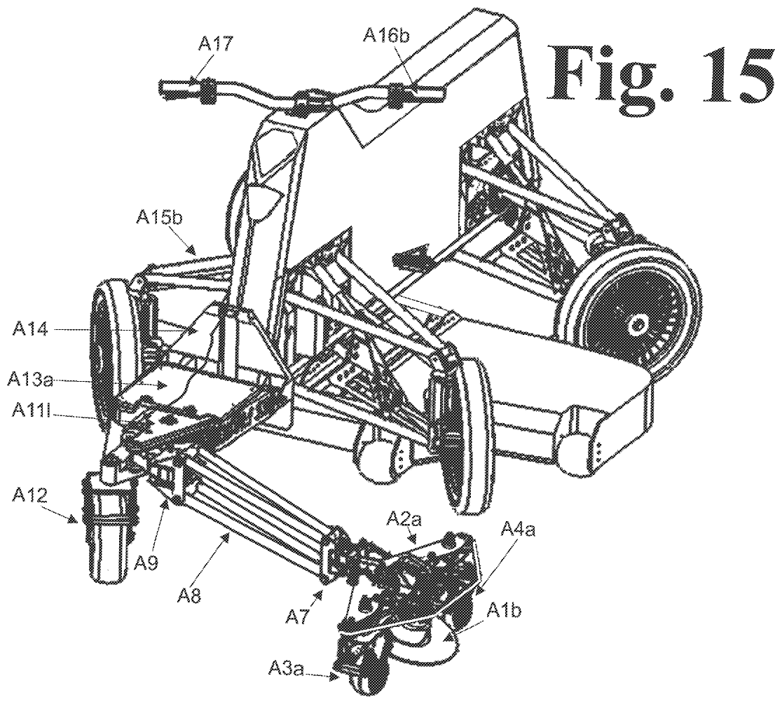

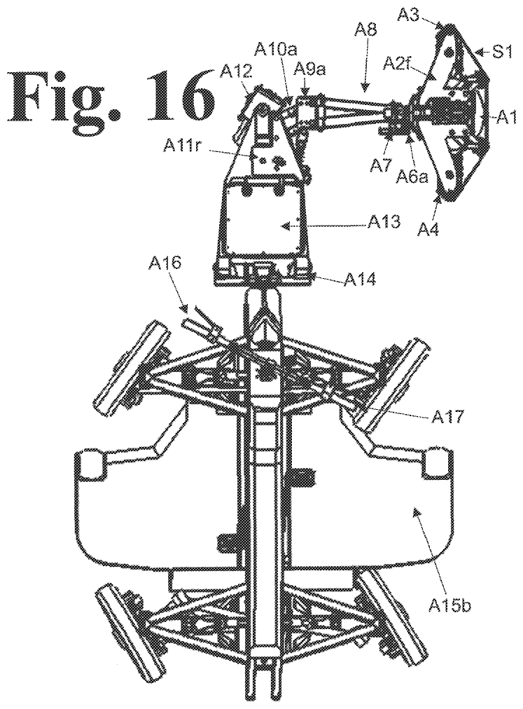

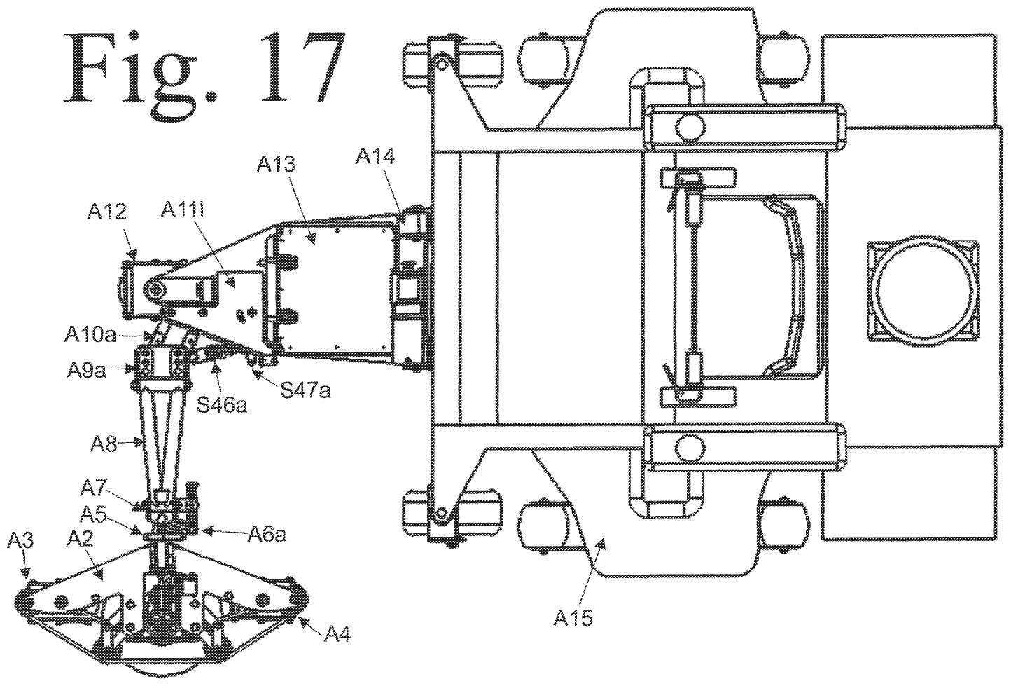

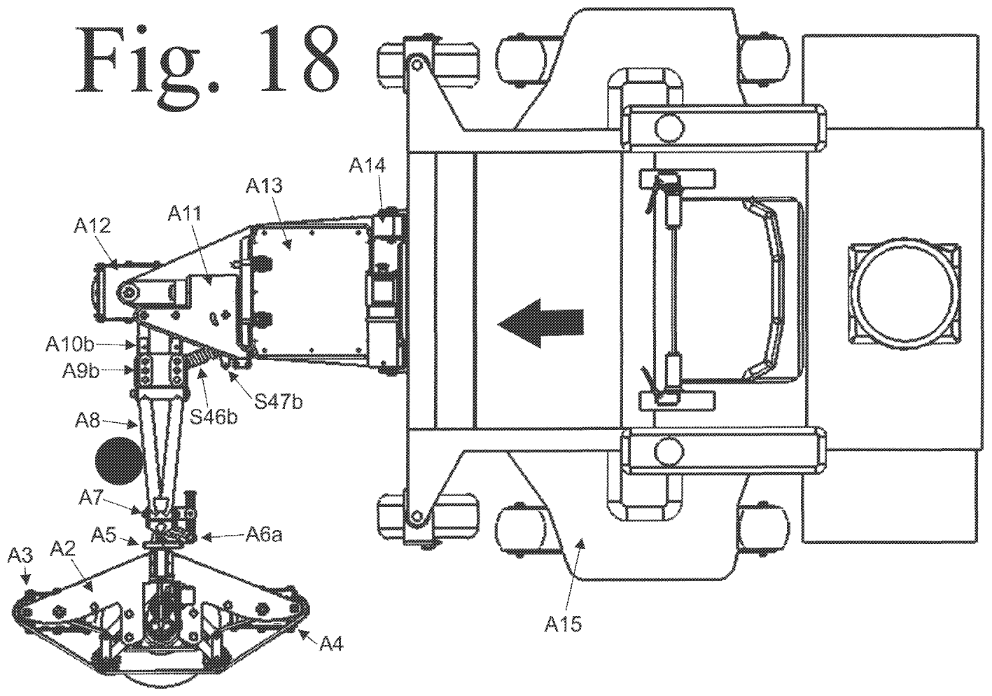

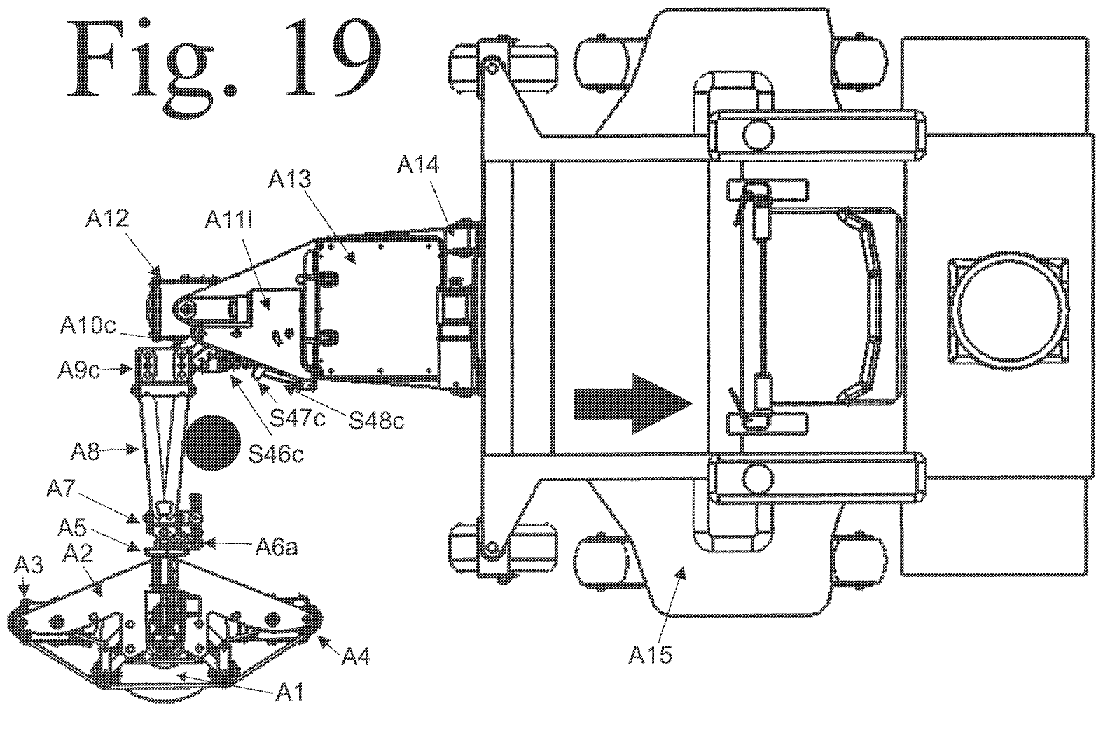

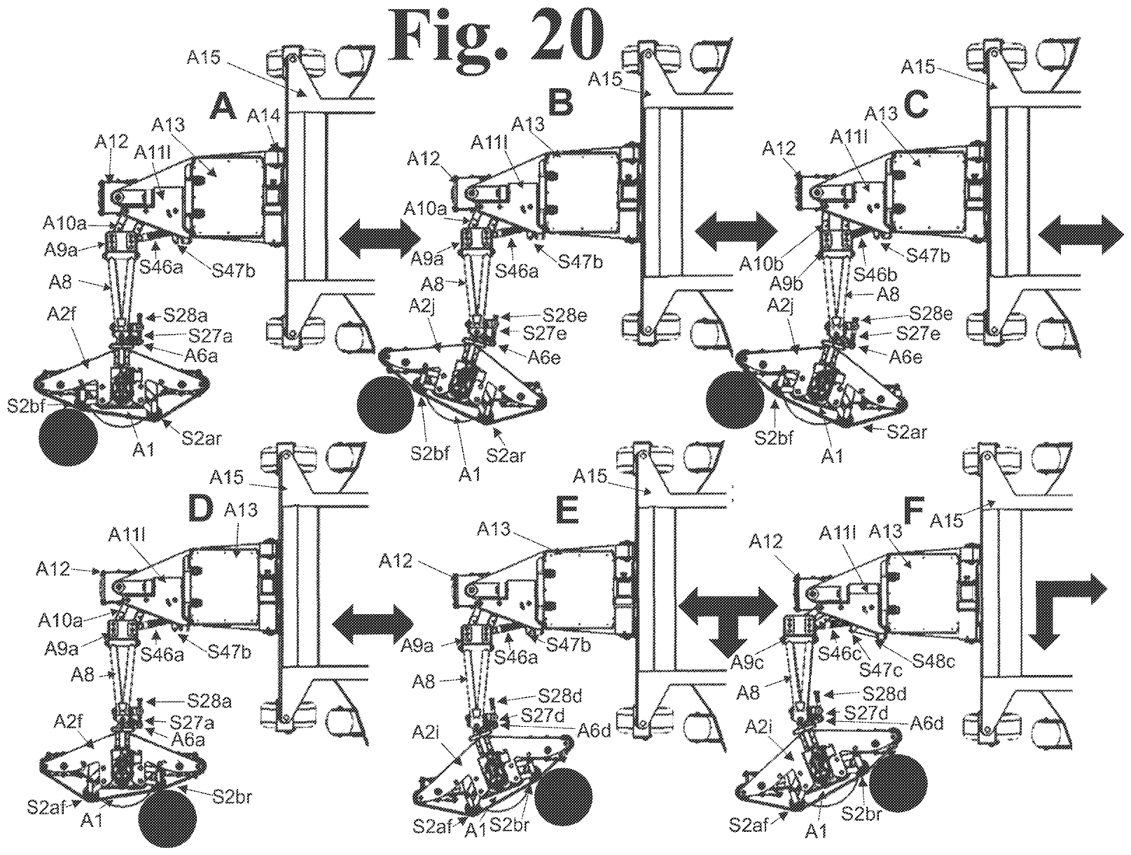

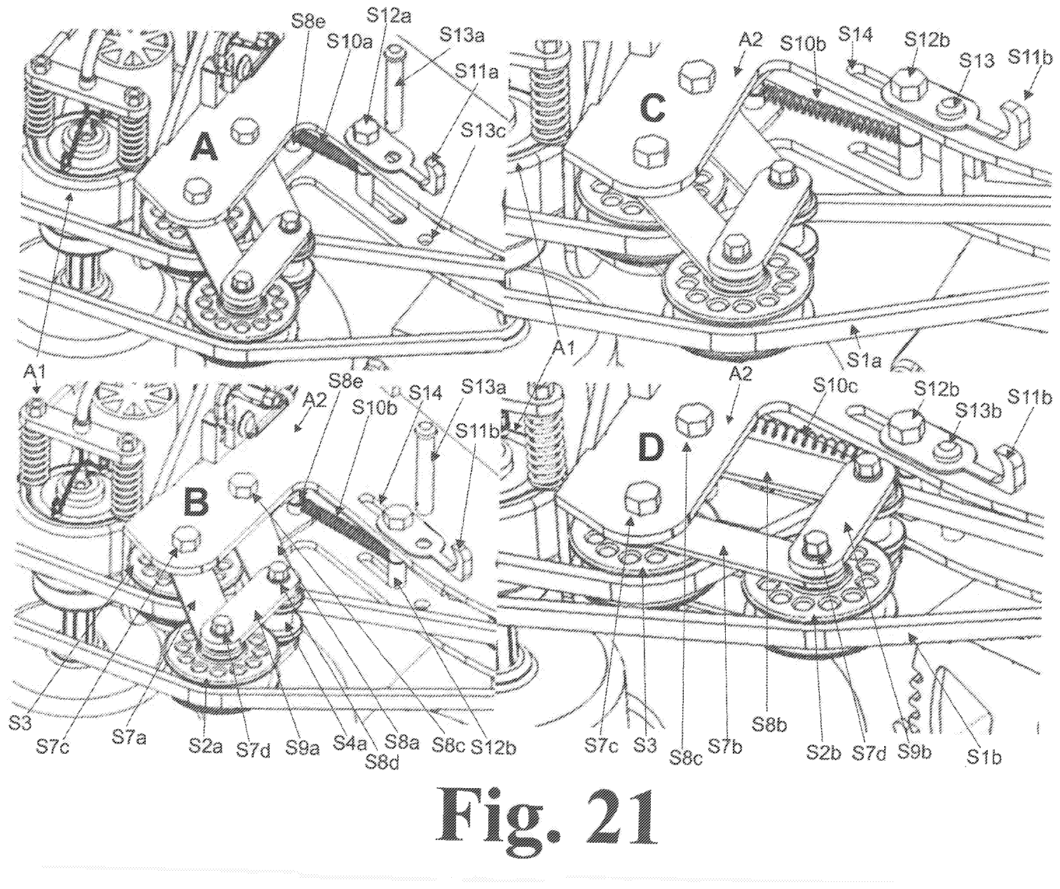

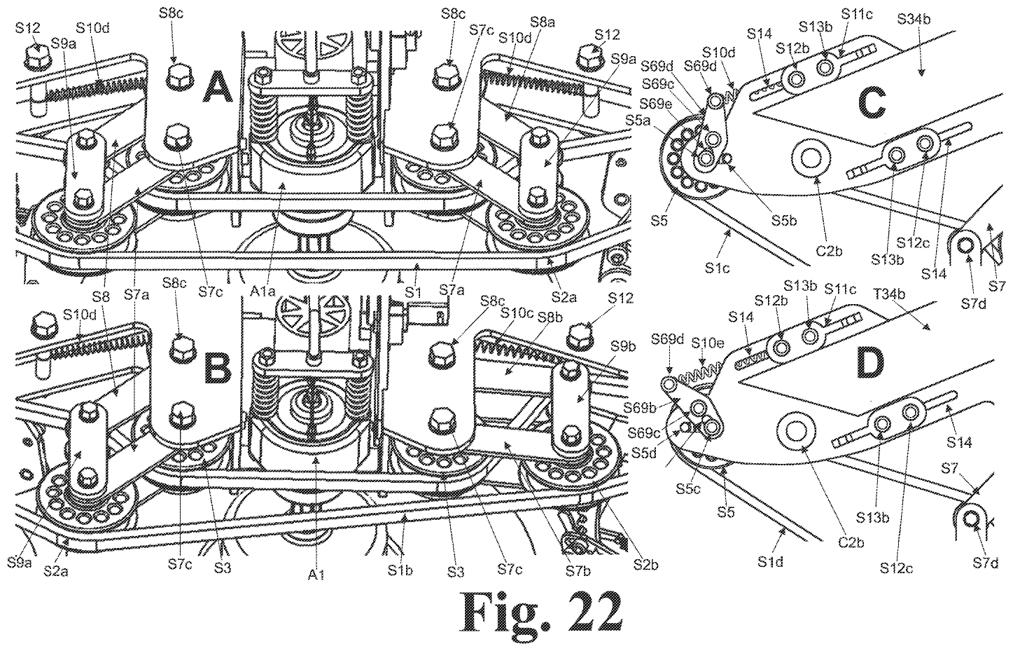

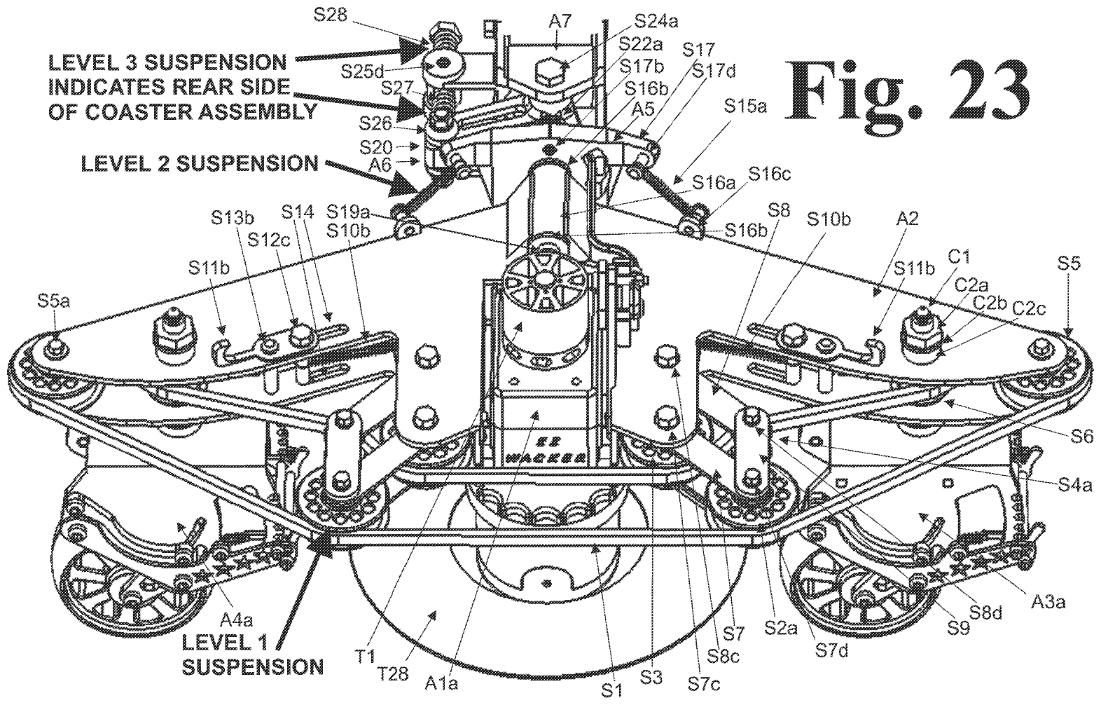

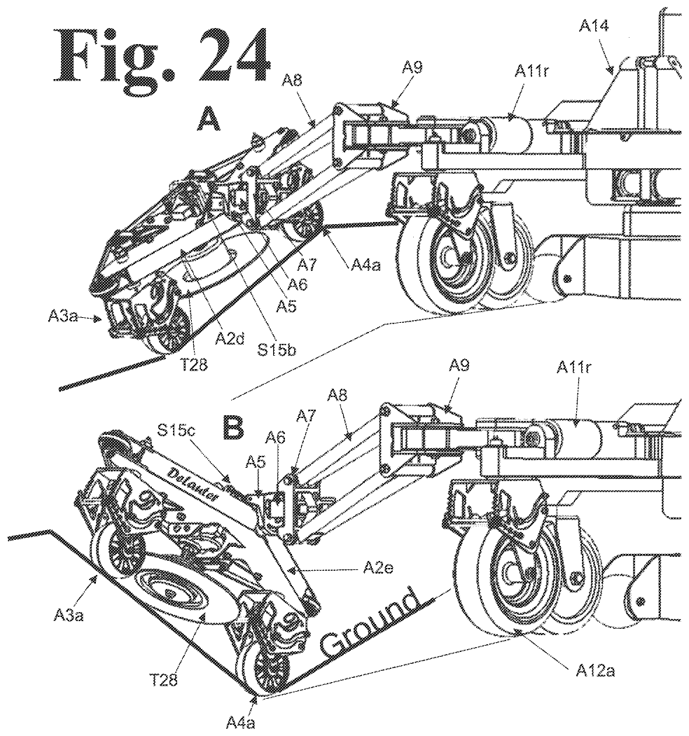

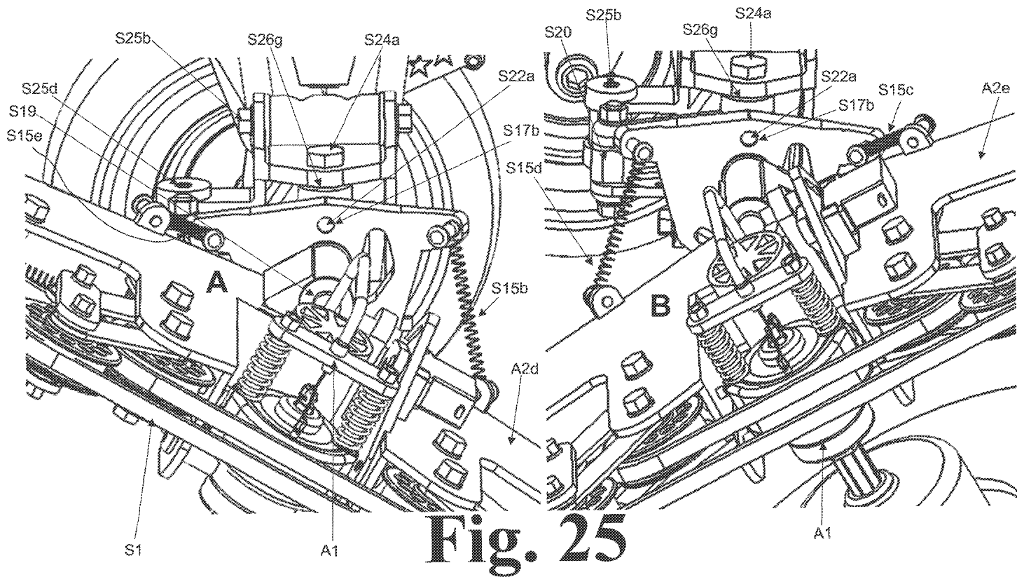

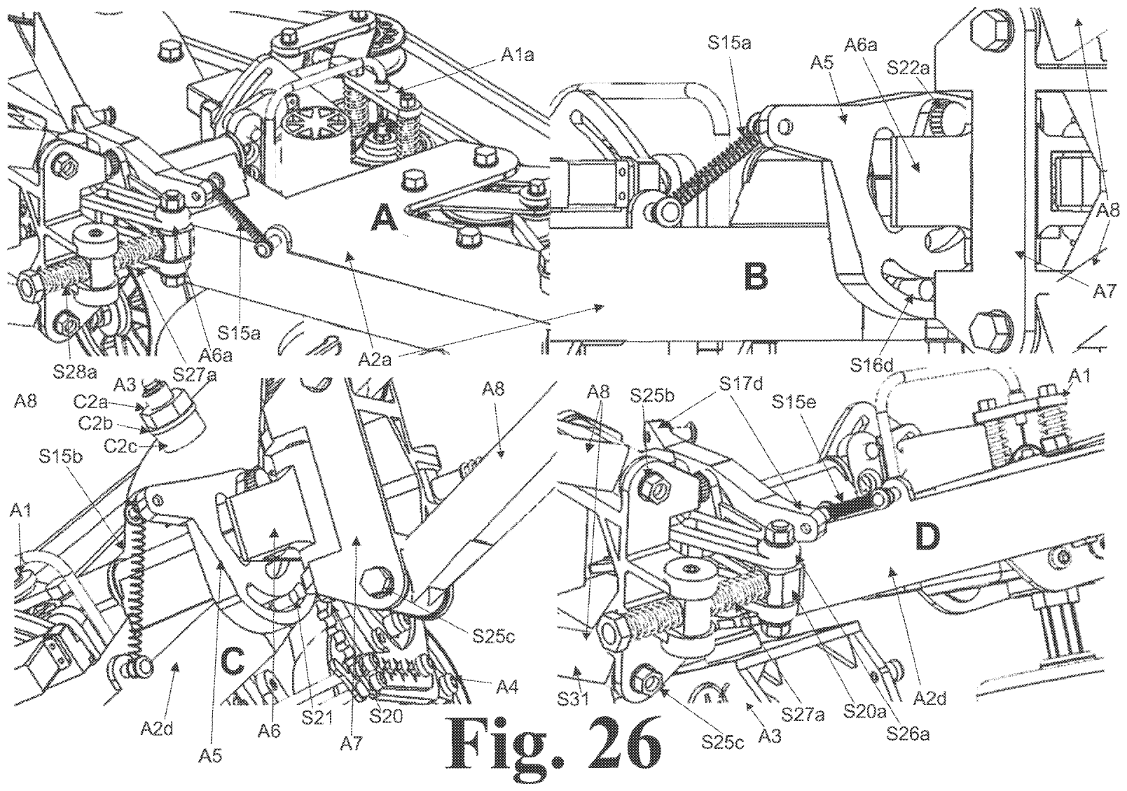

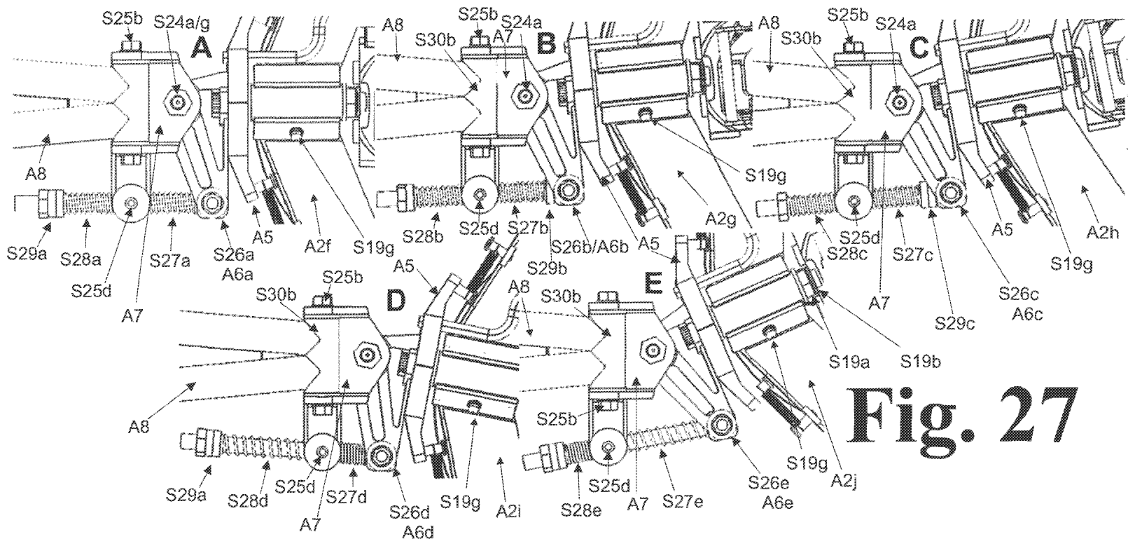

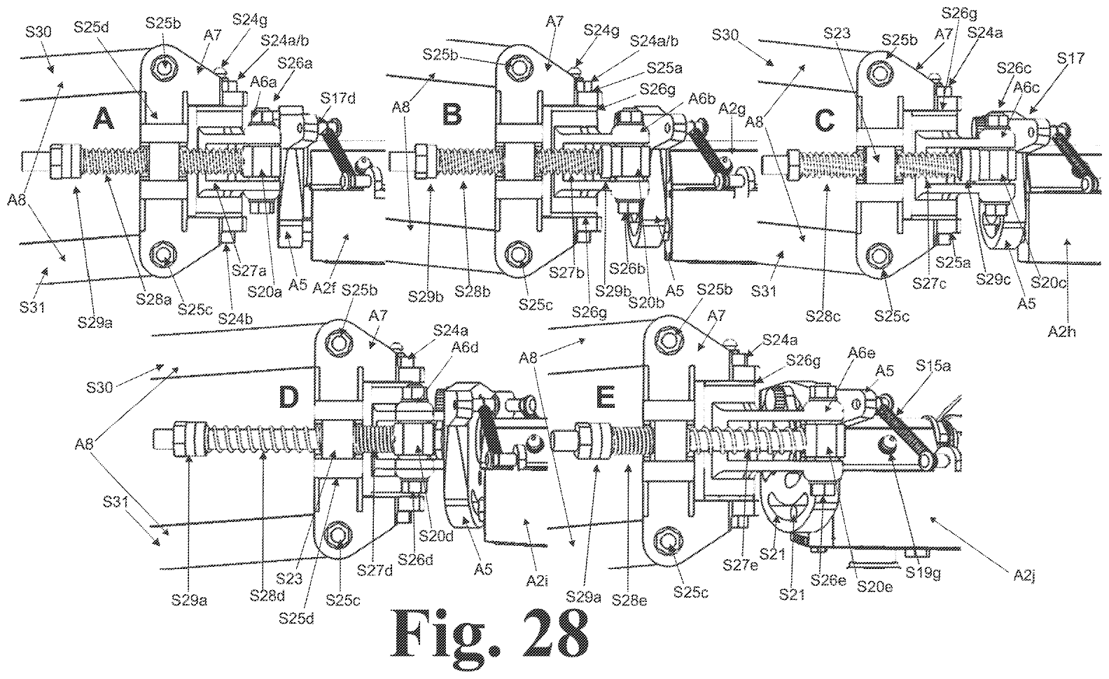

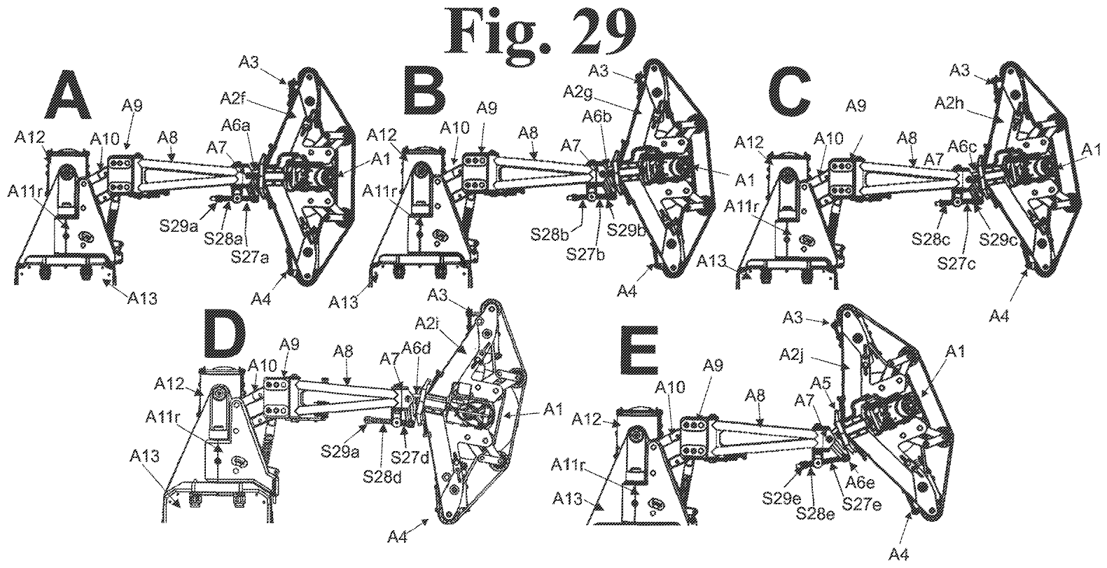

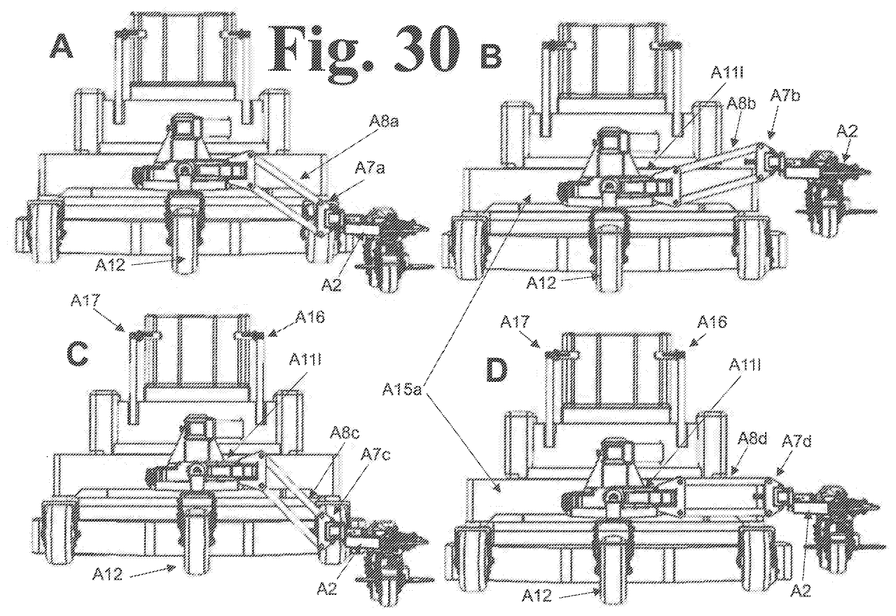

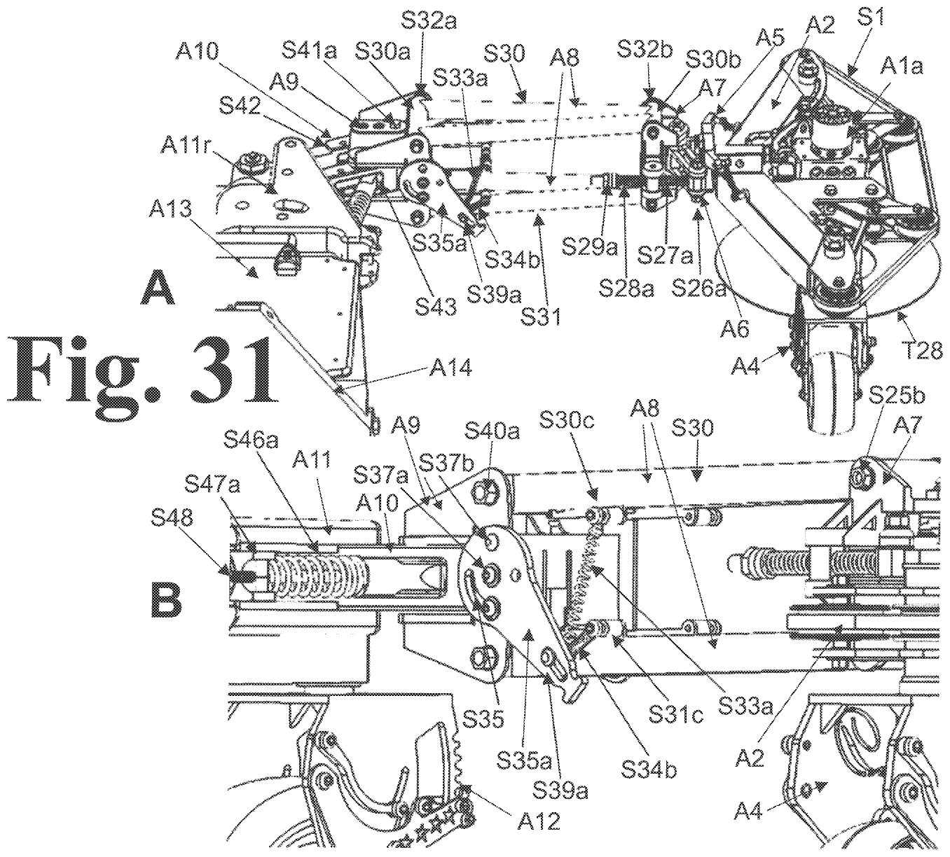

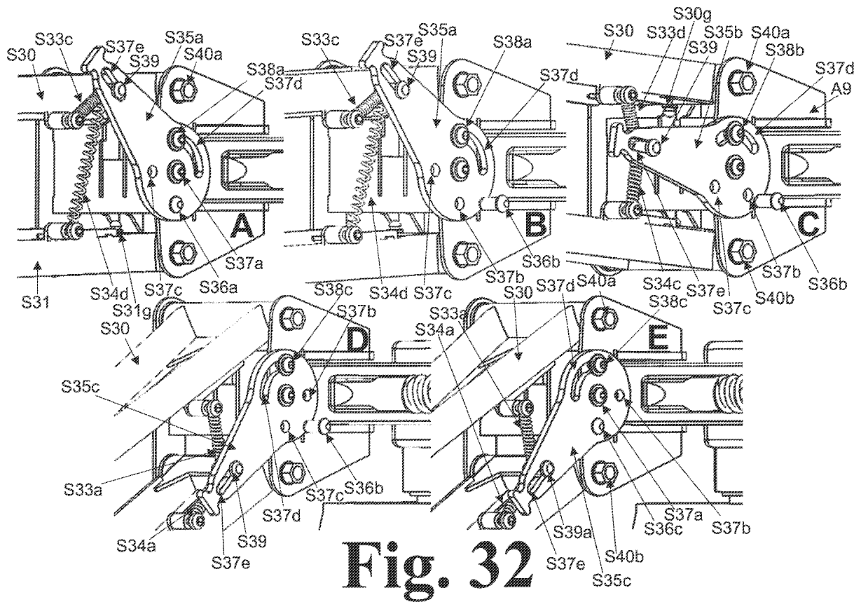

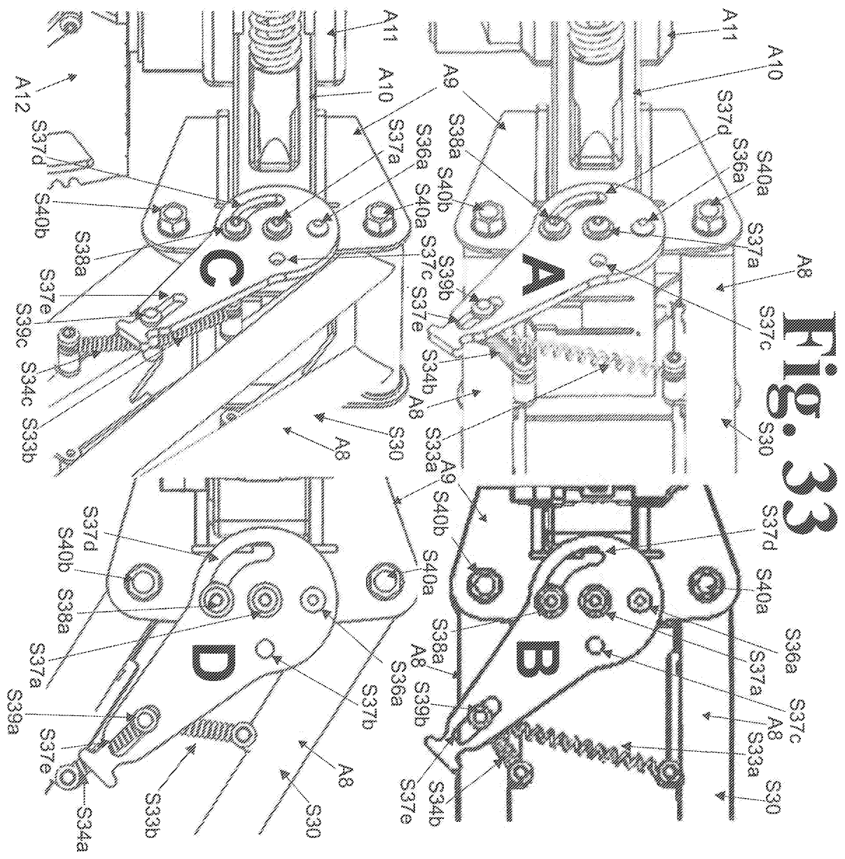

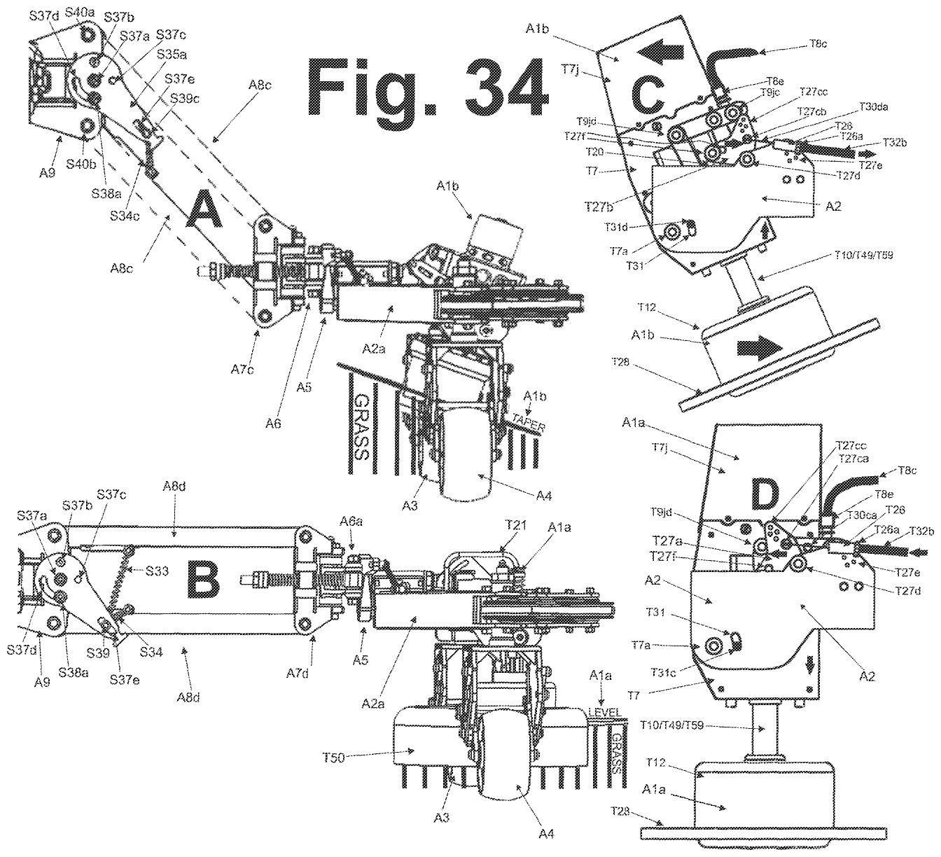

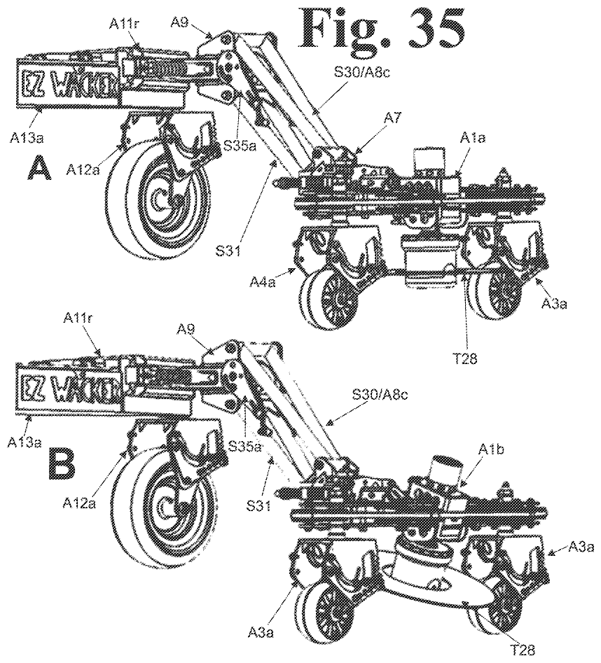

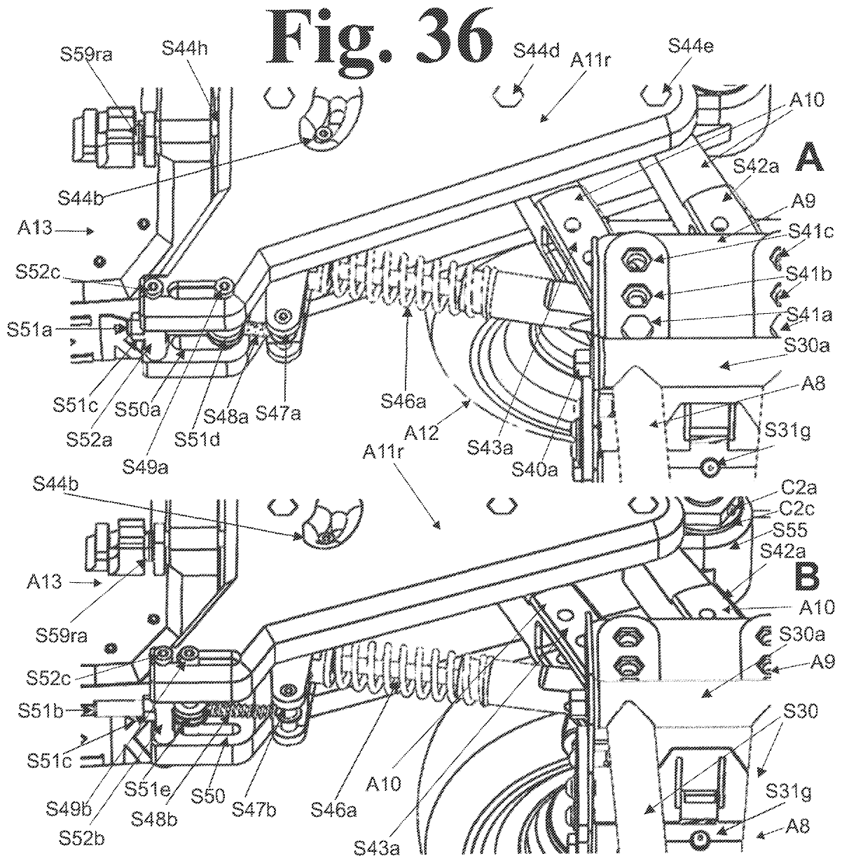

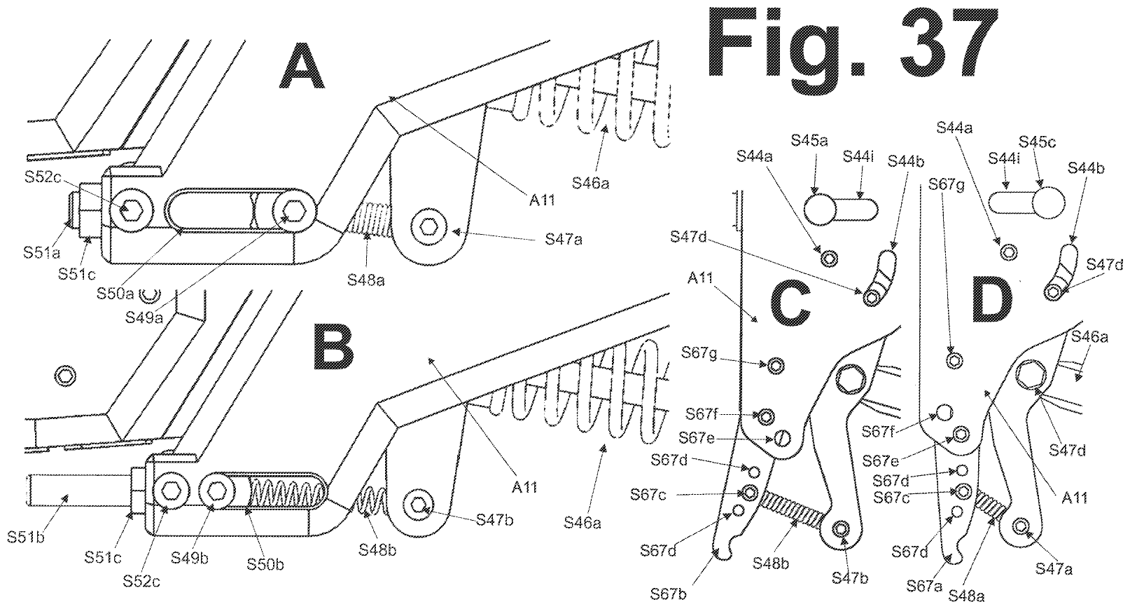

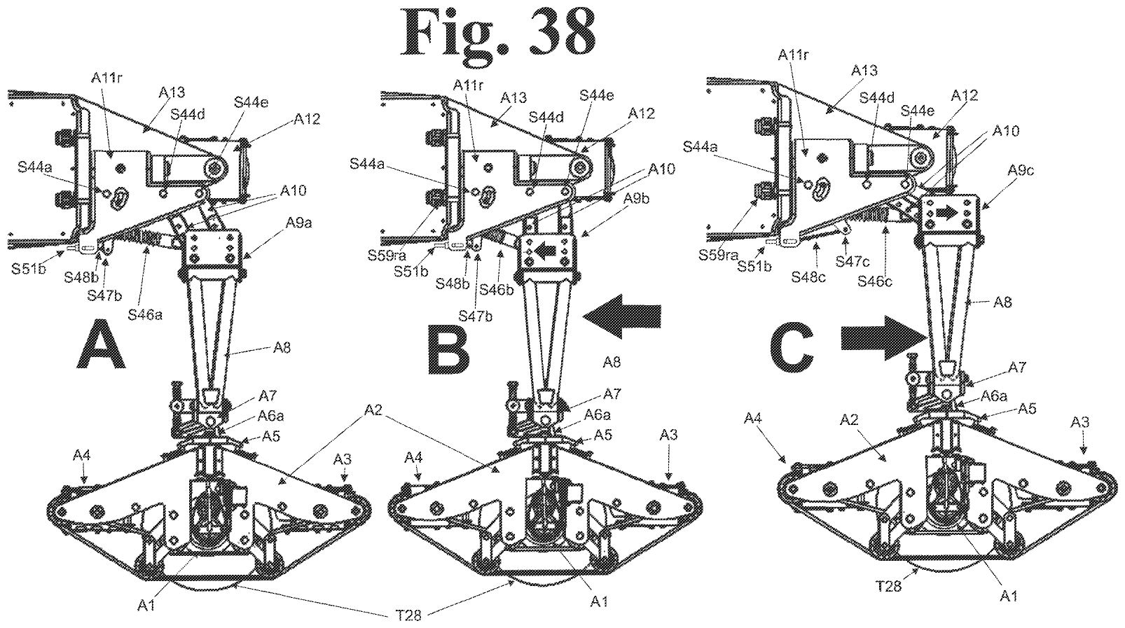

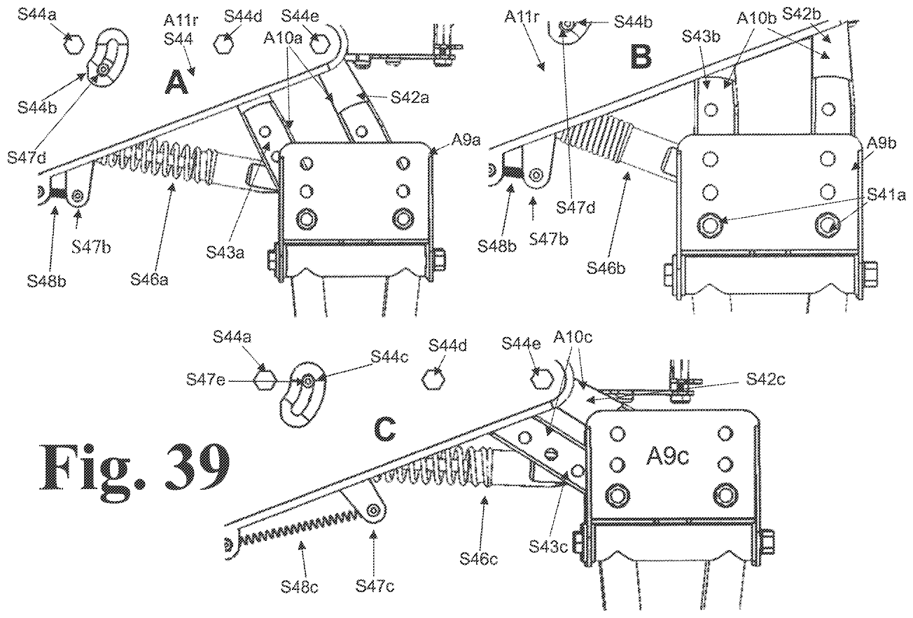

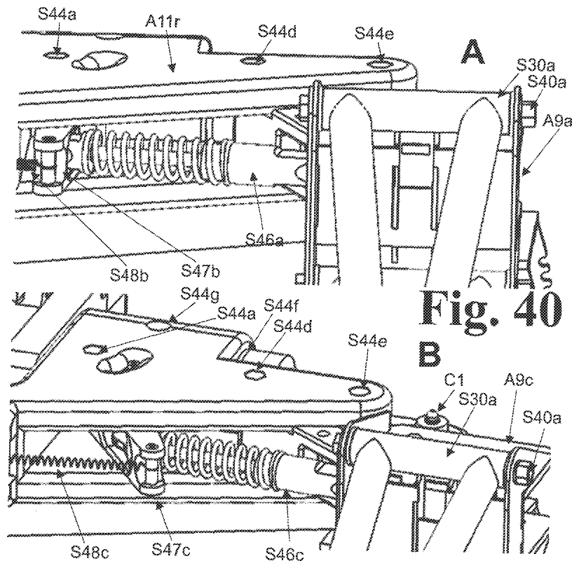

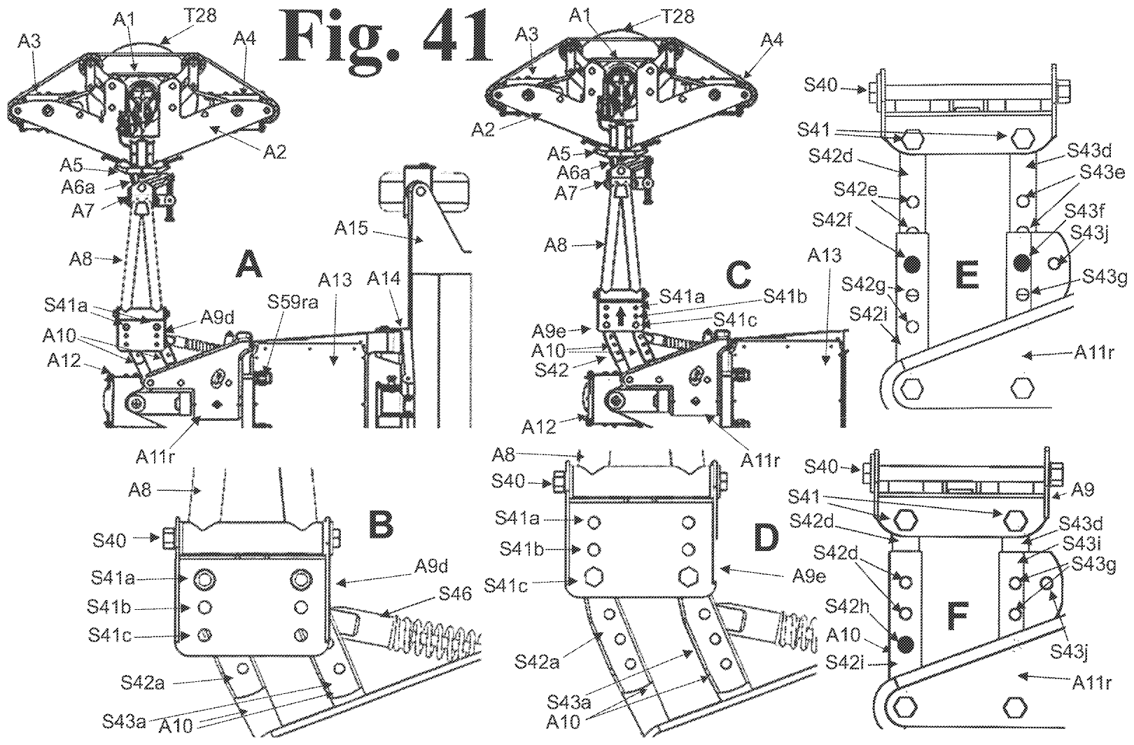

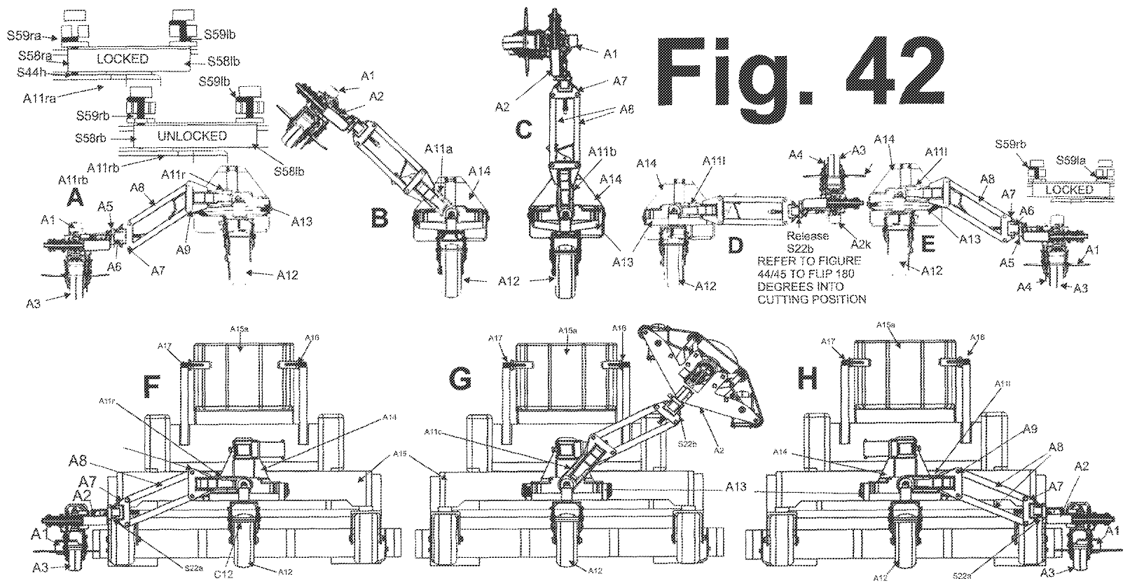

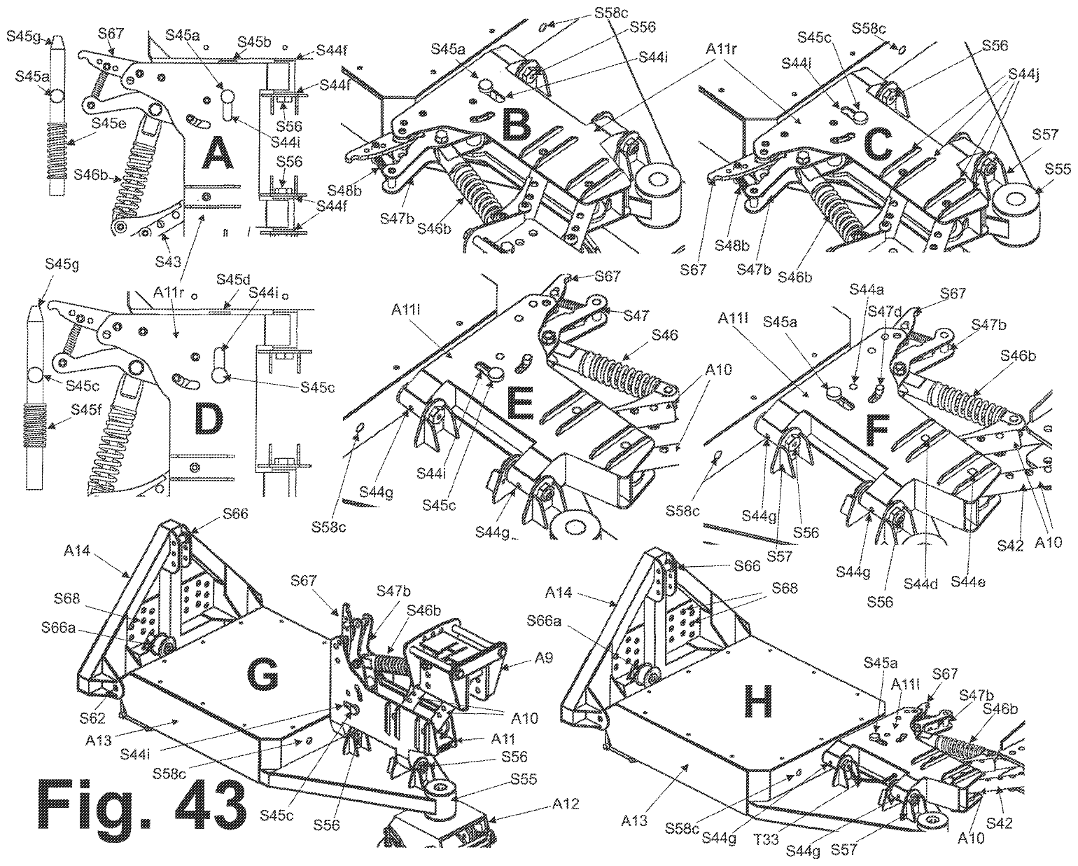

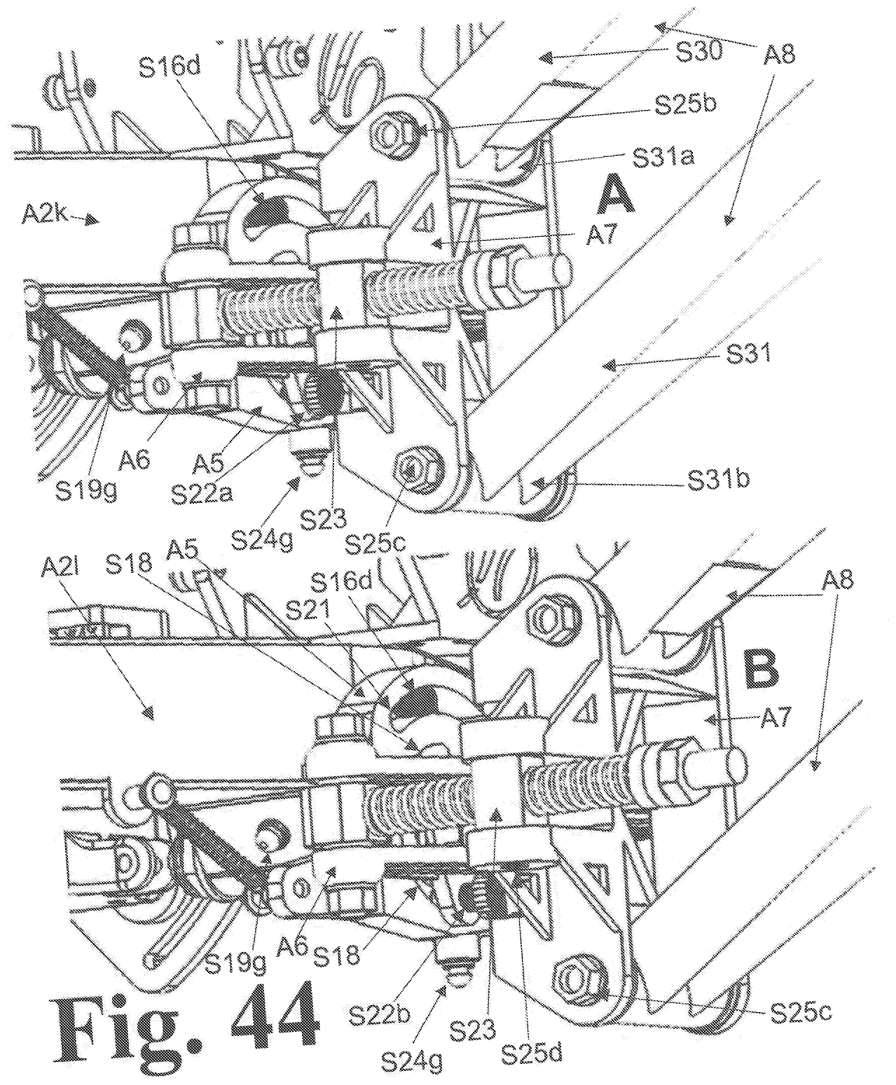

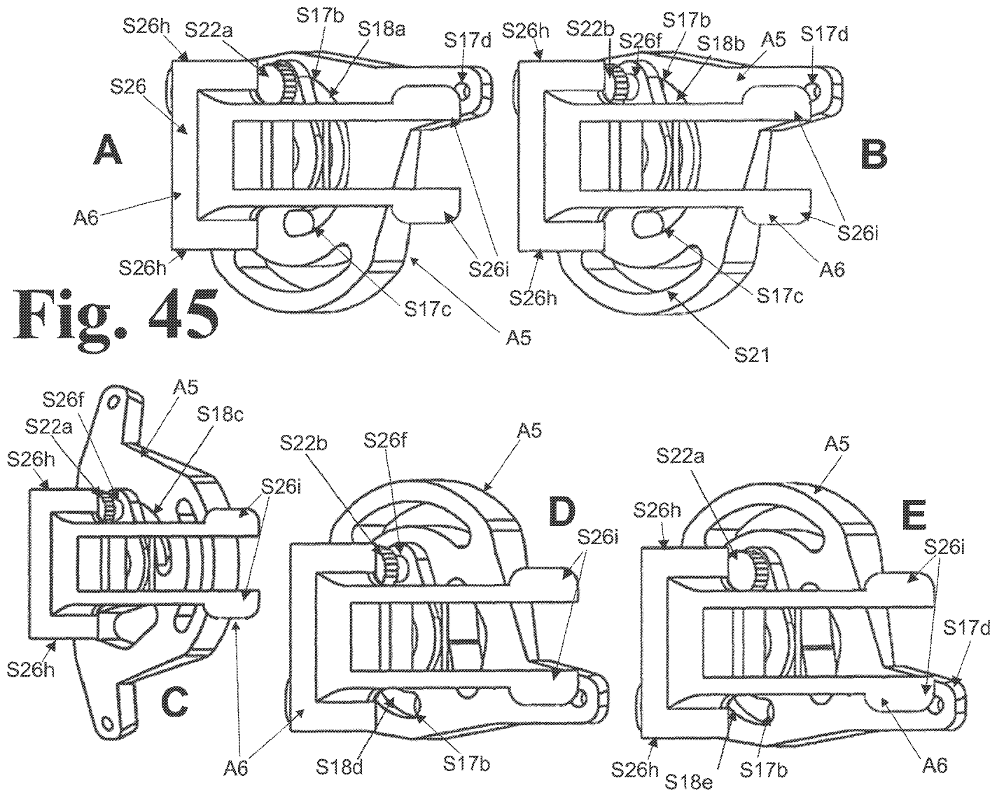

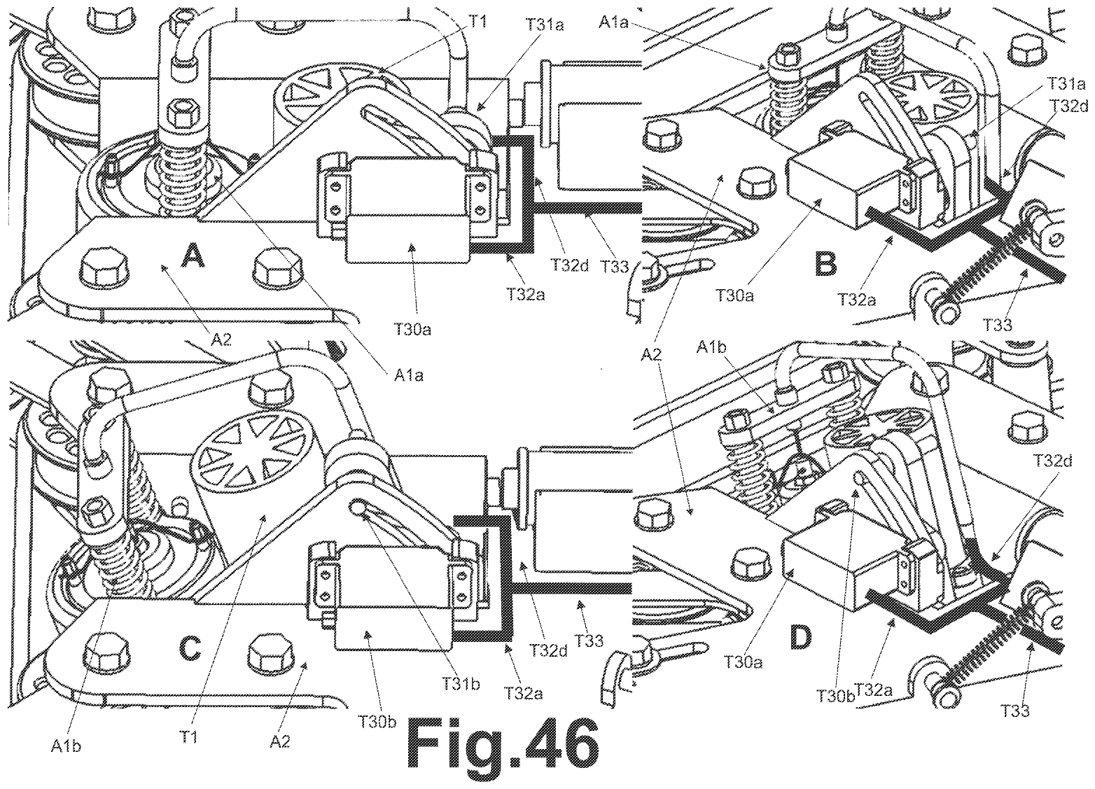

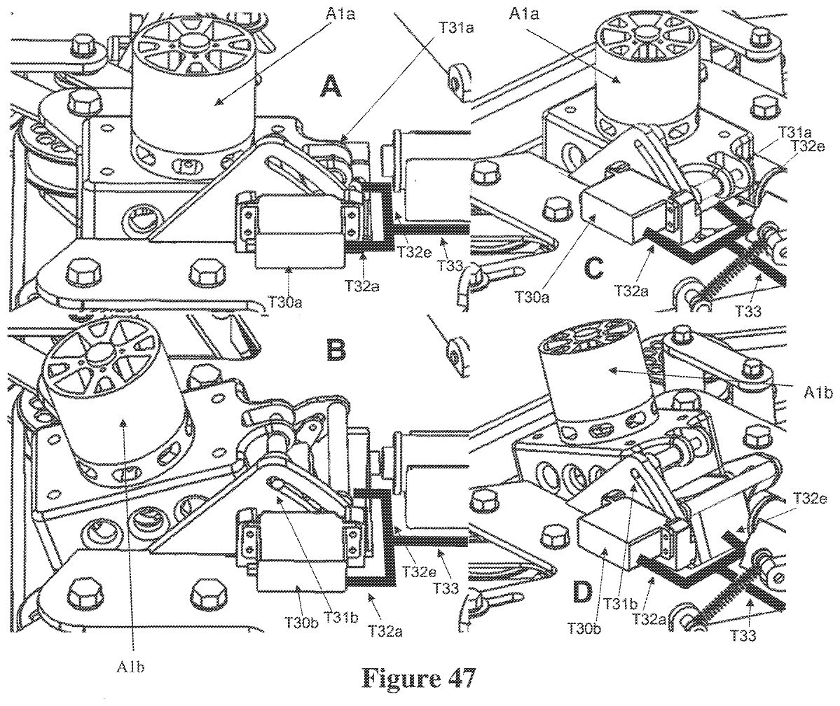

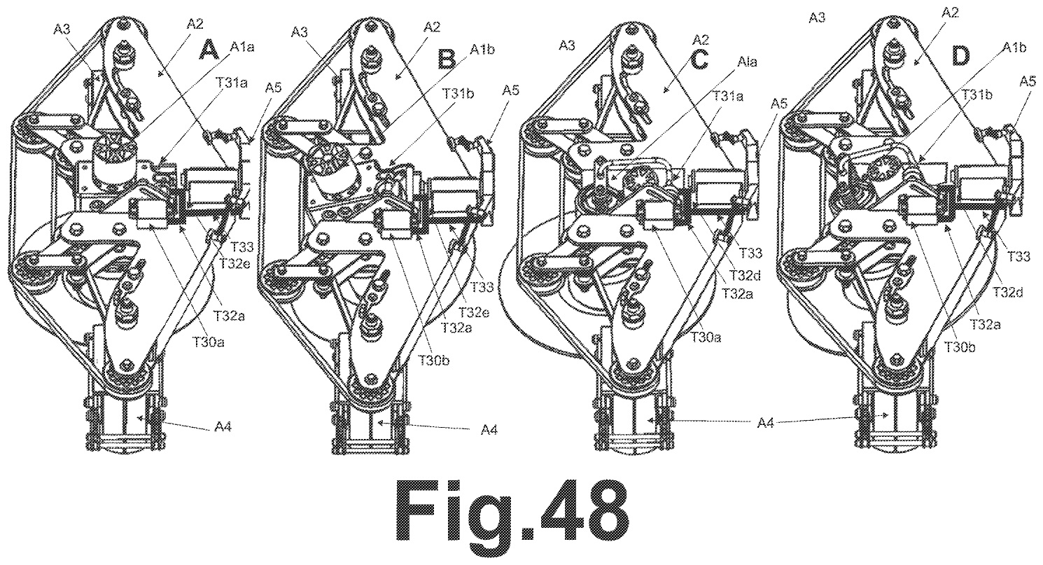

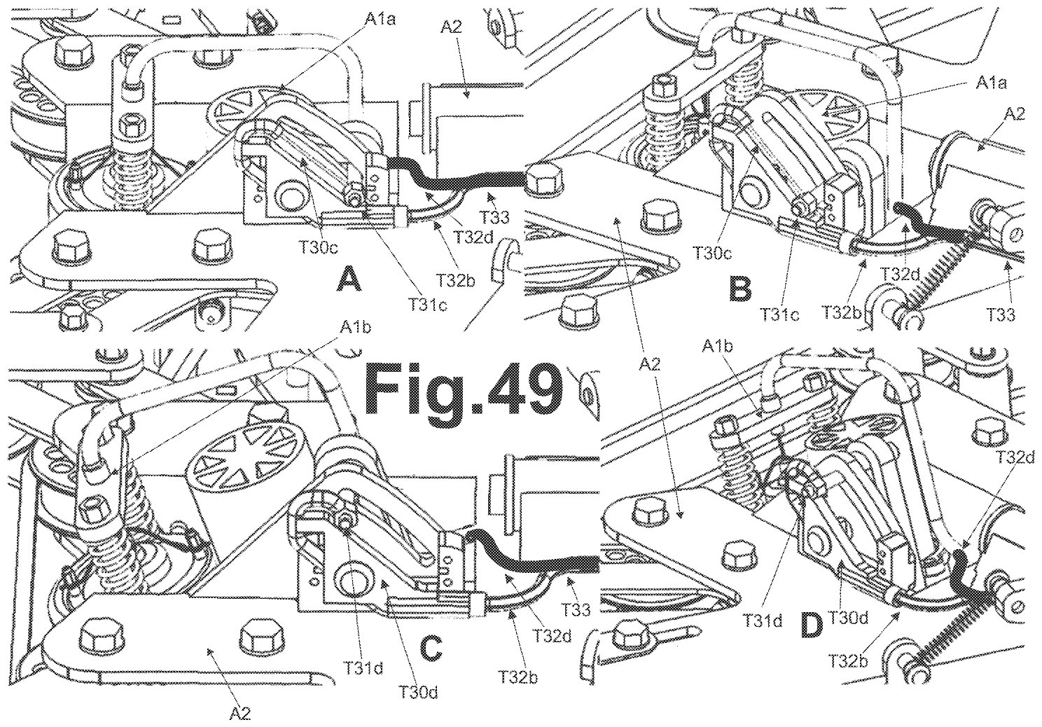

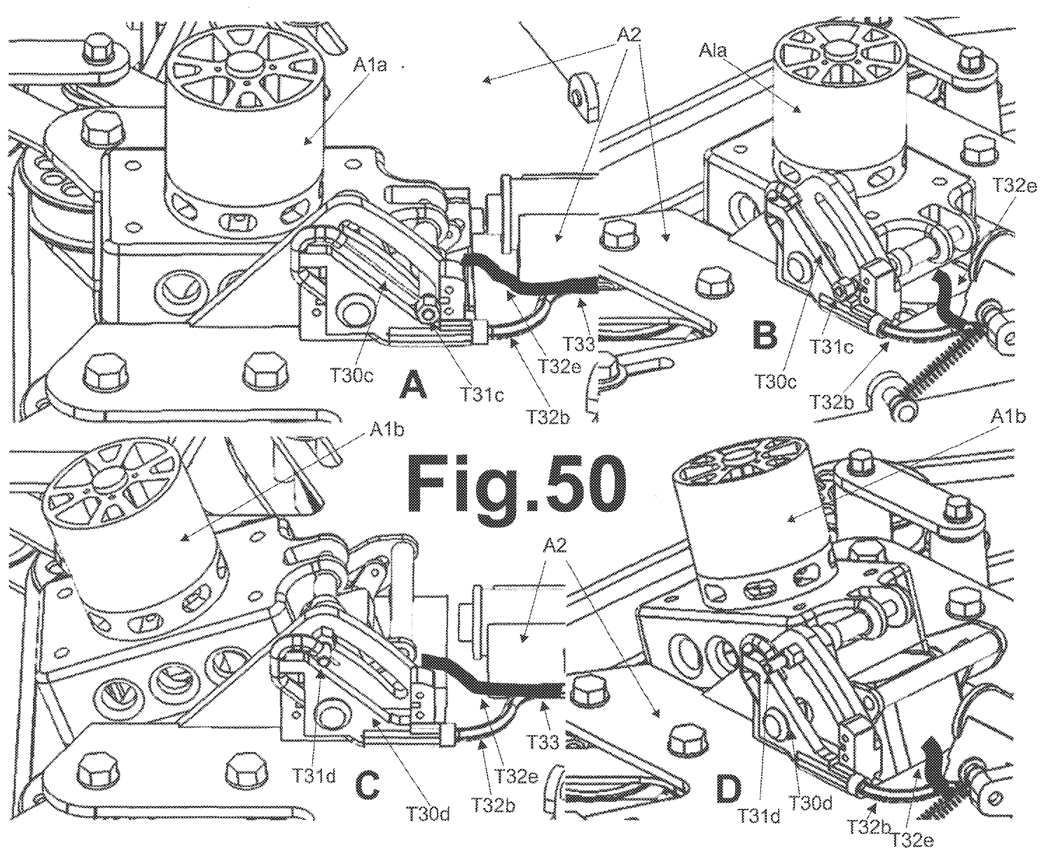

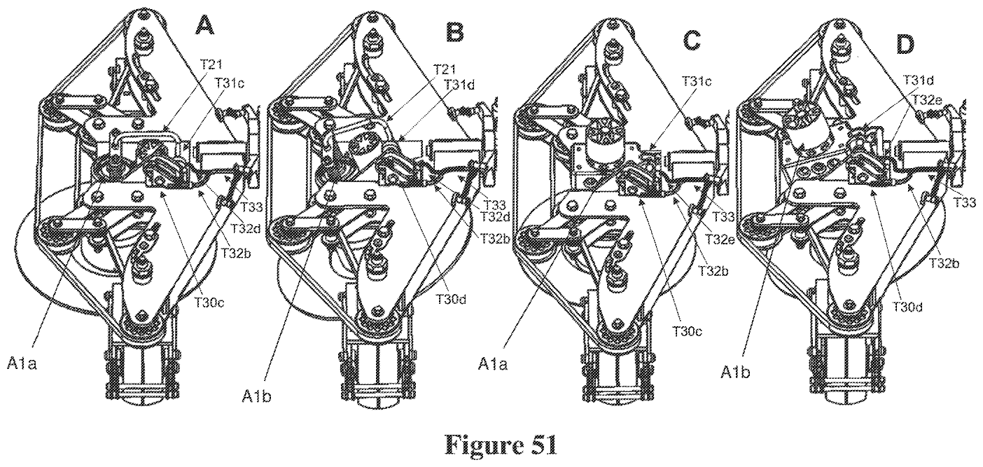

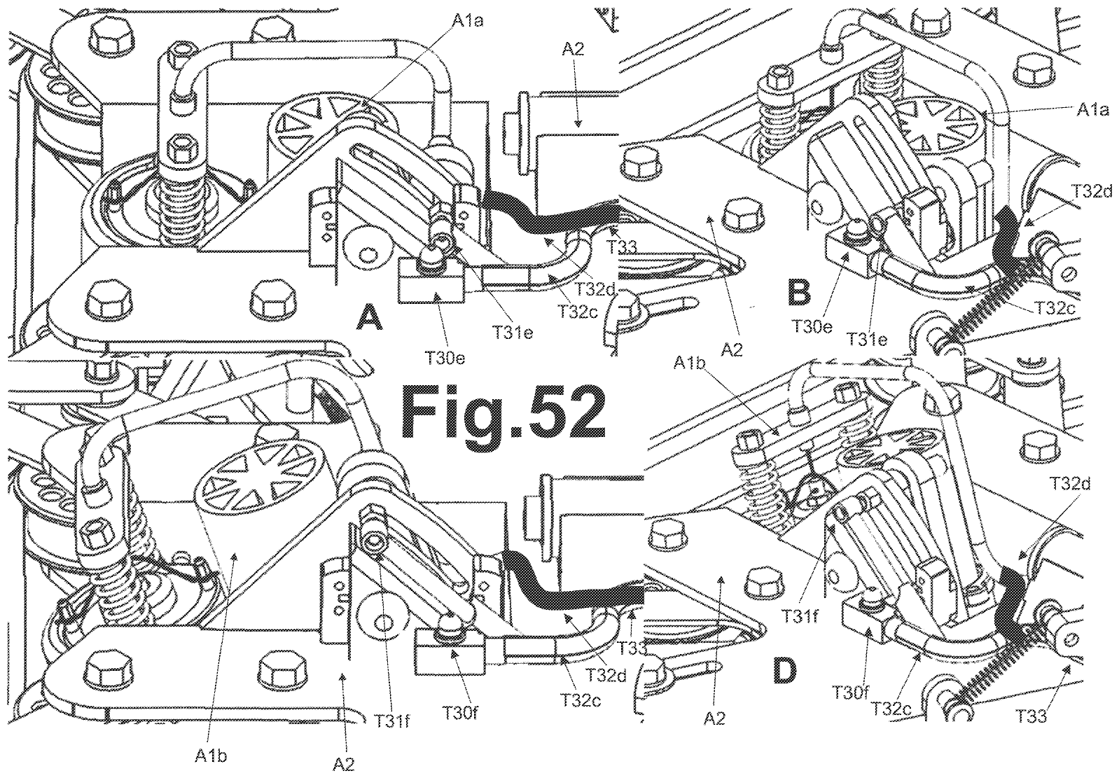

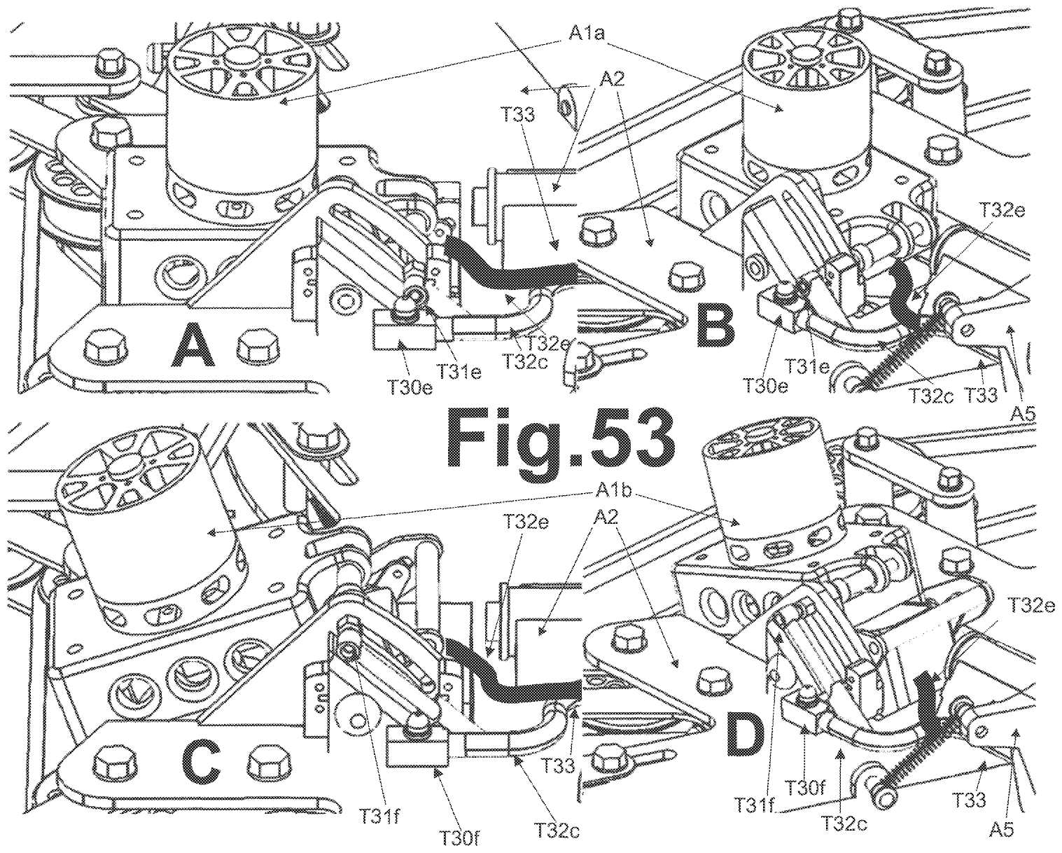

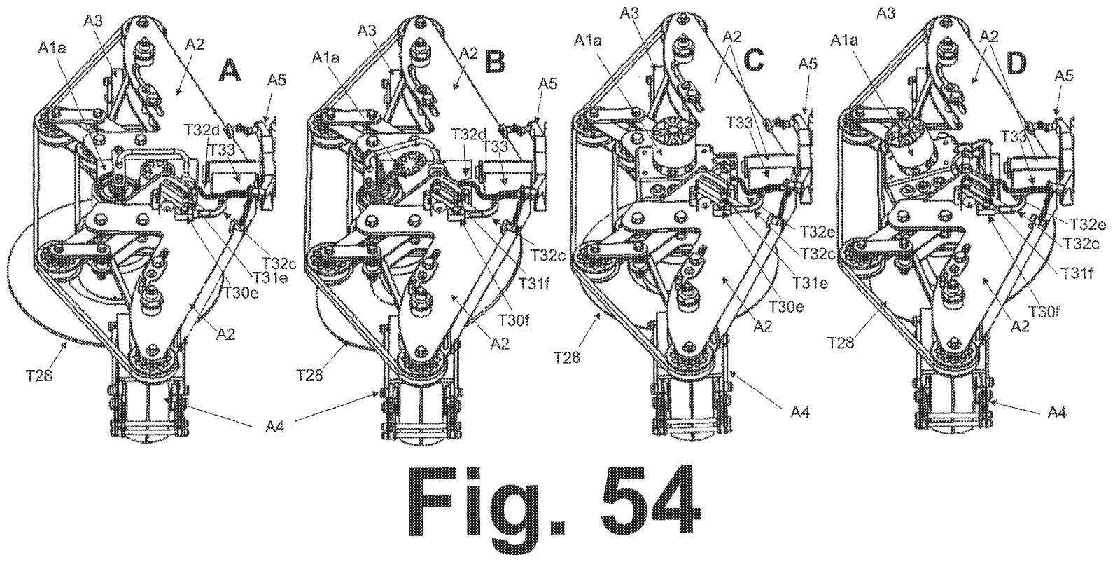

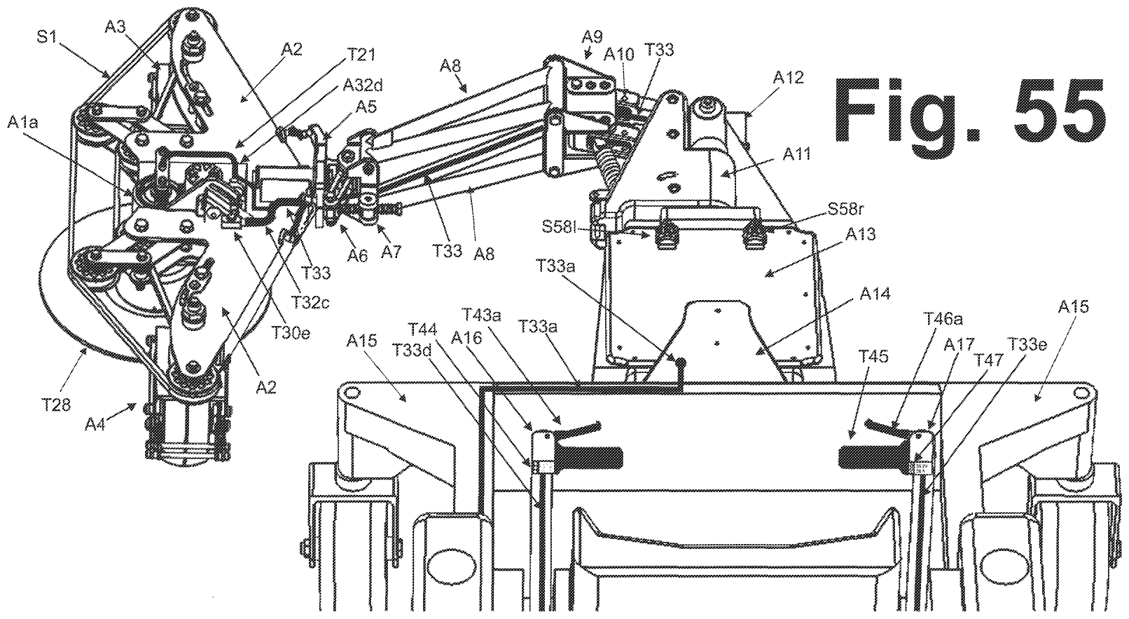

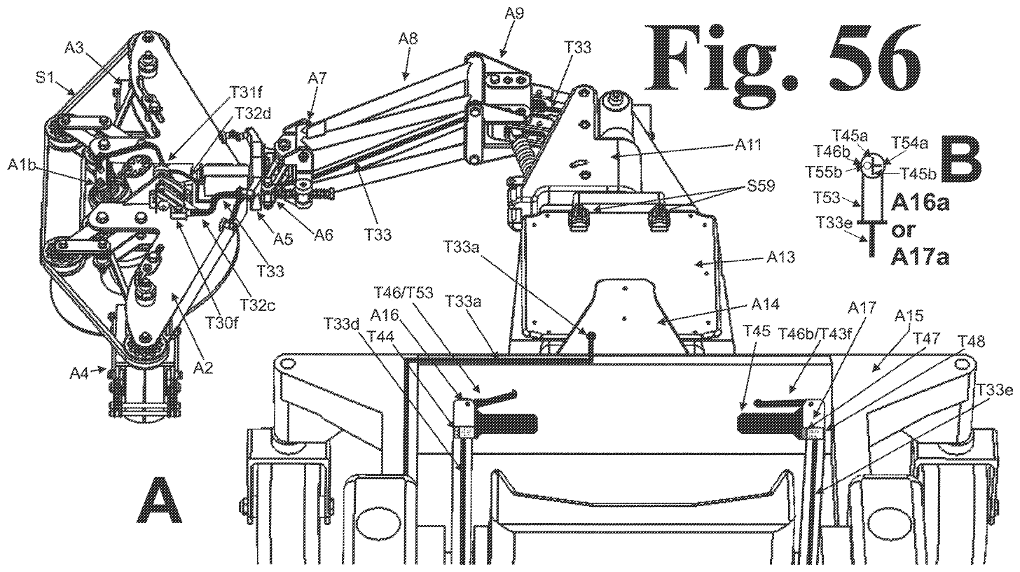

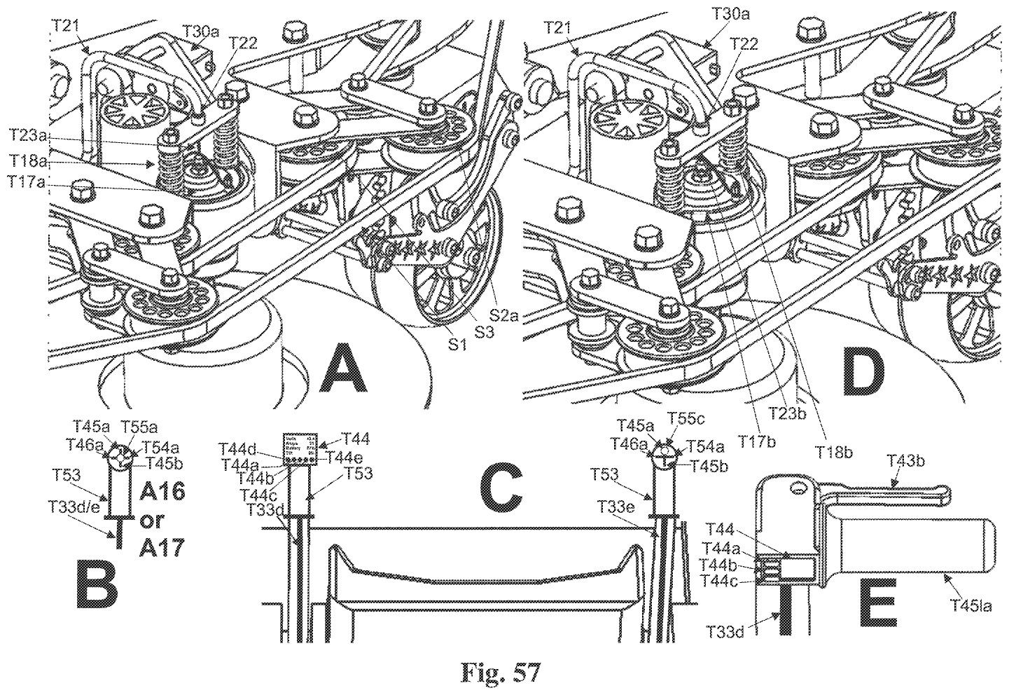

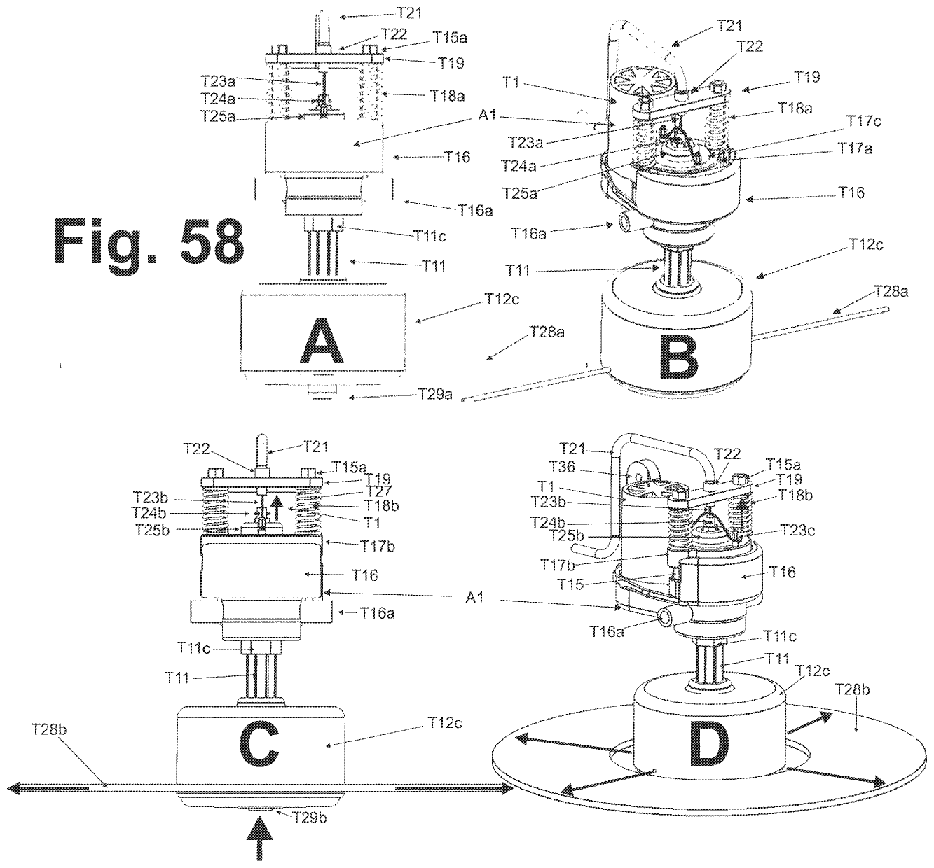

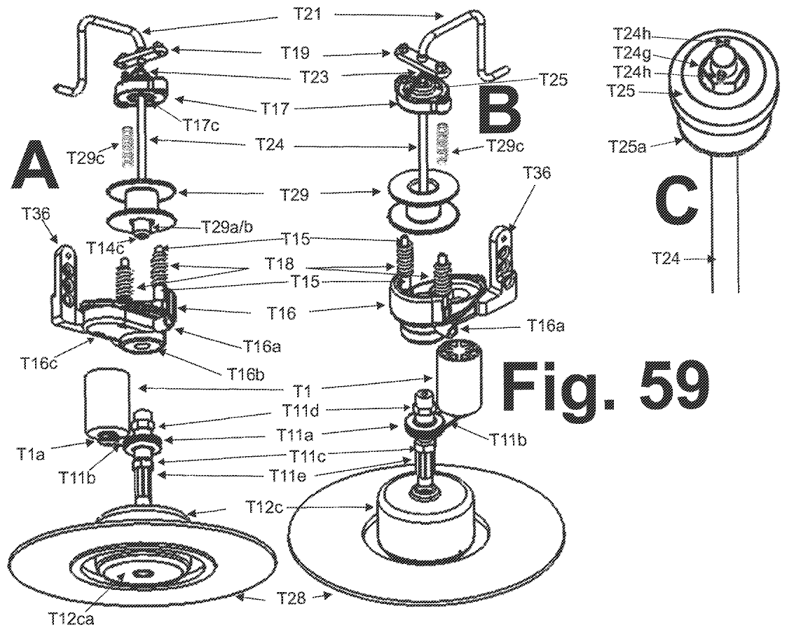

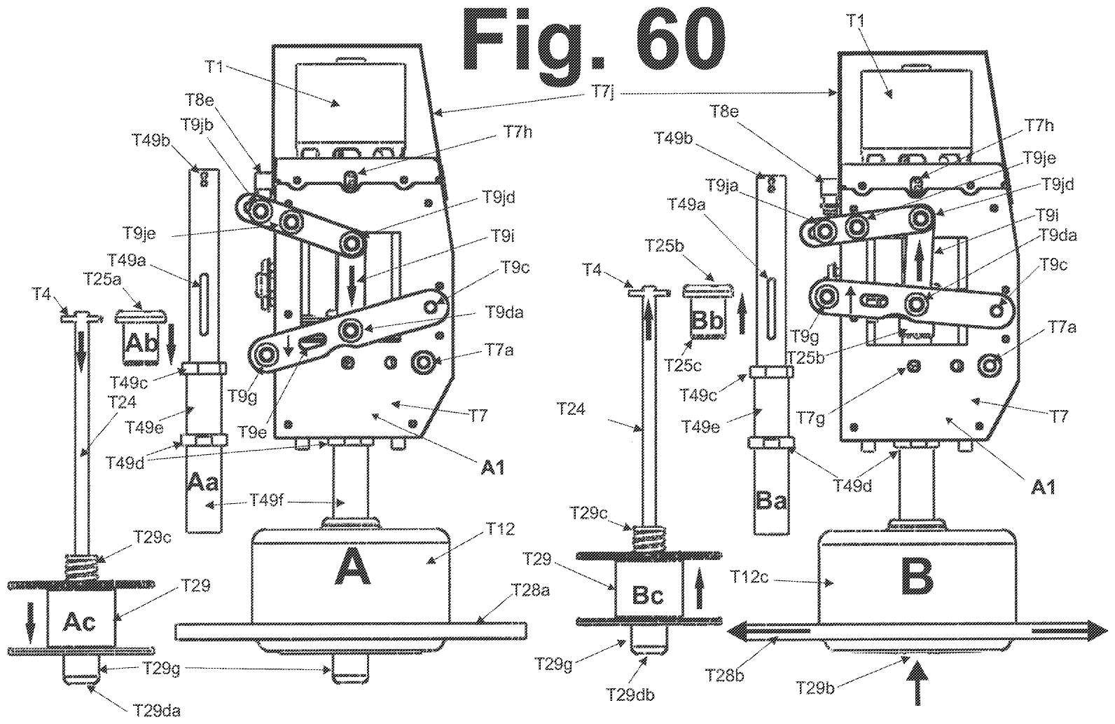

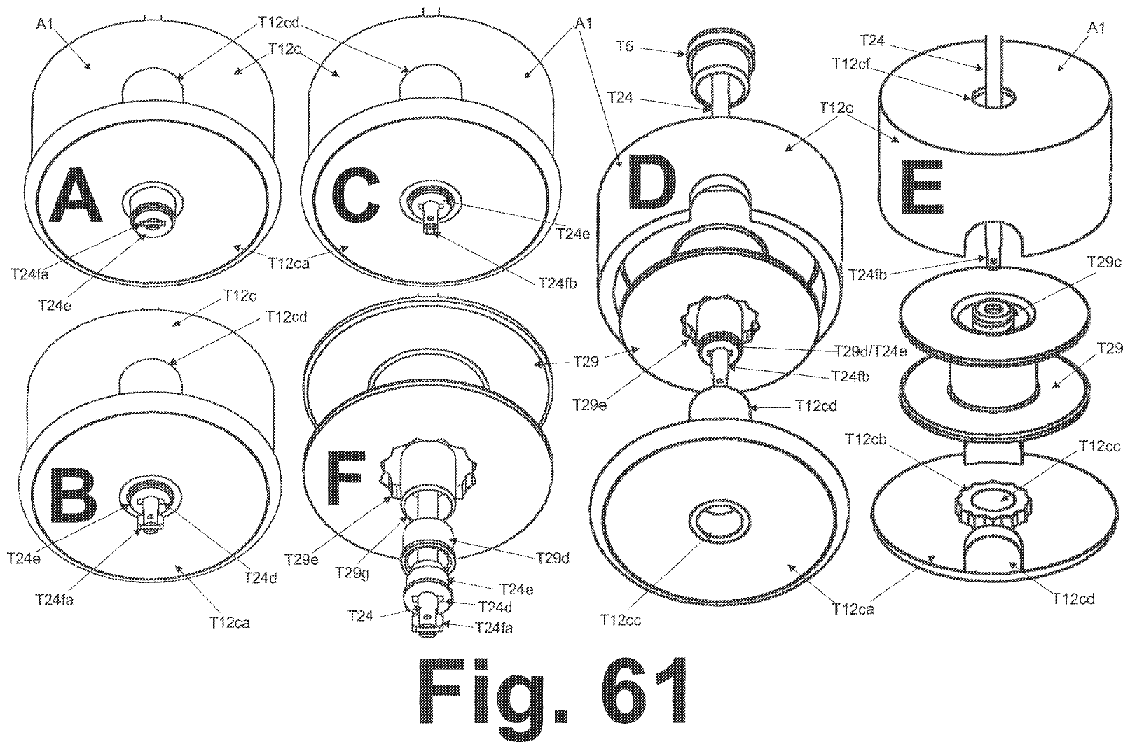

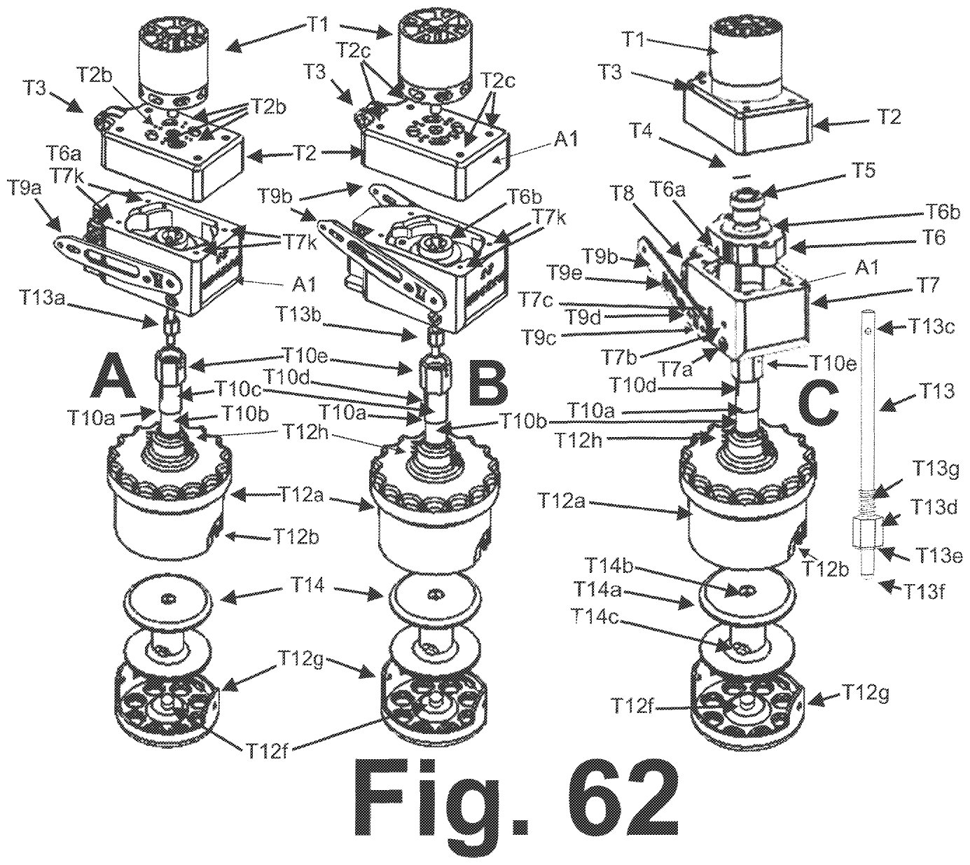

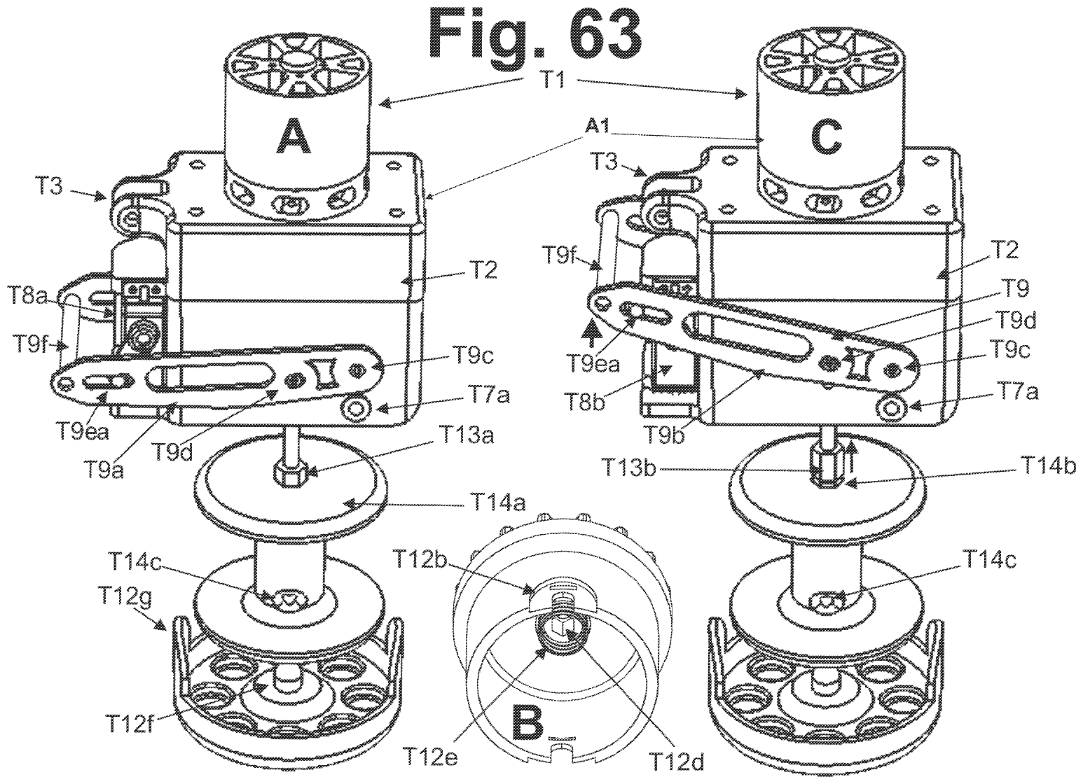

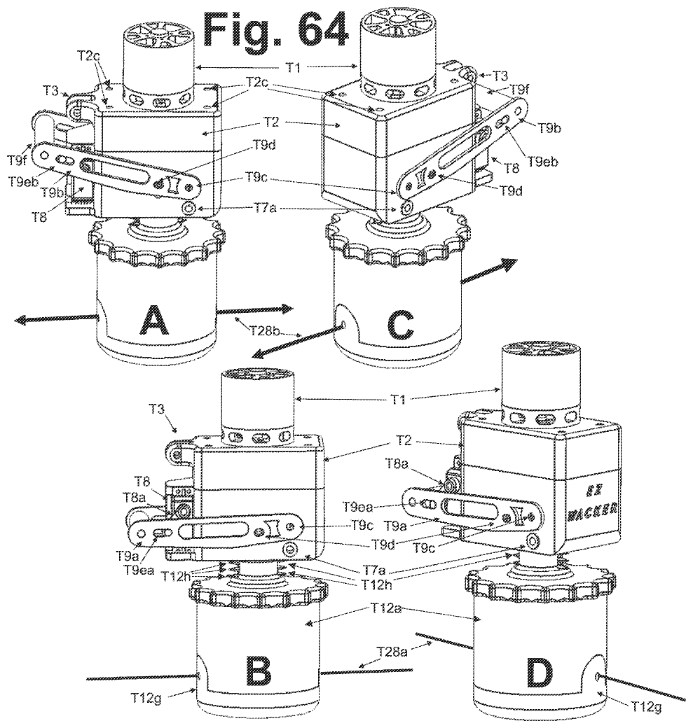

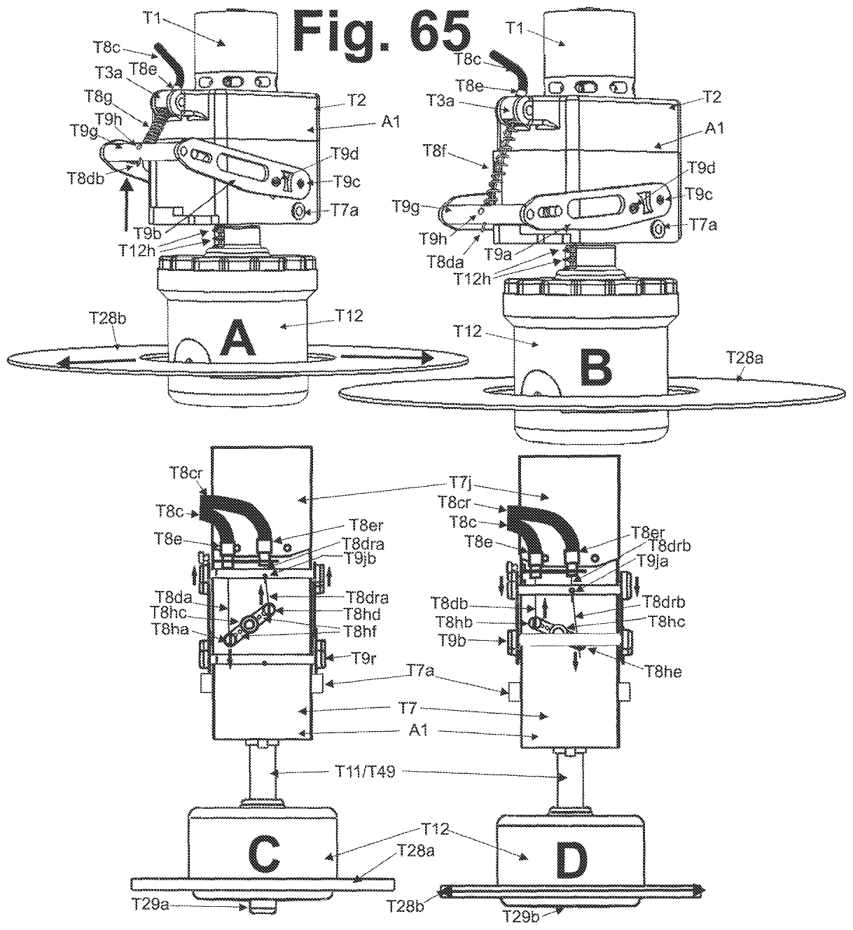

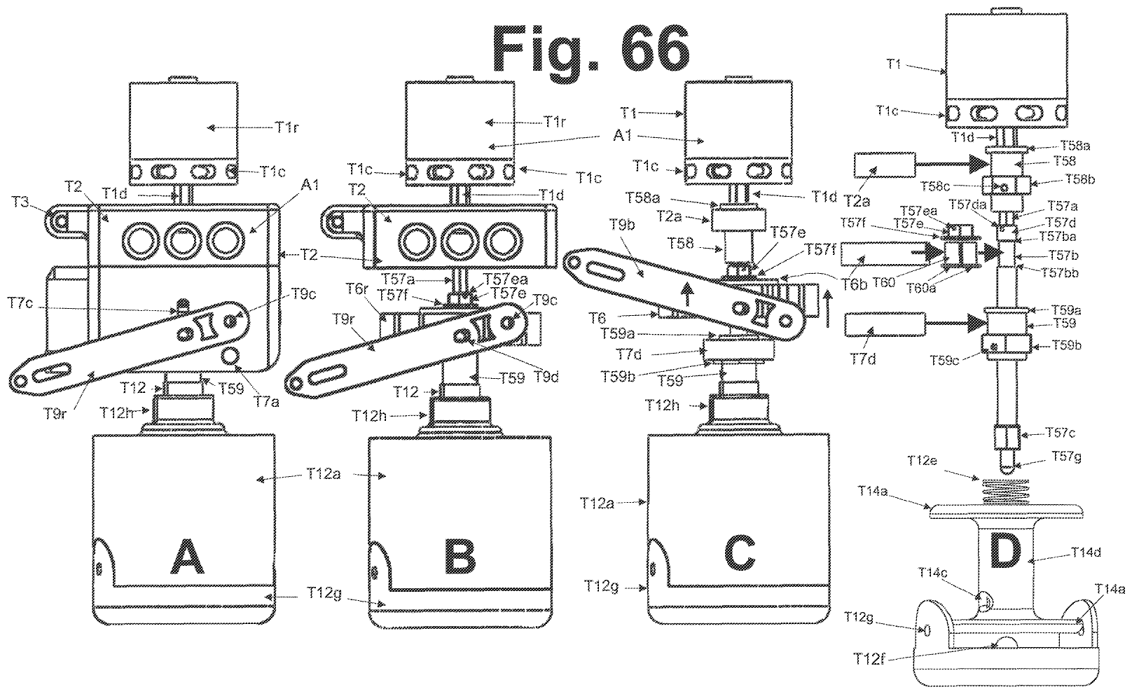

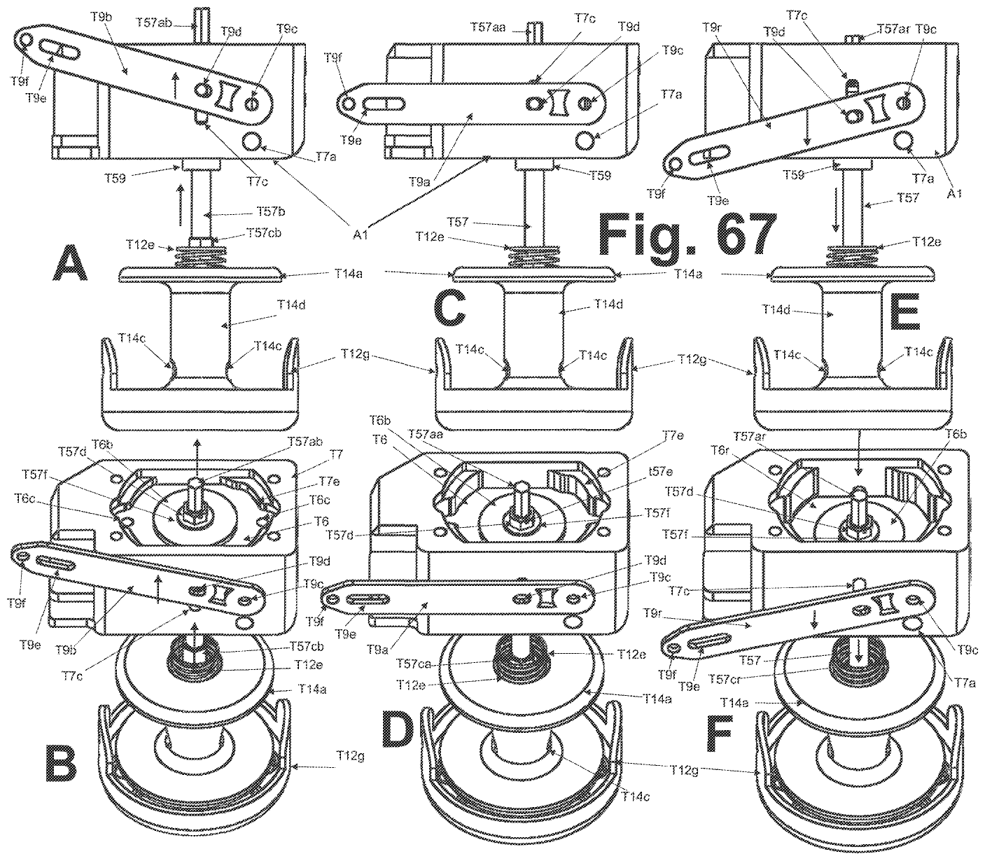

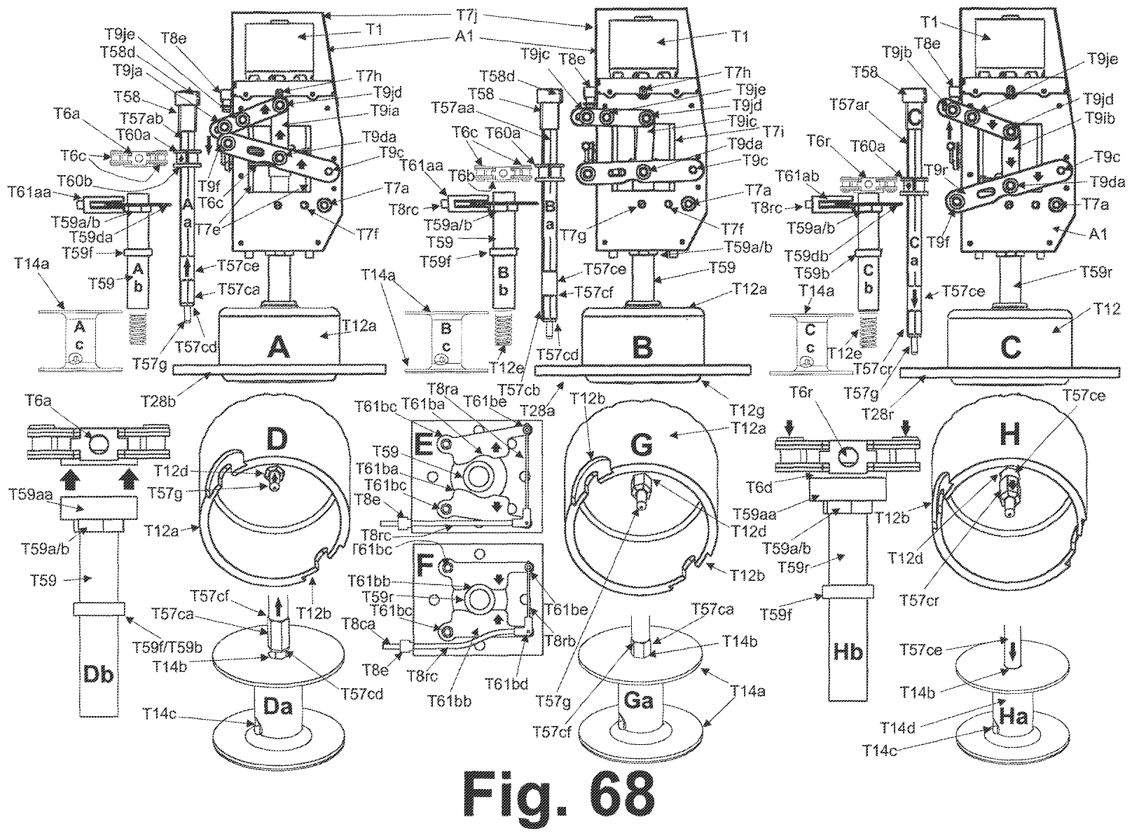

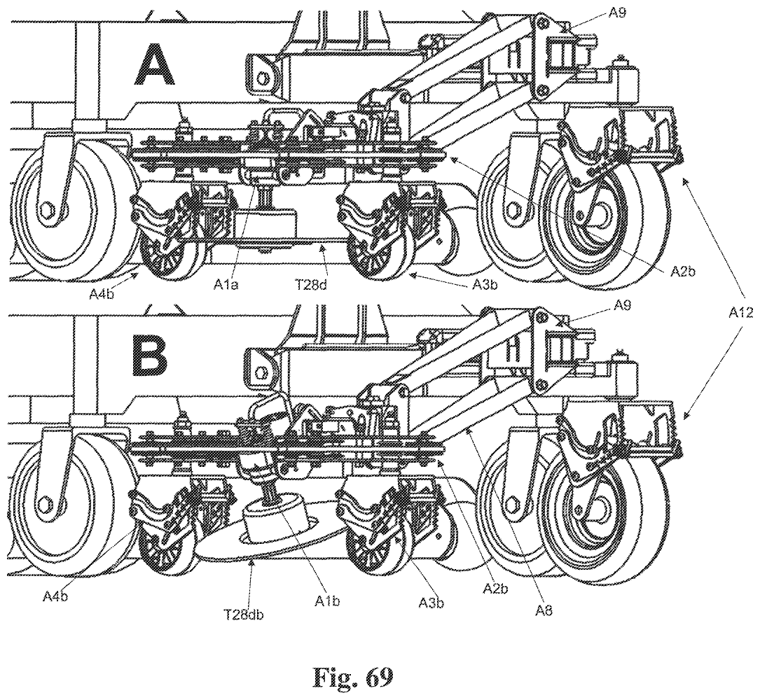

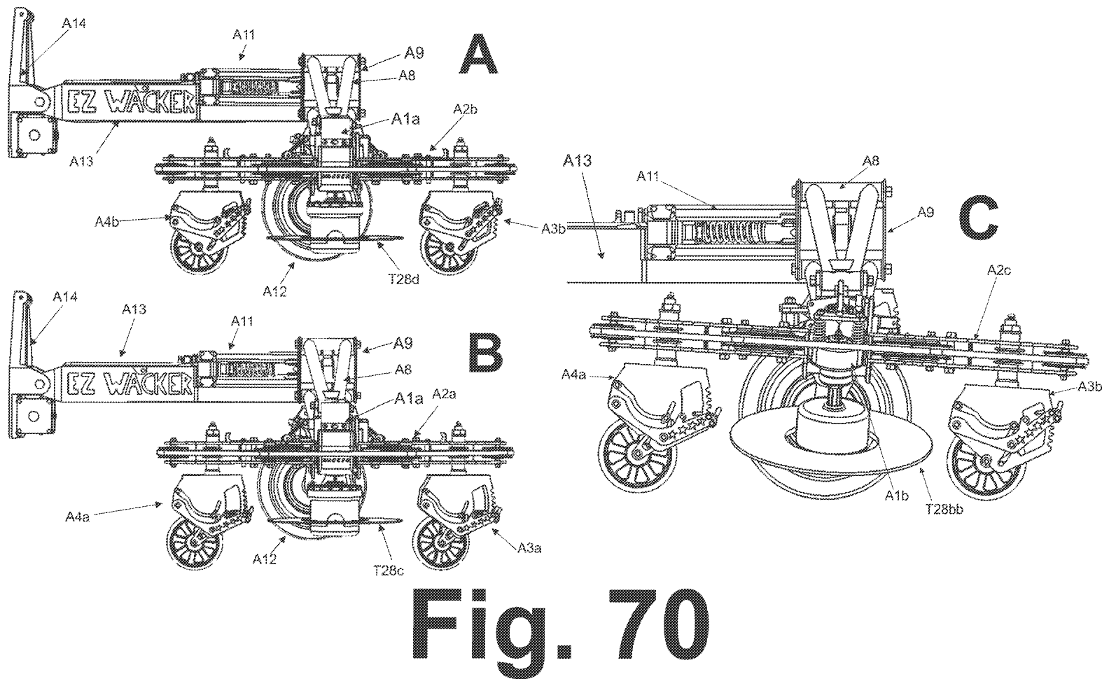

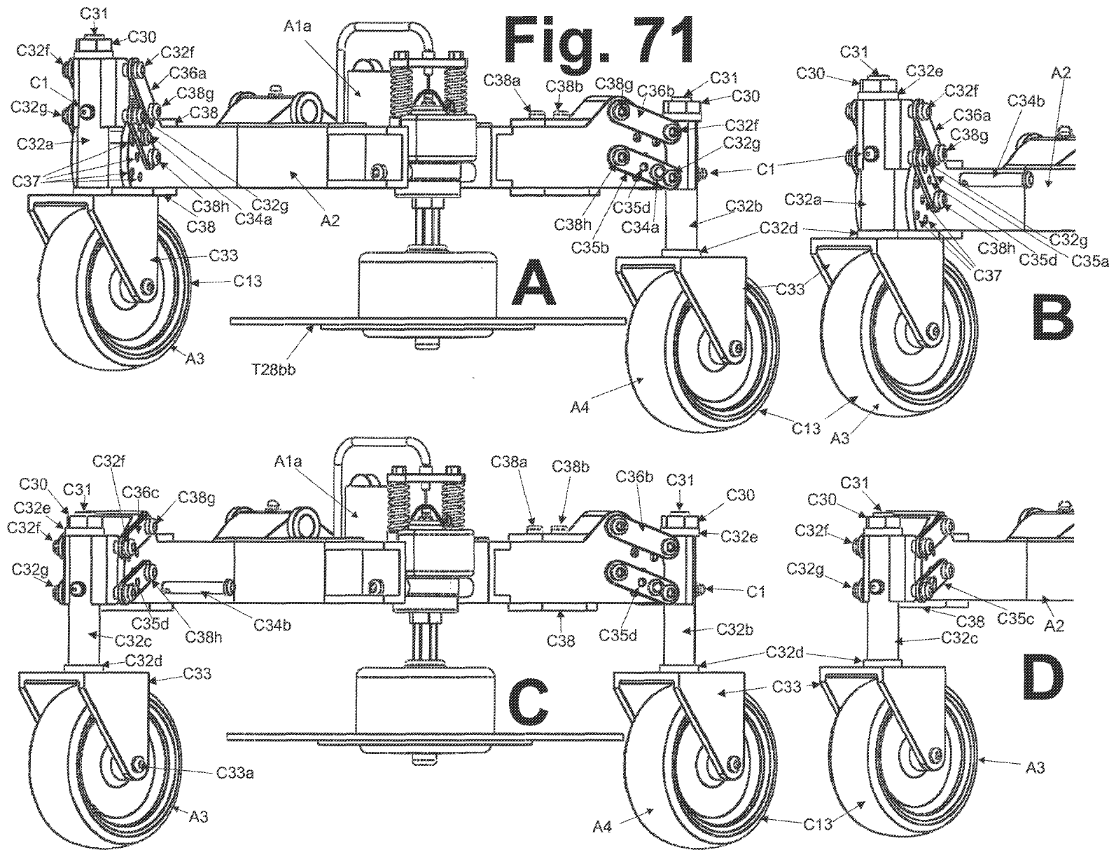

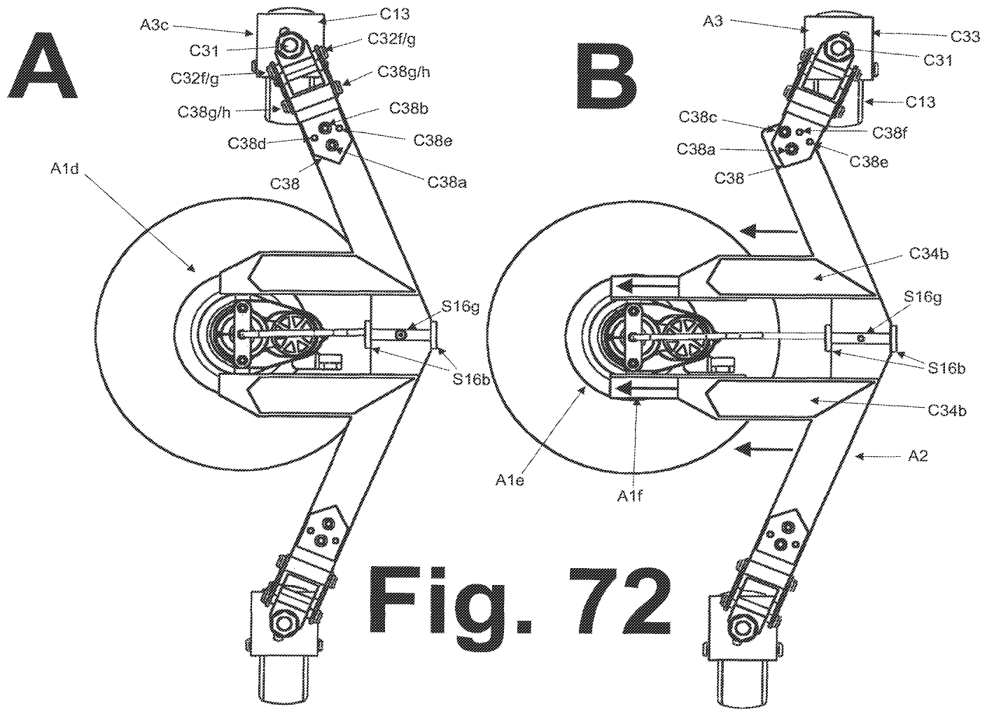

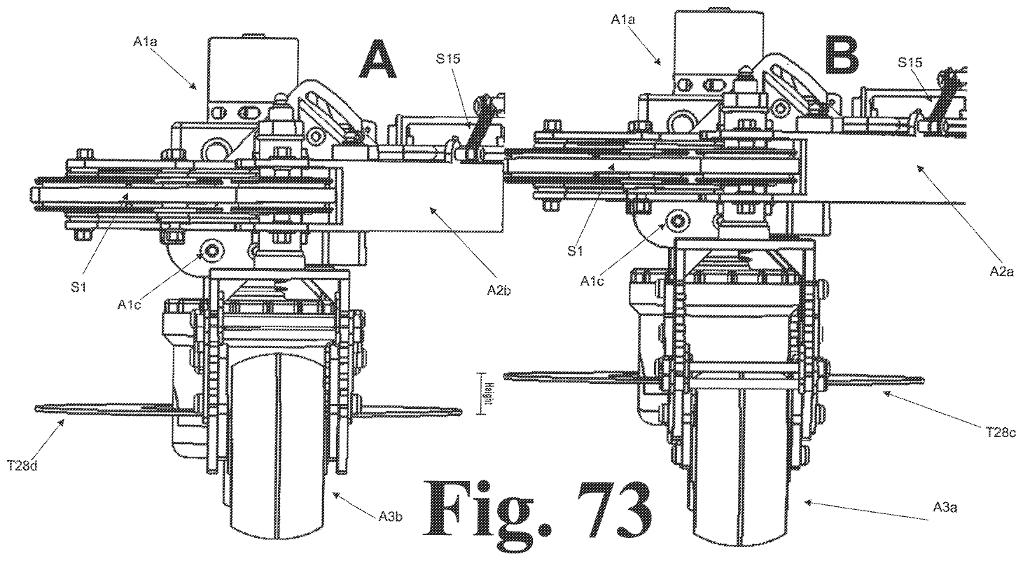

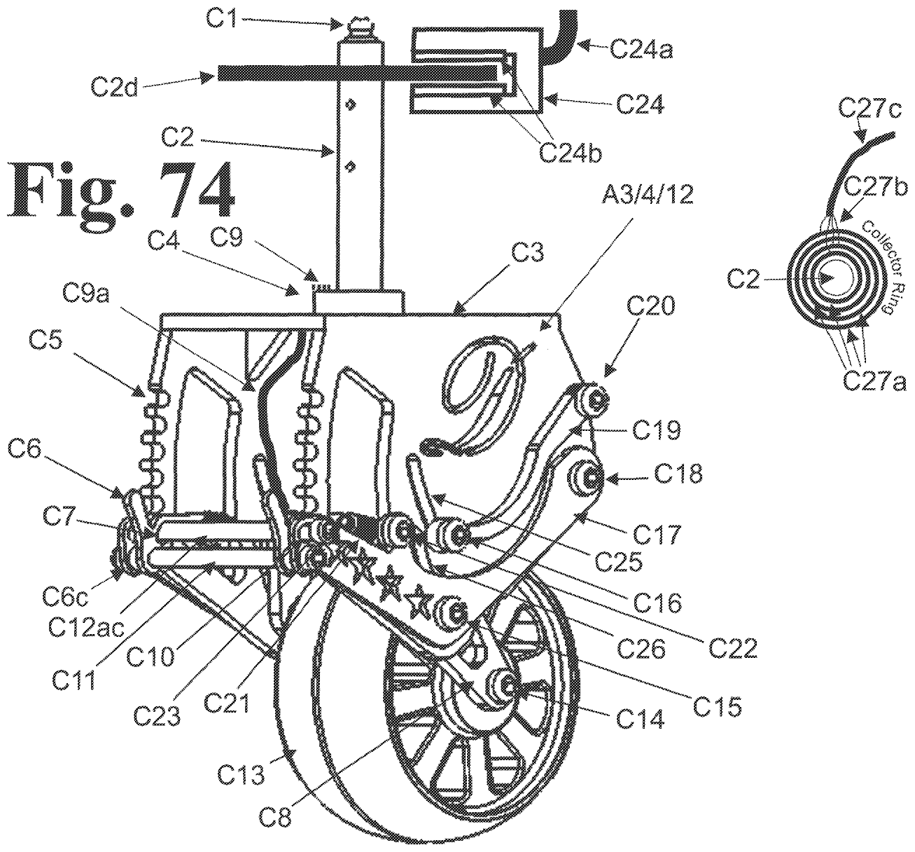

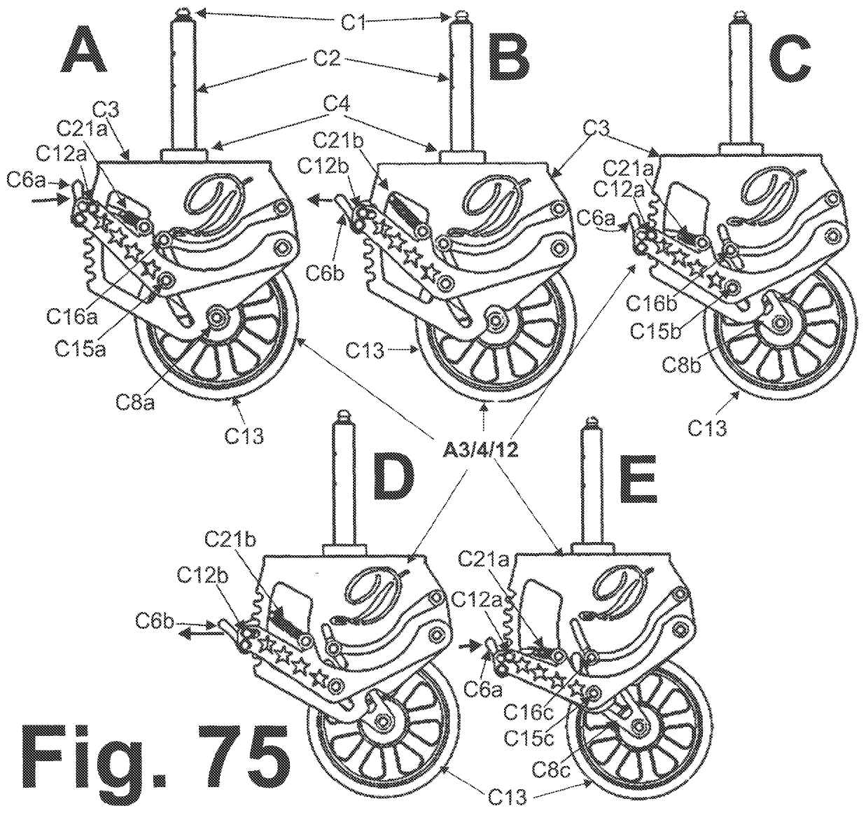

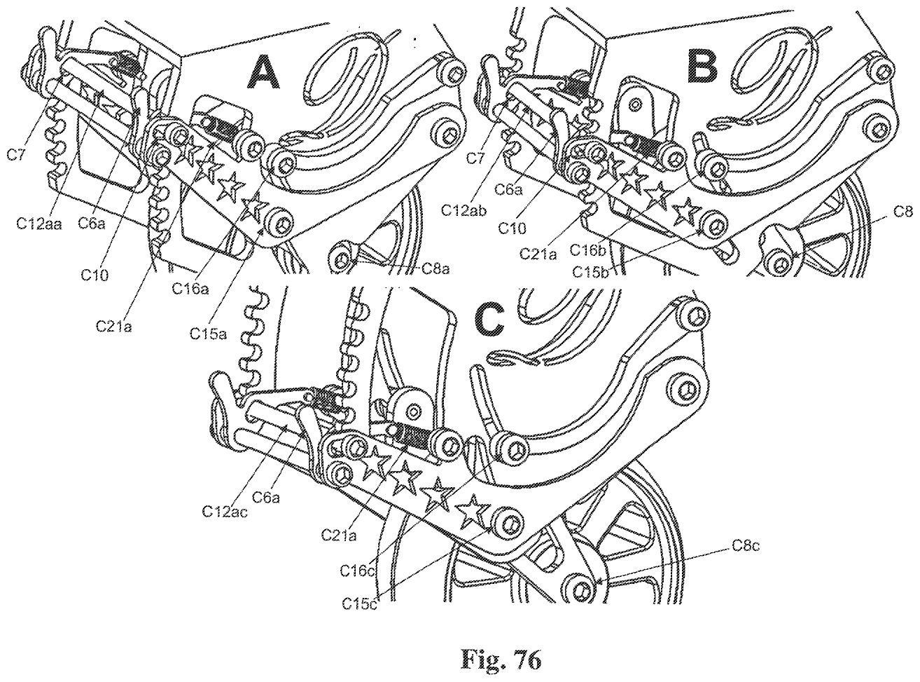

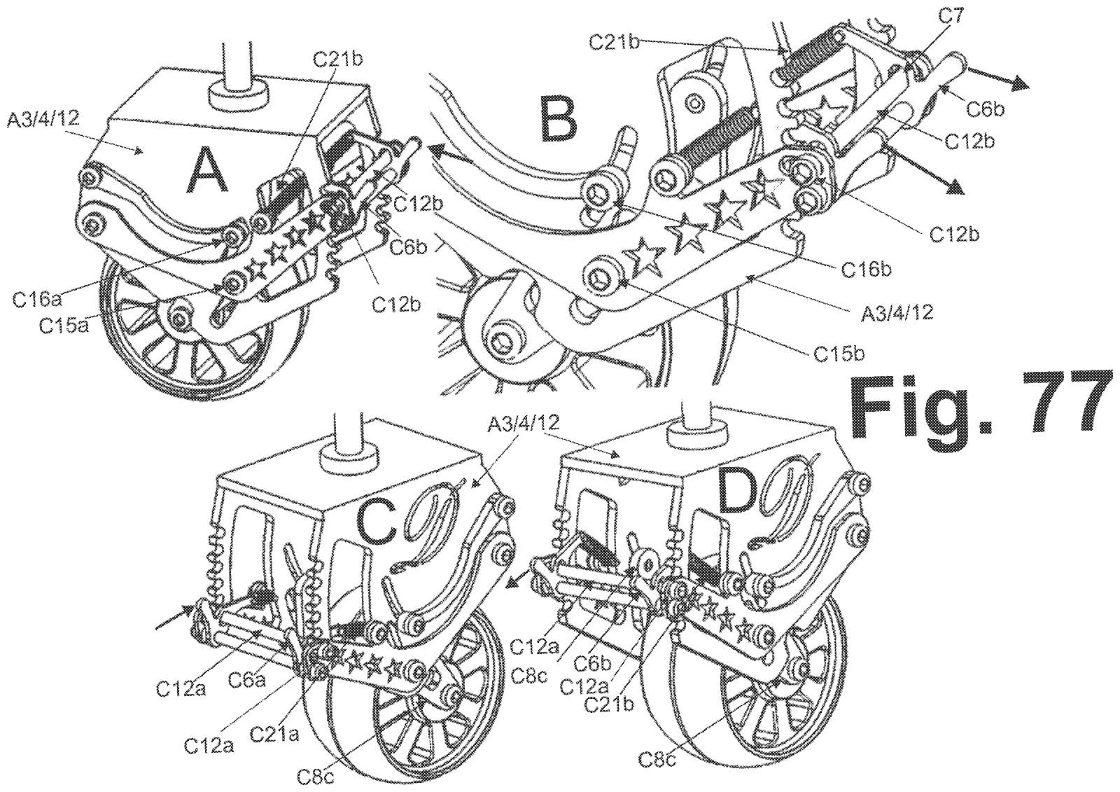

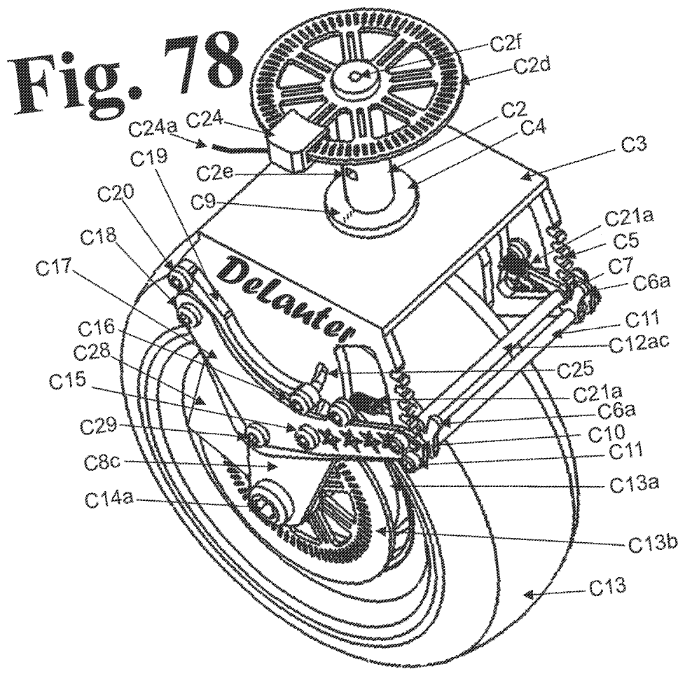

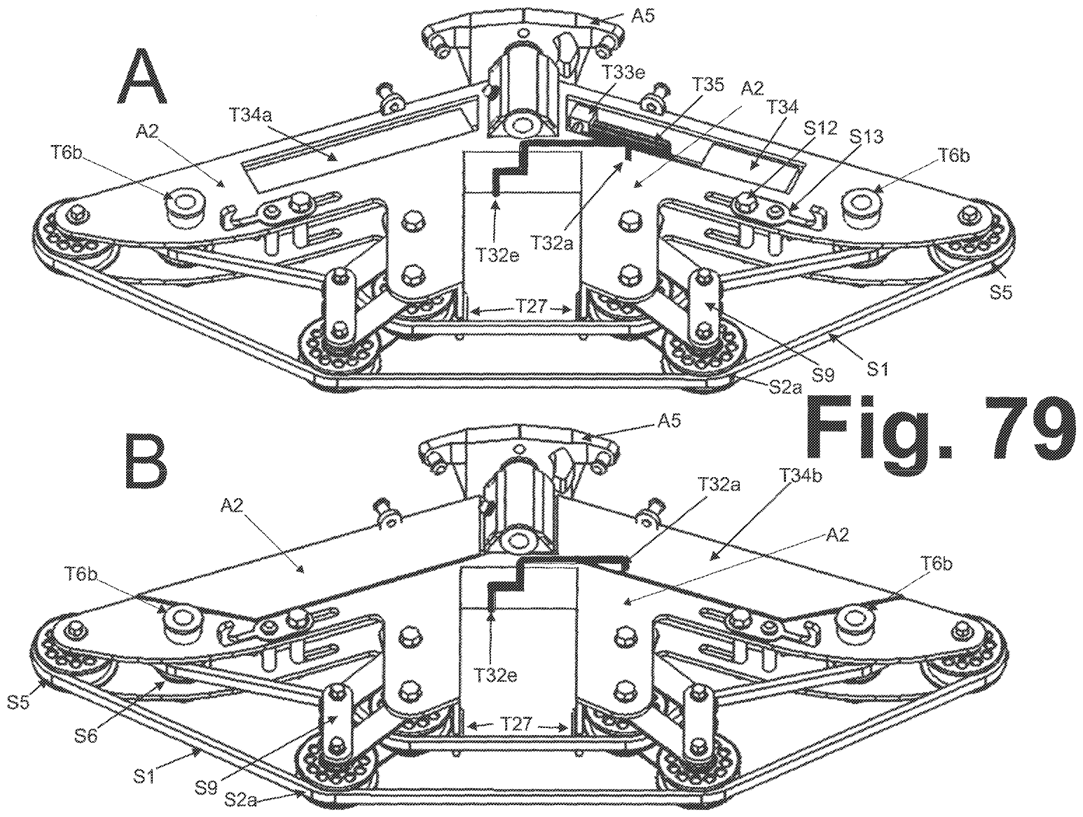

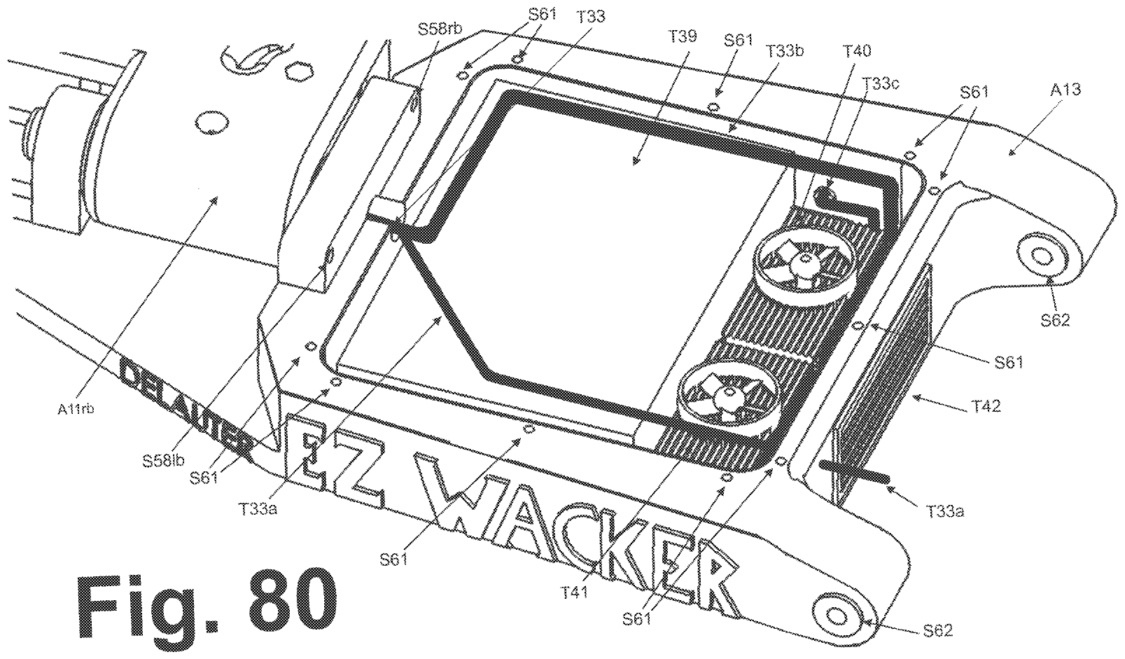

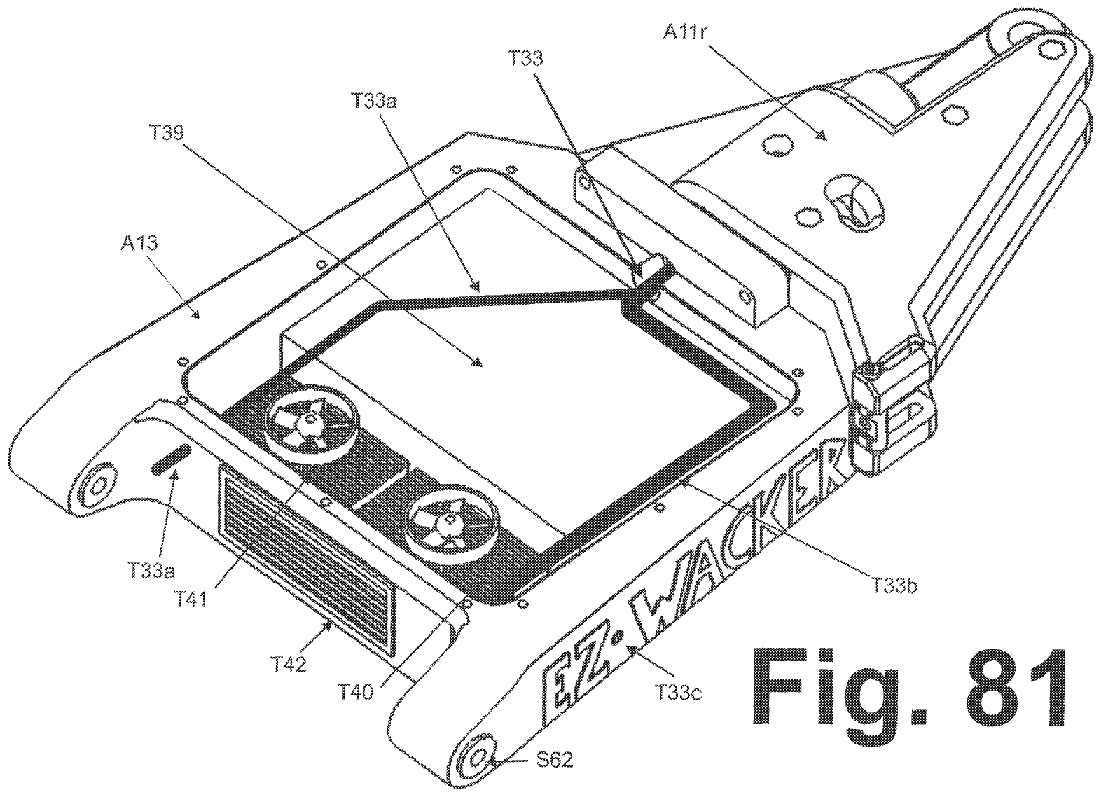

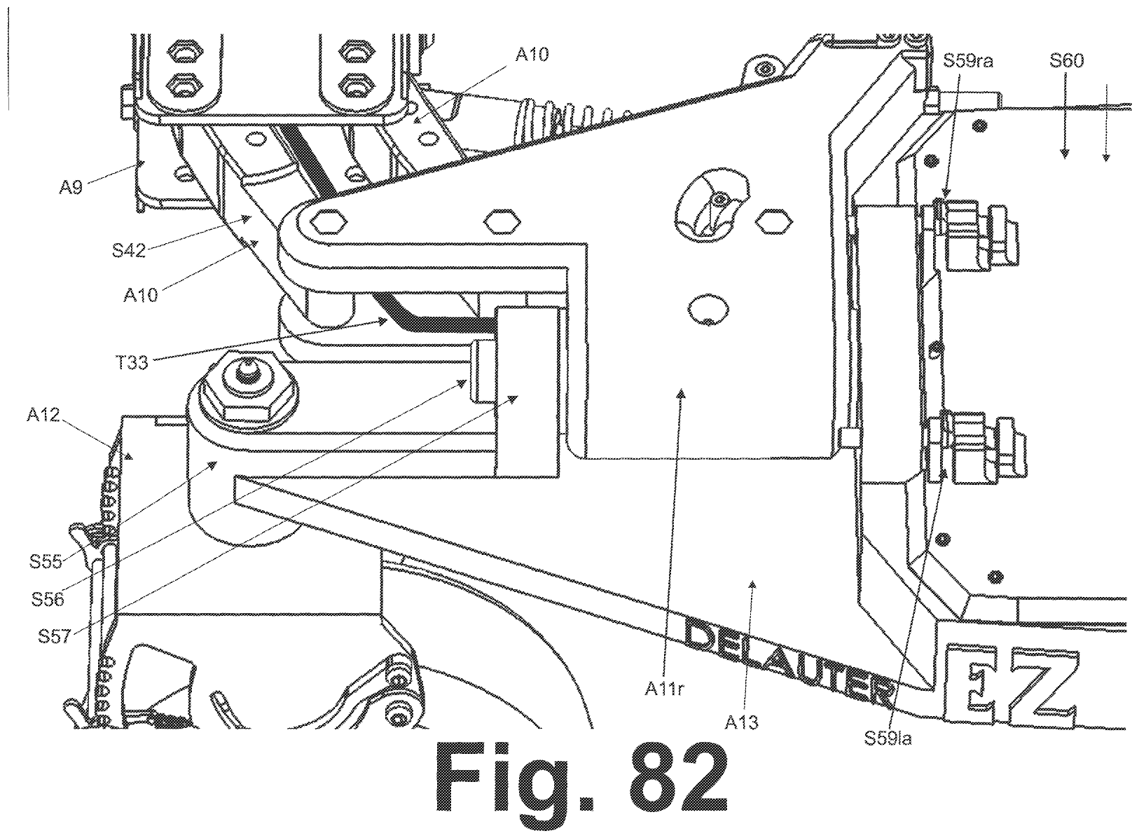

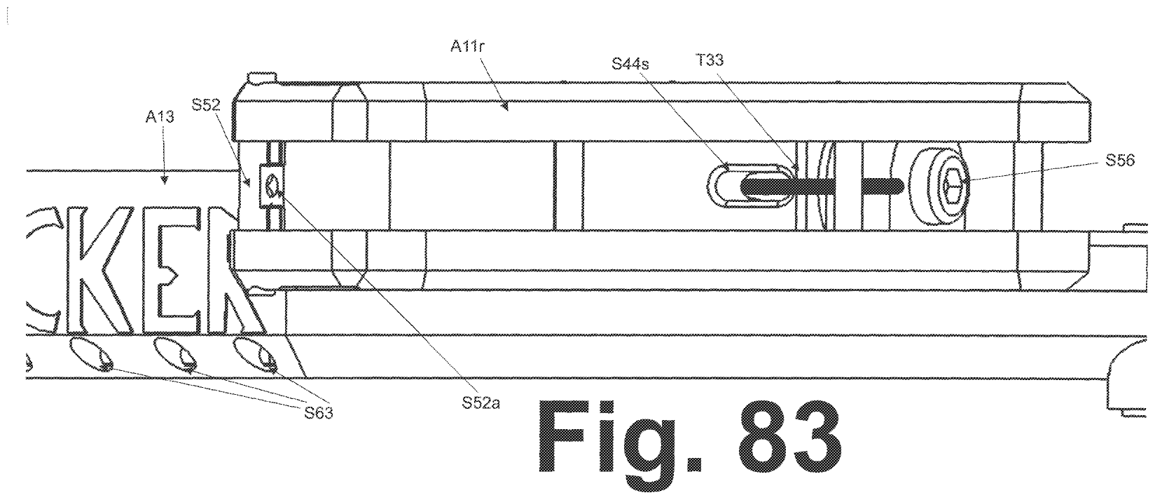

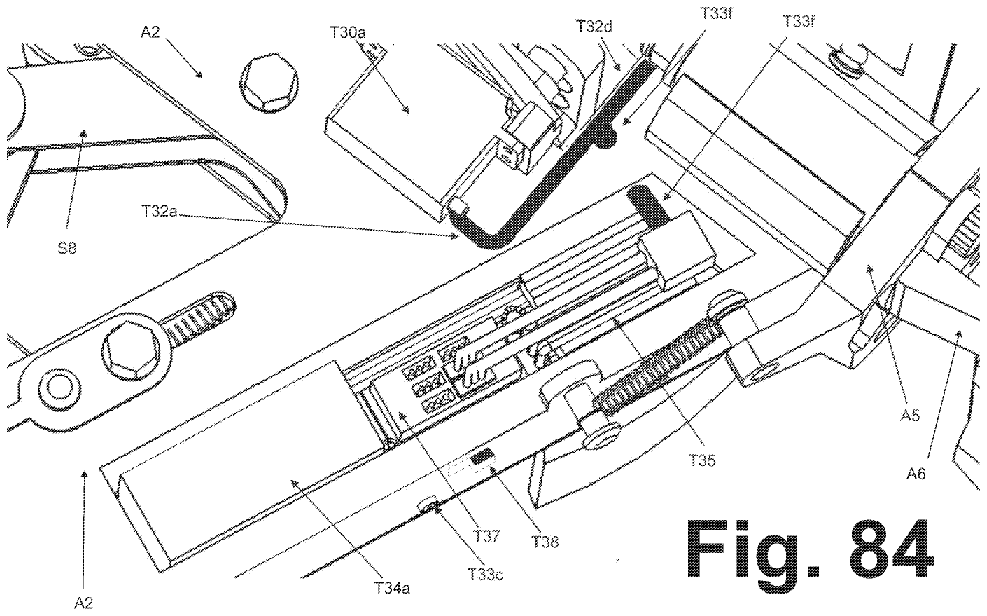

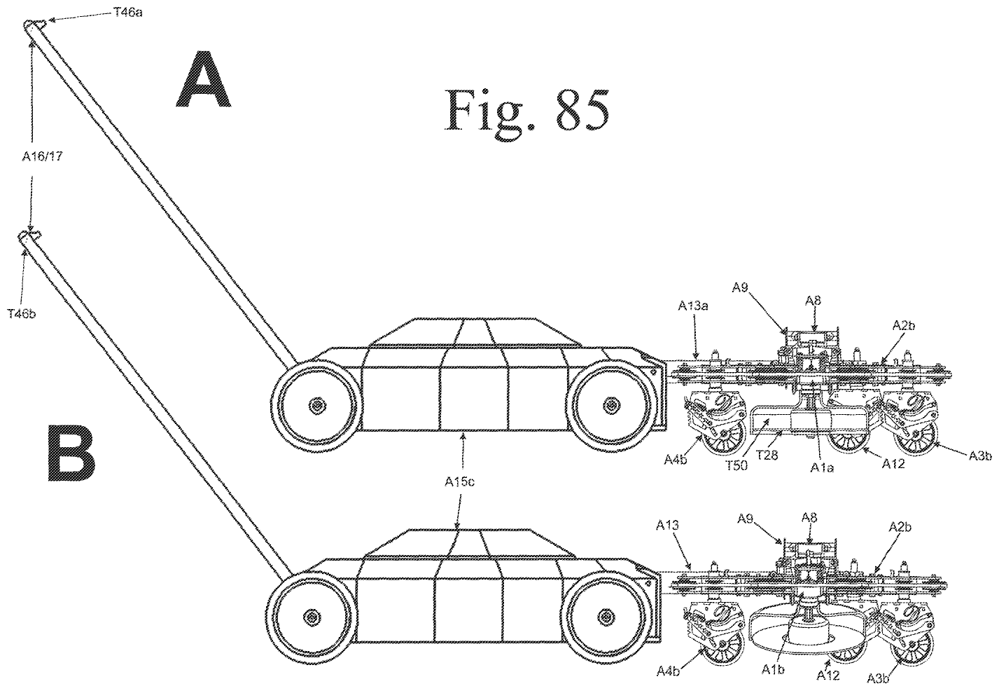

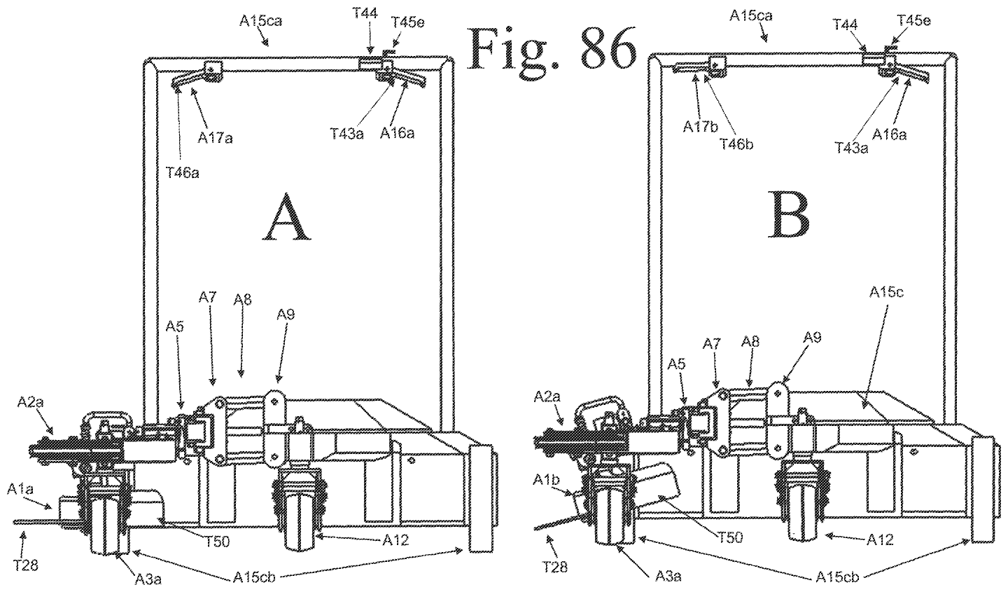

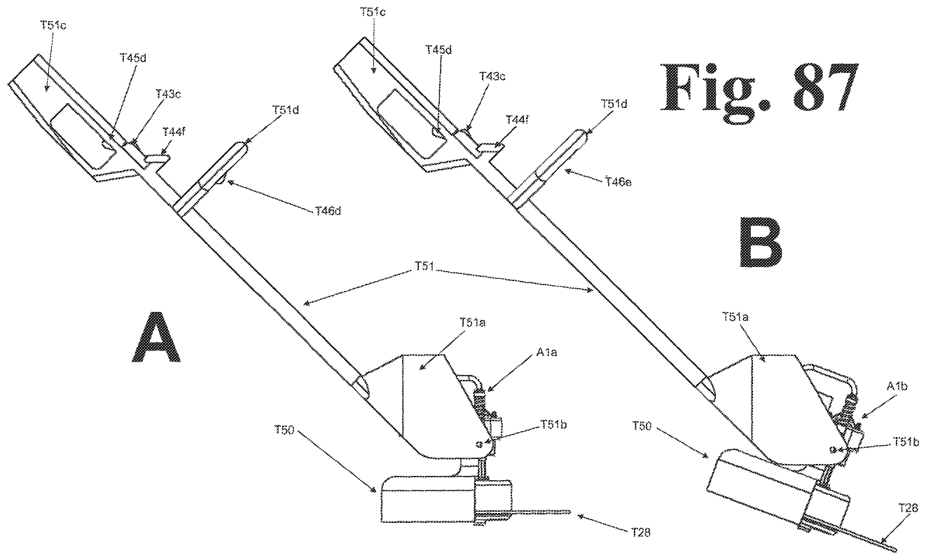

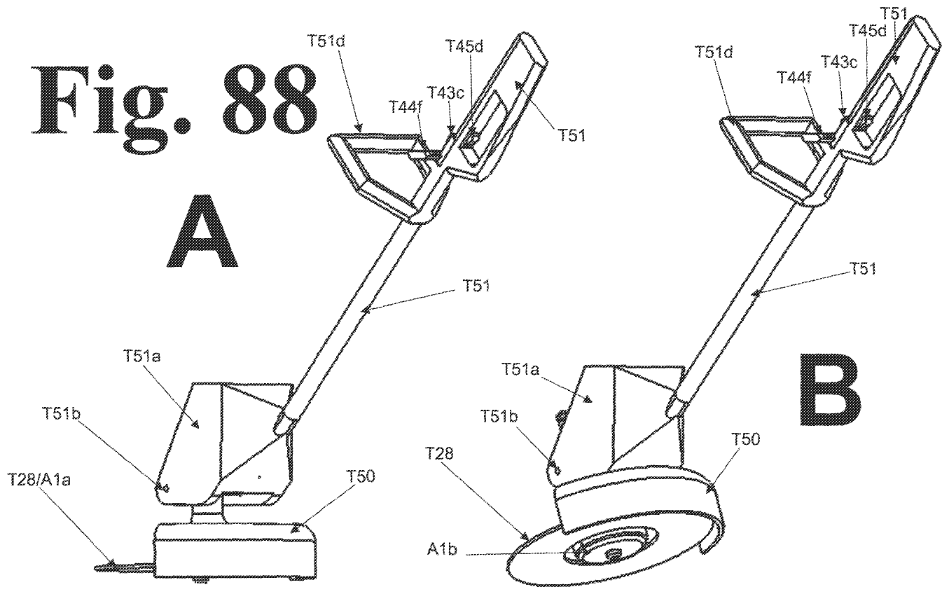

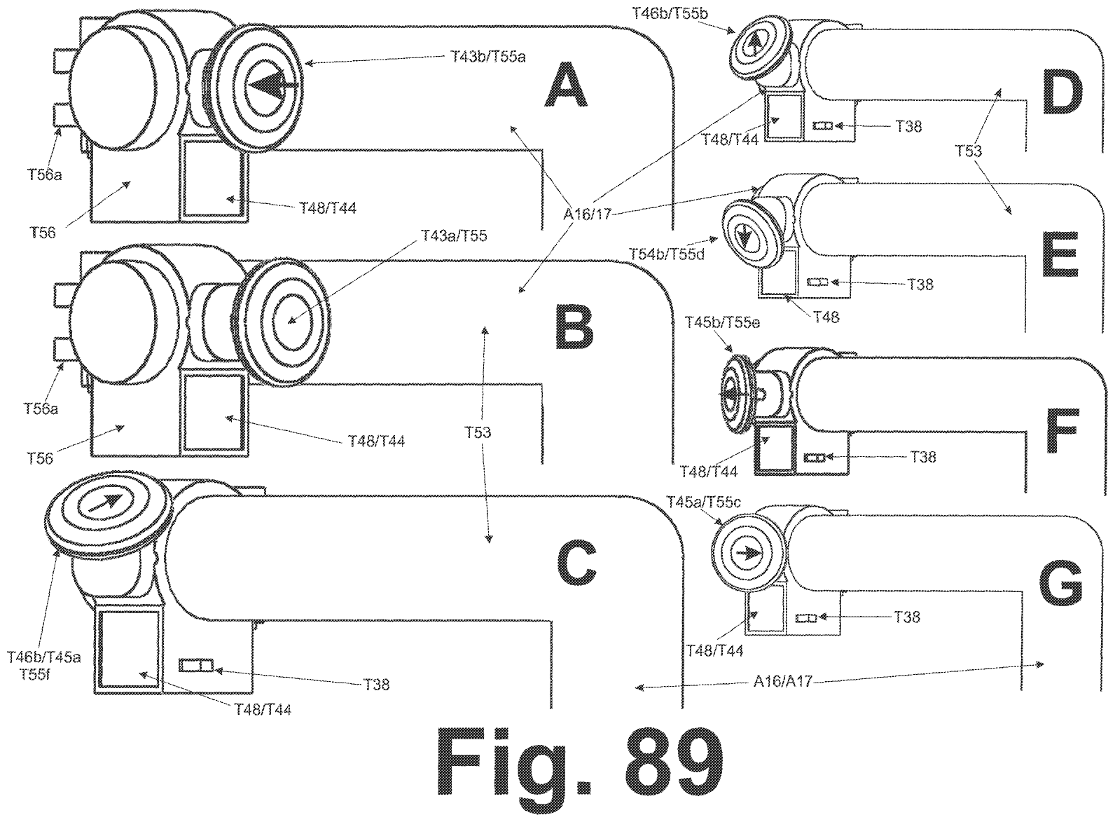

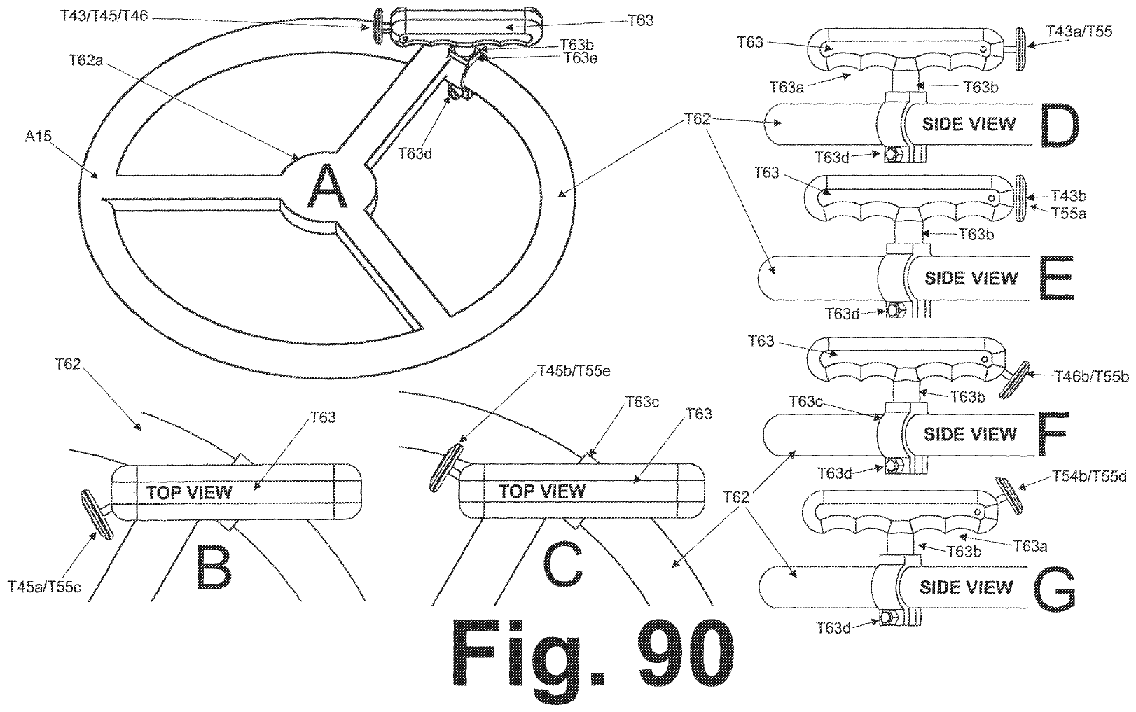

FIG. 21-4 picture demonstration of how to safely load tension spring for level 1 suspension.
A.) Demonstrates no tension on spring S10a. With no to minimal tension making it easier to change a tension spring. Lock bolt S13a is loose so tensioner bolt S12a/b can slide freely within tensioner slot S14.
B.) Demonstrates tensioner S11b pulled in position along slot S14 which creates tension on spring S10b making belt S1 tight. Lock bolt S13 is still not locked in place.
C.) Demonstrates same a FIG. 21B but with lock bolt S13b securing tensioner S11b in position.
D.) Demonstrates level 1 suspension compression with pulley S2 in position B with belt compressing inward S1b while spring S10c extends from tensioner arm S8b rotating inward from a combination of S2b, S7b, and S9b.

FIG. 22—Four picture demonstration of level 1 suspension, a version without a user friendly tensioner to make it easier to load springs S10 is demonstrated in FIGS. 22A & B. FIGS. 22 C & D demonstrate a tensioner on pulley S5, not shown in any other examples.
A.) Demonstrates normal position of level 1 suspension non compressed position.
B.) Demonstrate right side compression of level 1 suspension under an impact.
C.) Demonstrates a tensioner used to keep constant pressure on belt S1. Normal position, ready to absorb frontal impact.
D.) Demonstrates a frontal impact which extends spring S10e while forcing pulley S5 inward towards middle of coaster assembly A2.

FIG. 23. Coaster Assembly-Shows basic assembly what is referenced as (Coaster Assembly) A2 connecting to Cam A5, 2-Way Pivot A6, Lower Control Assembly A7. Trim Assembly A1a is in level cutting position. Level 1, 2, & 3 suspension all in normal position. Caster height in highest position.

FIG. 24. Demonstrates how the coaster assembly as defined in FIG. 23 can adjust to land depending on dips, hills, drops, obstacles and more. By rotating at point S19 the operator does not have to control one of the angles of the trimmer. Naturally the coaster assembly will adjust so user only needs to change cut angle at trimmer A1a/b, throttle, extending string, and driving mower.
A.) Demonstrates front side of coaster assembly lower than rear side A2d. Spring S15 is in position B as shown in FIGS. 25A and 26C. Spring S15b is creating down force on caster A4 to help level coaster assembly. Cam S21 with pin S16d keeps coaster assembly from flipping over 180 degrees.
B.) Demonstrates front side of coaster assembly higher than rear side of assembly A2e. As in if going up a steep hill or if the rear wheel drops into a deep hole. Not shown, but rear spring S15d is creating down force on front caster A3 keeps coaster assembly grounded at all times.

FIG. 25. Demonstrates close up views of spring S15 used to level coaster assembly and assist in making cam S21 work more efficiently without doing major damage to Limiting Pin S16d and bolt S19.
A.) Demonstrates rear of coaster assembly is higher than front, front spring S15b in position which is extended naturally creating upward force to help level coaster assembly A2d while the rear side spring is in compressed position S15e.
B.) Demonstrates front of coaster assembly is higher than rear A2e, from spring S15c in non-extended position while rear spring S15d is extended under tension, creating downward force on front wheel A3 to help level and correct itself naturally.

FIG. 26. View of 4 pictures Level 2 Suspension which demonstrates movements of coaster assembly from level to rear side higher than front as shown in C & D. Shows limit slot S21 and Limiting Pin S16d working with springs S15.
A.) Backside rear side of coaster assembly showing level springs S15a. No compression or extension to any levels of suspension. Level position.
B.) Front side rear side view of coaster assembly A2 showing even level 2 suspension and pin S16d in middle of cam S21.
C.) Demonstrates front of coaster assembly lower than rear side of coaster assembly which extends spring S15b and pin S16d rotates along cam/slot/limit S21 almost too stopping point/limit.
D.) Demonstrates rear side of coaster assembly A2d is higher than front which shows spring S15e while the front side spring is extended S15d creating downward force on rear caster A4.

FIG. 27. 5 pictures top view which shows how level 3 suspension works with absorbing impact and how spacers can affect cut angle for more user control.
A.) Normal Cutting Position. Coaster Assembly parallel with mower.
B.) One spacer in position S29b which puts the front point of coaster assembly slight angled inward toward middle of mower.
C.) Two spacers in position S29c which puts the front point of coaster assembly further angled inward toward middle of mower.
D.) Normal spacer position with front spring compressed S27d while rear spring extends S28d under impact rotating at point S24a.
E.) Normal spacer position with rear spring compressed S28e while front spring extends S27e under impact rotating at point S24a.

FIG. 28. 5 pictures side view which shows how level 3 suspension works with absorbing impact and how spacers can affect cut angle for more user control.
A.) Normal Cutting Position. Coaster Assembly parallel with mower.
B.) One spacer in position S29b which puts the front point of coaster assembly slight angled inward toward middle of mower.
C.) Two spacers in position S29c which puts the front point of coaster assembly further angled inward toward middle of mower.
D.) Normal spacer position with front spring compressed S27d while rear spring extends S28d under impact.
E.) Normal spacer position with rear spring compressed S28e while front spring extends S27e under impact. Shows back side of cam A5 as coaster assembly A2 rotates into position A2j.

FIG. 29. 5 pictures top expanded view which demonstrates how level 3 suspension works with absorbing impact and how spacers can affect cut angle for more user control. Shows a larger assembly which features all 5 levels of suspension including Main A, A-Aarm, and more.
A.) Normal Cutting Position. Coaster Assembly parallel position A2f with mower and Main A.
B.) One spacer in position S29b which puts the front point of coaster assembly A2g slightly angled inward toward middle of mower.
C.) Two spacers in position S29c which puts the front point of coaster assembly A2h further angled inward toward middle of mower.
D.) Normal spacer position with front spring compressed S27d while rear spring extends S28d under impact. Coaster assembly in position A2i with front caster A3 further away from caster A12.
E.) Normal spacer position with rear spring compressed S28e while front spring extends S27e under impact. Coaster assembly in position A2j with front caster A3 closer to caster A12 than FIG. 29A, B, C.

FIG. 30. Front view of 4 pictures of mower with The weed whacker demonstration different motion of A-Arms S30 & S31 which keep coaster assembly parallel at all points while naturally adjusting with the land at all pivot points.
A.) Normal cutting position.
B.) Coaster assembly is much higher than mower while lifting A7b above to adjust to a hill or object.
C.) Coaster Assembly A2 lower than mower deck adjusting to lower ground than what the mower has reached.
D.) Coaster assembly slightly higher than mower cut height A-Arms S30 & S31 are parallel.

FIG. 31. Two pictures demonstrating different views of level 4 suspension in action similar to FIG. 30D. Gives an overall picture showing tension on spring S33.
A.) Top Angle view of right hand cutting showing Main A A13, Rotating Assembly S44/A11r, A10, A9, A8 (S30/31), A7, A6, A5, A4, A2, A1. Demonstrates coaster assembly A2 can stay parallel while level 4 suspension is activated.
B.) Side Angle view of level 4 suspension showing tension on spring S33a which in return creates downward force on upper a-arm S30 which transfers to coaster assembly A2 to casters A3/A4.

FIG. 32. Side angle view of 5 pictures demonstrating the process of switching tension of level 4 suspension from right hand cutting to left hand cutting.
A.) Demonstrates tension spring tensioner S35a set up for right side cutting but was switched to left side cutting position.
B.) Lock bolt S36b removed to allow tensioner S35 to rotate at point S37a along slot S37d to change into left hand cutting position.
C.) Demonstrates tensioner S35b starting to rotate to switch tension downward for left hand cutting.
D.) Tensioner S35c in position for left hand cutting creating tension for level 4 suspension. Lock pin S36b still not installed.
E.) Tensioner S35c switched from right to left side tension for level 4 suspension. Lock pin S36a installed at point S37c, with tensioner locked into position.

FIG. 33. Right rear and side angle views of level 4 suspension.
A.) Shows angle view of a-arms A8d in near level position. Spring S33a extended creating downward force on coaster assembly A2.
B.) Rear view of level 4 suspension with a-arms A8d in near level position creating down force on top a-arm S30 which creates down force on coaster assembly A2.
C.) Angle view of a-arms S30/S31 creating minimal tension on spring S33b while tensioner slide bolt S39c moves along slot S37e to help shift tension between springs S33/S34.
D.) Rear view of a-arms S30/S31 in position A8a. Slide bolts S39a moved along slot S37e.

FIGS. 34. A & B demonstrate rear view of Level 4 suspension experiencing two different height positions with tapered cutting Alb and level cutting demonstration A1a. C & D demonstrates close up examples of taper cut tilt mechanism controlled through cable T30da.
A.) Shows trimmer in higher position with the lower and upper a-arms adjusting to lower land. Tapered cut Alb while demonstrating an example of the angle grass would be cut. Does not show guard T50.
B.) Above parallel position A8b which pulls downward with spring A33 on coaster assembly helping to keep casters A3/A4 on land. Shows guard T50.
C.) Cable controlled taper cut, demonstrating tilt linkage T27b is forced to rotate along point T27d as cable T30da shortens lifting tilt linkage T20 upward lifting point T7g shown in FIG. 60. Motor housing T7 rotates along point T7a as limit pin T9aa within slot T31 to reach max rotation point T31d.
D.) Cable controlled level cut, demonstrating cable T30ca extending in length causing tilt linkage T27a and motor house T7 to rotate in level resting position T31c within tilt limiting slot T31.

FIG. 36. Side Top Angle View of Level 5 suspension reverse tensioner. The tensioner is designed for the operator to safely reduce or increase spring tension.
A.) Demonstrates the tensioner in non-tensioned position with spring S48a creating minimal pulling force on arm S46a.
B.) Nut S51c is tightened pulling S49 along slot S50b creating tension on Spring S48b creating force on arm S47b.

FIG. 37. Top View Level 5 tensioner
A.) Minimal tension on level 5 tensioner with tension bolt S51a placing spring bolt S49 in position S50a along slot creating minimal force with spring S48a.
B.) Tensioner in maximum position along slot S50b pulling two way arm S47b backwards under force from spring S48b.
C.) Finger grip tensioner S67 in highest tensioned position T67f to assist with pulling two was suspension arm S47 back into normal operating position.
D.) Finger grip tensioner S67 in lowest tensioned position S67e to assist with pulling two way suspension arm S47 back into normal operating position.

FIG. 38. Top View demonstrating Level 5 Suspension without mower A15, 3 pictures demonstrating normal, frontal collision, and reverse impact.
A.) Normal Cutting Position with tensioner spring S48b pulling arm S47b toward mower while main spring S46a is in normal position.
B.) Compressed level 5 shock absorber S46b compresses against two way suspension arm S47b causing A9b to pivot a-arms A8 and coaster assembly A2 closer towards front of mower.
C.) Spring S48c is extended from arm S47c pivoting allowing assembly A9c to pull forward in a reverse collision. Spring S48 will naturally help pull arm S47 into position S47b.

FIG. 39. Top view of 3 example of level 5 suspension. Shows close up view of main shock S46 moving with A9 and arm S47.
A.) Normal position with two way arm S47b forced towards mower with arm lock pin S47d at max rotation point on limit slot S44b. Shock S46a in normal position.
B.) Shock S46b is compressed pushing against two way arm S47b allowing arms S43b/S42b to rotate towards mower moving A9 into position A9b.
C.) Spring S48c extends while two way arm S47c rotates at point S44a place limit pin at position S47e along limit slot S44b. Since S47c rotates, it moves shock S46c to allow arms S43c/S43c to shift A9c away from mower.

FIG. 40. Side view of showing how two way arm S47 affects multiple components whenever rotating form positions S47b to S47c.
A.) Normal position. Shows rotation points for S47 at point S44a, S43 at point S44d, and S42 at point S44e.
B.) Spring S48 extends allow S47c to rotation at point S44a allows A9c to move further away from mower.

FIG. 41. Top view of 4 pictures showing A& B having the width relative to edge of T28 to middle caster A12 is narrower than C & D.
A.) A9d has arms S43 and S42 mounted at holes S41a to match with a smaller mower deck than needed for A9e.
B.) A9d has arms S43 and S42 mounted at holes S41a.
C.) A9e has arms S43 and S42 mounted at holes S41c extending the width to match with a larger mower deck.
D.) A9e has arms S43 and S42 mounted at holes S41c extending the width to match with a larger mower deck.
E.) Shows telescoping arms S42/S43 set at the widest width adjustment. In this position A9 travels further during a front or rear impact.
F.) Shows telescoping arms S42/S43 set at the narrowing width adjustment. In this position A9 travels less distance during a front or rear impact.

FIG. 42. Grouping of photos showing process used to switch right hand cutting position to left hand cutting position. A through E demonstrates only the assemblies needed to switch cutting positions while F through H demonstrates switching cutting positions while showing the Zero turn mower.
A.) In right cutting position A11r. Shows two pictures above, top picture is in locked position, with pin S59ra locked into A11ra. Bottom picture shows pin S59rb unlocked from A11rb.
B.) Since pin S59rb has been unlocked from A11rb, rotating at point S56 allowing Alla to start transitioning from right to left.
C.) A11b is in near vertical position as switching from right to left is halfway done.
D.) A11b is in left cutting position but coaster assembly A2 has not been release from cam A5/A6 to rotate 180 degrees.
E.) User pulls pin S22 to allow coaster assembly to rotate 180 degrees to allow coaster assembly to rest on both casters A3/A4. User must lock pin S59la to keep The weed whacker secured in left side cutting position A11la.
F.) The weed whacker located on right side of mower set for right side cutting.
G.) The weed whacker transitioning from right to left side cutting. A11c is unlocked and rotating towards position A11l. Shows coaster assembly A2 pivots 90 degrees while in process of making full 180 degree turn.
H.) The weed whacker is in left side cut position with right to left mount in position A11l. Coaster assembly A2 has rotated 180 degrees from FIG. 42a.

FIG. 43. Front view of mechanism which starts with The weed whacker in right cutting position A11r but shows the process of unlocking and rotating A11r to switch to left side A11r.
A.) Top view of rotating assembly A11 demonstrating lock/slide pin S45a locked in place along slot S44i, S45b is mounted into A13. On left side of photo slide pin S45 is separated from A11 to show compression spring S45e in non-compressed position while also showing taper point S45g used for aligned pin into lock hole S58c. Slide lock pin S45 moves within assembly A11 to lock and unlock.
B.) Top angle view of rotating assembly A11r locked into right cutting position. Lock/Slide pin S45a is secure within mounting hole S58c.
C.) Top angle view of rotating assembly A11r unlocked in right cutting position. Lock/Slide pin S45c is disengaged. Free to rotate.
D.) Top view of rotating assembly A11r unlocked in right cutting position. Located to left of assembly there is a demonstration of spring S45f compressed showing how energy is stored within lock/slide pin to help lock and keep pin S45 secured within mounting holes S58c. S58d demonstrates pin disengaged from A13.
E.) Top angle view of rotating assembly in unlocked left cutting position A11l. Slide lock pin S45c is disengaged from mounting hole S58c.
F.) Top angle view of rotation assembly in locked left cutting position A11l. Slide lock pin S45a is secured within mounting hole S58c keeping rotating assembly locked into left cutting position.
G.) Front angle view of enlarged assemblies showing rotating assembly A11b in vertical position while transitioning to cutting position determined by user/operator.
H.) Front angle view of enlarged assemblies showing rotating assembly A11l locked into left cutting position with slide lock pin S45a secured within mounting hole S58c.

FIG. 44. Shows two pictures of the process used to release pin S22 to allow cam A5 with coaster assembly A2 to rotate 180 degrees against A6.
A.) Pin S22a locked in right hand cutting position while rotating assembly A11lb has coaster assembly in left hand position. Since pin S22a is locked coaster assembly is upside down.
B.) S22b unlocked pin will allow user to rotate 180 degrees as shown in FIG. 44D/E or FIG. 45A,B,C,D,E.

FIG. 45. Shows 5 pictures defining the process which is used to rotate coaster assembly 180 degrees when switching cut orientation from right to left or left to right. Demonstrates the rotation between A5 and A6.
A.) Locked pin S22a has cam A5 in right hand cutting position. Locked into hole S17b.
B.) Pin S22b is unlocked allowing pin S22b to slide along slot S18b to begin rotation for switching cut orientation.
C.) Pin S22b unlocked with cam A5c 90 degrees into rotation along slot S18c.
D.) Pin S22b unlocked with cam A5c successfully rotated 180 degrees from FIG. 45A along slot S18d.
E.) Pin S22a locked into hole S17c securing cam A5e to A6 a mounting point S26f. Coaster assembly is now setup for left side cutting.

FIG. 46. 4 pictures of external trim head defined in FIGS. 58, 59, and 60. Shows how stepper/servo T30a/b creates tapered or even cut A1a/b. Shows cables supplying controls T32a/d/e.
A.) Side view of trimmer assembly with external trim head in level cutting position A1a with servo/stepper controls T30a.
B.) Side angle view of trimmer assembly with external trim head in level cutting position A1a with servo/stepper controls T30a.
C.) Side view of trimmer assembly with external trim head in tapered cutting position Alb controlled by servo/stepper T30b along slot T31b.
D.) Side angle view of trimmer assembly with external trim head in tapered cutting position Alb controlled by servo/stepper T30b along slot T31b.

FIG. 47. 4 pictures of internal trim head defined in FIGS. 61, 62, 63, 64, 65, 66, 67, 68 with cut angle controlled by servo/stepper T30a/b.
A.) Side view of trimmer assembly with external trim head in level cutting position A1a with servo/stepper controls T30a.
B.) Side angle view of trimmer assembly with external trim head in level cutting position A1a with servo/stepper controls T30a.
C.) Side view of trimmer assembly with external trim head in tapered cutting position Alb controlled by servo/stepper T30b along slot T31b.
D.) Side angle view of trimmer assembly with external trim head in tapered cutting position Alb controlled by servo/stepper T30b along slot T31b.

FIG. 48. 4 pictures showing internal and external designed trim heads in level cutting position A1a or tapered cutting position Alb controlled by stepper/servo T30a/b. Both styles mount and pivot the same way. Interchangeable.
A.) Internal trim head in level cutting position A1a controlled by servo/stepper T30a.
B.) Internal trim head in tapered cutting position Alb controlled by servo/stepper T30b.
C.) External trim head in level cutting position A1a controlled by servo/stepper T30a.
D.) External trim head in taper cutting position Alb controlled by servo/stepper T30b.

FIG. 49. 4 pictures demonstrating external trim head defined in FIGS. 58, 59, and 60. Shows how cable T30c/d controlling tapered or even cut A1a/b. Shows cables supplying controls T32a/d/e.
A.) Side view of trimmer assembly with external trim head in level cutting position A1a with cable controls T30c.
B.) Side angle view of trimmer assembly with external trim head in level cutting position A1a with cable controls T30c.
C.) Side view of trimmer assembly with external trim head in tapered cutting position Alb controlled by cable T30d along slot T31d.
D.) Side angle view of trimmer assembly with external trim head in tapered cutting position Alb controlled by cable T30d along slot T31d.

FIG. 50. 4 pictures of internal trim head defined in FIGS. 61, 62, 63, 64, 65, 66, 67, 68 with cut angle A1a/b controlled by cable T30c/d.
A.) Side view of trimmer assembly with external trim head in level cutting position A1a with cable controls T30c.
B.) Side angle view of trimmer assembly with external trim head in level cutting position A1a with cable controls T30c.
C.) Side view of trimmer assembly with external trim head in tapered cutting position Alb controlled by cable T30d along slot T31d.
D.) Side angle view of trimmer assembly with external trim head in tapered cutting position A1b controlled by cable T30d along slot T31d.

FIG. 51. 4 pictures showing internal and external designed trim heads in level cutting position A1a or tapered cutting position A1b controlled by cable T30c/d. Both styles mount and pivot the same way. Interchangeable.
A.) External trim head in level cutting position A1a controlled by cable T30c.
B.) External trim head in taper cutting position A1b controlled by cable T30d.
C.) Internal trim head in level cutting position A1a controlled by cable T30c.
D.) Internal trim head in tapered cutting position A1b controlled by cable T30d.

FIG. 52. 4 pictures of external trim head defined in FIGS. 58, 59, and 60. Shows how hydraulics T30e/f controlling tapered or even cut A1a/b. Shows cables supplying controls T32a/d/e.
A.) Side view of trimmer assembly with external trim head in level cutting position A1a with hydraulic controls T30e.
B.) Side angle view of trimmer assembly with external trim head in level cutting position A1a with hydraulic controls T30e.
C.) Side view of trimmer assembly with external trim head in tapered cutting position A1b controlled by hydraulics T30f along slot T31f.
D.) Side angle view of trimmer assembly with external trim head in tapered cutting position A1b controlled by hydraulics T30f along slot T31f.

FIG. 53. 4 pictures of internal trim head defined in FIGS. 61, 62, 63, 64, 65, 66, 67, 68 with cut angle A1a/b controlled by hydraulics T30e/f.
A.) Side view of trimmer assembly with external trim head in level cutting position A1a with hydraulic controls T30e.
B.) Side angle view of trimmer assembly with external trim head in level cutting position A1a with hydraulic controls T30e.
C.) Side view of trimmer assembly with external trim head in tapered cutting position A1b controlled by hydraulics T30f along slot T31f.
D.) Side angle view of trimmer assembly with external trim head in tapered cutting position A1b controlled by hydraulics T30f along slot T31f.

FIG. 54. FIG. 51. 4 pictures showing internal and external designed trim heads in level cutting position A1a or tapered cutting position A1b controlled by hydraulics T30e/f. Both styles mount and pivot the same way. Interchangeable.
A.) External trim head in level cutting position A1a controlled by hydraulics T30e.
B.) External trim head in taper cutting position A1b controlled by hydraulics T30f.
C.) Internal trim head in level cutting position A1a controlled by hydraulics T30e.
D.) Internal trim head in tapered cutting position A1b controlled by hydraulics T30f.

FIG. 55. Front operator view of the weed whacker on level ground with cut assembly A1a on left side with no tilt. Shows operator controls with nothing being activated

FIG. 56. Shows operator view of the weed whacker located on left side of mower with user activating control T46b to create a taper cut A1b.
A.) Shows operator using brake lever to pull on cable T30d to allow tapered rotation of cut A1b.
B.) Shows joystick controls to create tapered cut which could use servo/stepper to pull on cable or simply be switch to versions shown in FIG. 51a, b, c, d.

FIG. 57. Shows 5 pictures demonstrating normal string locked at length in A & B whiles pictures C, D, E shows user controlled activation of T43b to lengthen string.
A.) String locked at length showing internal trim head as defined in FIG. 58. User not activating any controls.
B.) User controls/joystick in normal position not affecting The weed whacker.
C.) Shows operator view of programmer/controls T44 and user controls tilt/angle adjust combined into one control. User pushes upward with finger to activate string extension T28b which pulls T17b upward.
D.) Cable T23b pulls T17b upward lengthening string T28b.
E.) Shows commonly known as a brake lever T43b pull towards grip T451a which would pull cable T23b upward lengthening string T28b.

FIG. 58. For A & B demonstrates front and front angle view of externally operated trim head whenever string T28 is locked at length. Powered by motor T1 and combination of a hollow shaft T11 with activating rod T24 sliding within shaft T11 to pull T29 upward or stay in locked position as showed in A & B. For C & D demonstrates front view and front angle view of externally operated trim head whenever string T28b is released to increase length. T29b is hidden because it's being pulled up by rod/bolt T24b to release the spool within T12c as if bumping off of ground.
A.) T29 is fully visible which would be used to bump off of the ground on a traditional trimmer commonly used/sold today and in the past, whereas rod T24 through mechanical movement mimics the ground pulling T29 upward so the user does not have to do damage to lawn.
B.) Front angle view of external trimmer assembly. Springs T18 push carriage T17 downward keeping tension on cable T23a when operator is not using control T43.
C.) Front view of carriage T17b moving upward along slides T15 compressing spring T18b while pulling T19b upwards releasing spool to extend string.
D.) Front angle view of carriage T17b moving upward along slides T15 compressing spring T18b while pulling T19b upwards releasing spool to extend string T28b.

FIG. 59. Exploded views of external trimmer showing the inner workings. As shown T24 connects to the bottom of T29. Shows hollow shaft above T11d, shows how motor T1 connects to shaft through belt T11b while being able to be tensioned at point T16c. Shaft T11 mounts to bearing T16b. Linear bearing carriage T17 mounts to linear slides T15 while shaft T24 stays centered within bearing T17c not labeled.
A.) Angled view showing bottom of assemblies and components involved with external trim head assembly.
B.) Angled view showing top of assemblies and components involved with external trim head assemblies.
C.) Close up image demonstrating activation cone T25 locking into pin T24h/T4. The activating cone T25 naturally centering within bearing T17c.

FIG. 60. Multiple side photos of trimmer assembly using drive shaft T49 which is similar to drive shaft T11 in regards to mimicking ground impact with T24, but shares similar qualities to drive shaft T10 by directly connecting to Motor T1 and using slot T49a to provide the up and down movement along drive shaft needed to lock and release string spool T29.
A.) Demonstrates a conventional bump head trimmer spool T29 with string locked at length by showing movement of engage arms T9 relative to movement Ab/Ac typically hidden within components T12/T7/T49.
   a.) Demonstrate drive shaft T49 showing mounting points T49b/c/d and slot T49a while also giving a fixed reference point to demonstrated movement change of Bb/Bc relative to FIG. 60Ab/Ac.
   b.) Demonstrates centering cone T25 located at lower point of slot T49a relative to movement of engage linkage T9 moving downward, locking string at length.
   c.) Demonstrates spool T29 locked into T12 to keep string at currently length.
B.) Demonstrates a conventional bump head trimmer spool T29 lifted upward by engage linkage T9. Examples Bb/Bc demonstrate the upward movement of spool T29 relative to fixed driveshaft T49 (FIG. 60Ba and FIG. 60B).
   a.) Demonstrate drive shaft T49 showing mounting points T49b/c/d and slot T49a while also giving a fixed reference point to demonstrated movement change of Bb/Bc relative to FIG. 60Ab/Ac.
   b.) Demonstrates centering cone T25 relative to upper point of slot T49a.
   c.) Demonstrates with arrows upward movement of spool T29 to allow string to increase length.

FIG. 61. 6 pictures demonstrating lock & unlocking mechanism to remove spool T29 from engage rod/shaft T24, while also demonstrating the internal splines with a bump head string spool assembly T12c/T29;
A.) Normal position with engage rod lock T24fa set into bushing T24e.
B.) Bottom of spool T29 is pushed upward which compresses spring T29c, creating distance between T24d/T24e.
C.) Same example as FIG. 61B but locking mechanism T24fb is rotated 90 degrees vertically to prepare for removal of spool cover T12ca.
D.) Demonstrates removal of spool cover T12cc as locking mechanism remains unlocked T24fb. From bottom view you can see spool splines T29e which lock and release with casing splines T12cb.
E.) Demonstrate removal of spool T29 and cover T12ca. Demonstrates spring T29c which is used to keep spool splines T29e locked into casing splines T12cb during normal use.
F.) Demonstrates two different bushing used to ensure free spinning of spool T29 whenever pulled upward to change string length. Bushing T24d houses locking mechanism T24fa/b while rotating within lubricated bushing T29d which is pressed into bottom of spool T29g.

FIG. 62. 3 Pictures using direct to motor drive shaft T10 and activation drive shaft T13 to demonstrate normal locked position A while B & C demonstrate string extension. Assemblies are partially separated to reveal inner workings.
A.) Activator arm T9a is in normal locked position with carriage T6 shown within T7.
B.) Activator arm T9b is in extension position lifting linear bearing carriage T6 upward within T7, pulls T5 upward which pulls pin T4 through hole on activator shaft T13c along slot T10d.
C.) Shows further break down of internal trim head with linear bearing carriage T6 lifted out of T7. Shows breakdown of activator shaft T13 and the components which make it work. T13f keeps spool T14 centered whenever T13 is pulled upward releasing T13d from T14b to allow string to lengthen.
   3 pictures showing partial assemblies in normal position A and string lengthening in C. A servo/stepper T8 is used to move arm T9 to raise or lower T13.
A.) Splines on activator shaft T13a which is defined by T13d is connected to spool T14b and T12d which locks string at length.
B.) Shows T12 from bottom view to give example of splines built within T12 to allow shaft T13d, a, b or T57c to slide within. In the middle shows spool housing T12 from underneath which reveals where T13d makes contact with T12d and spring T12e which pushes down on spool to keep contact with centering pin T12f.
C.) Shows side picture of internal partial assembly with shaft T13b released from spool T14b. Shaft T13b would slide up within spine T12d. Spool T14 spins along centering pin T12f on spool cover and T13f or T57g. Demonstrates string free to increase length. T9b is lifted up which pulls T13d upward which disengages with T12d while T12e pushes down on the spool T14 keeping contact with centering pin T12f.

FIG. 63. 3 pictures showing partial assemblies in normal position A and string lengthening in C. Demonstrates both examples of T13a locked into spool splines T14b and T13b released from spool casing splines T14b.
A.) Splines on activator shaft T13a which is defined by T13d is connected within spool splines T14b and T12d which locks string at length.
B.) Shows spool casing T12 from bottom view to give example of splines built within T12d to allow shaft T13d, a, b or T57c to slide within to provide user with ability to extend or rewind string using mower mounted controls.
C.) Shows side picture of internal partial assembly with shaft T13b released from spool T14b. Shaft T13b would slide up within spine T12d. Spool T14 spins freely along centering pin T12f on spool cover and T13f or T57g to extend string length T28b. Demonstrates string free to increase length.
   Side and front angle view of internal functioning trimmer in normal position. Engage arm T9a allows spool to be locked in place to keep string locked at one length T28a. Servo/Stepper T8a moves engage arm along slot T9e. T11 points to blades on drive shaft to shear cable, rope, wire, brush, etc. to prevent it from damaging bearing within T7.

FIG. 64. 4 pictures demonstrating both side and angled views of trimmer assemblies with string length locked at length shown in B/D and string released to extend string length shown in A/C.
A.) Side view showing engage arm T9b in upward position allowing string T28b to extend.
B.) Side view showing engage arm T9a in downward position locking string T28a at length.
C.) Angled view showing engage arm T9b in upward position allowing string T28b to extend.
D.) Angled view showing engage arm T9a in downward position locking string T28a at length.

FIG. 65. 4 photos demonstrating rear and side angle views of internal trimmer head using a cable/s to control string extending and rewinding mechanism. Both FIG. 65A/B show a cutting mechanism T12h which is designed to cut cable/string/weeds/etc. to help eliminate premature failure at main bearing T7d.
A.) Spring T8g compresses while engage arm T9b lifts internal mechanism T6/T13/T57 as shown in FIG. 62/63 to release spool T14 within T12 to lengthen string T28b.
B.) Spring T8f helps assist in returning engage arm T9a back into normal locked position keeping string T28a at one length.
C.) Back view demonstrating a two way linkage setup T8h in combination with cables T8c/T8cr to lift T9jb upwards to engage string rewinding mechanism. Cable T8da increases in length pushing T8ha downward while cable T8dra shortens pulling point T8hd upwards rotating two way linkage T8h along point T8hc.
D.) Back view demonstrating a two way linkage setup T8h in combination with cables T8c/T8cr to pull T9 upward in order to extend string length. Whenever cable T8db shortens pulling point T8hb upwards while rotating at point T8hc, cable T8drb pulls linkage arm T8ja downward relative to T8he thus moving T9b upward.

FIG. 66. 4 Pictures used to define how rewind able spool mechanism works and how it is different within FIGS. 66, 67, 68 from FIGS. 62,63,64,65 as engage shaft is now T57 instead of T13. Basically identical in how it functions but shaft T57 is physically mounted to bearing T6b to allow two way movement instead of only upward movement demonstrated with T13/T9b for releasing string, while also using a coupler T58 mounted to bearing T2a to allow shaft T57 to slide upward or downward to lock string, release spool, or rewind spool. Now engage arm goes downward into position T9r to allow motor to spin in reverse to rewind string T28. Shows motor cooling base T1c separated from top of T2 to show example of splined shaft T1d which connects into couple T58.
A.) Engage arm rotated downward in position T9r to allow string T28 to rewind/refill supply while rotating within T12a. Shows base T7 rotating with engage arm T9 rotating at point T9c while moving T9d downward on slot T7c to create braking friction with bottom of bearing carriage T6 on drive shaft T59.
B.) Same as example A but without base T7 to show movement of Tor relative to T6b shown in FIG. 66C. T57a slides downward within coupler T58. Tor turns into a friction brake which creates downward pressure against top of shaft T59a stopping 360 degree rotation to allow spool T14b to fully engage with T57cr to revere spool with motor T1r thus rewinding spool T14d with new supply of string T28.
C.) Shows picture of engage arm T9b pulling T6 upward toward bottom of coupler T58 as spline T57a slides within coupler T58. When Toa is lifted by engage arm T9b top of shaft T59a mounted to bearing T7d is revealed. Shows bearing T2a which is mounted within top T2 or hidden within casing T7 shown in FIG. 68 (but not visible within drawings).
D.) Blowout picture of rewind able internal trim head without showing top cover T2, bottom housing T7, or spool housing T12. Shows coupler bearing T2a pulled away from coupler T58 while also showing how coupler flange T58a and fastener T58b/c secure bearing T2a to coupler. Shows linear bearing carriage bearing T6b pulled away from two piece bushing T60 to show how bushing flange T60a and fastener T57e/ea secure bearing T6b to internally sliding shaft T57 at points T57ba and T57bb. Shows base bearing T7d pulled away from shaft T59 to demonstrate how flange T59a and fastener T59b/c secure shaft to bearing T7d. Bottom of photo shows bottom of shaft T57c and centering tip T57g above spring T12e which is shown resting on top of spool T14a. Spool T14 is directly above centering pin T12f on cover of spool housing.

FIG. 67. 6 Pictures used to demonstrate internal mechanism responsible for increasing cutting string length A/B, locking string at length C/D, position which allows string T28 to rewind on spool T14 shown in examples E/F.
A.) Side view of internal head with engage arm positioned at position T9b pulling shaft T57 upward to release T57cb from top of spool T14b to allow string T28b to lengthen. Point T57ab demonstrates distance engage shaft T57 will slide within couple T58 whenever releasing spool T14.
B.) Top side view of internal head with engage arm positioned at position T9b raising T6 upward within T7. When pulled upward shaft T57 moves with carriage T6 to release T57cb from spool T14b (shown in FIG. 68D) while centering tip T57g keeps spool centered while working with centering pin T12f. Shows spring T12e which is used to push spool T14 downward to constantly spin centered and to allow string release mechanism to work properly.
C.) Side view of internal head with engage arm positioned at normal position T9a which allows shaft T57c to lock with both spool T14 and housing spline T12d (shown in FIG. 63B) Shows engage arm T9b relatively parallel with top of T7.
D.) Top angle view of internal trim head showing engage arm T9a relatively parallel with top of T7 while making T6 positioned lower within T7 than shown in FIG. 67B. Shaft T57ca is locked into top of spool T14b while also locking into T12d shown in FIG. 63B and FIG. 68G to allow spool T14 and housing T12 to spin at same speed locking string T28a at length.
E.) Side view of internal trim head showing engage arm positioned downward T9r forcing Tor lower than example shown in FIG. 67d which causes a friction brake on shaft T59 to stop 360 degree rotation. FIG. 68 demonstrate a disc brake T61aa/ab and v-brake T61ba/bb mechanism to stop rotation of shaft T59 to rewind string.
F.) Top side view of internal trim head showing engage arm positioned downward T9r forcing Tor lower than example shown in FIG. 67d which causes a friction brake on shaft T59 to stop 360 degree rotation. Shaft T57cc is fully engaged with spool T14b while spring T12e forces spool downward onto centering pin T12f shown in FIG. 68.

FIG. 68. Multiple side and angle pictures used to clearly define inner working inside of motor assembly T7 to release, lock, & and rewind cutting string T28.
A.) Side view showing mechanical movement required to extend string length relative to normal operating position shown in FIG. 68B.
   a.) Demonstrates engage shaft moved upward shortening distance between couple T58 and bushing flange T60a while engage shaft spline T57ca disengages from spool spline T14b.
   b.) Fully unlocked drive shaft T59 showing bearing carriage T6 separated from top of drive shaft T59 while disc brake caliper T61aa is in unlocked position.
   c.) Spool demonstrating height relative to engage shaft T57ca which would allow free rotation of spool T14 to increase string length.
B.) Side view demonstrating normal operating position where string T28 is locked at one length.
   a.) Demonstrates engage shaft T57 in relative position where engage into spool spline T14b and casing spline T12d to lock string at length. Locking bushing travels with bearing carriage.
   b.) Drive shaft T59 showing bearing carriage T6 spaced away from top of shaft while disc brake caliper T61aa releases from drive shaft disc rotor T59da.
   c.) Demonstrates spool T14 relative to location of engage shaft T57 which would lock into both spool T14b and casing spline T12d.
C.) Side view demonstrating mechanical movement required to rewind spool T14 to add supply/capacity of string T28.
   a.) Demonstrates downward movement of engage shaft T57c relative to T12/T14 as engage arm moves into rewinding position T9r. Engage shaft T57 moves downward while still transferring motor power as distance between bushing flange T60a and coupler T58 increases.
   b.) Demonstrates bearing carriage Tor and clamped disc brake rotor T61ab/T59db to stop rotation of driveshaft T59.
   c.) Spool shown with position of T57 fully engage into spool spline T14b while disengaging from spool casing spline T12d.
D.) Close up view demonstrating movement of activation shaft T57 fully engaged into casing spline T12d only showing centering point T59g for spool T14 rotate freely along while friction braking mechanism moves upward creating distance between T6 and T59aa whenever operator extends string length.
   a.) Demonstrates spool spline T14b disconnected from upward moving engage shaft spline T57ca to allow free spinning spool T14 to extend string length.
   b.) Drive shaft T59 spins freely as T6 is pulled upward away top of drive shaft T59aa.
E.) Unlocked v-brake mechanism allows free rotation of drive shaft T59 under normal operational use.
F.) Locked v-brake mechanism locks against drive shaft T59 to stop rotation of drive shaft T59 and spool casing T12 to allow spool T14 to spin under power from motor T1 to rewind string.
G.) Close up view demonstrating normal operating position of engage shaft T57 when locked into both spool T14b and spool casing T12d.
   a.) String spool T14 shows engage arm T59ca partially exposed for locking into casing spline T12d and partially engaged into spool spline T14b to lock string at length.
H.) Close up view demonstrating position location of carriage bearing system Tor and engage shaft T57 whenever activating string rewinding mechanism. Shows spacing between spool casing spline T12b and engage spline T57cr so spool T14 can be rotated while shaft T59 and spool casing T12 stops rotating.
   a.) Spool T14 with engage arm T57 fully engaged, arrow demonstrates downward motion.
   b.) Drive shaft T59 has bearing carriage squeezing downward between points Tod and top of shaft T59aa to stop rotation.

FIG. 69. Front angle views shows tilt and level cutting at the lowest height on casters A3b and A4b which affects coaster assembly A2b.
A.) Lowest height on both casters with a level cut A1a.
B.) Lowest height on both casters with a user controlled tilt for cutting A1b.

FIG. 70. Side view of the weed whacker with two different cut heights with a level cut and a view demonstrating different height castors changing the taper/angle of cut.
A.) Lowest level for both casters A3b/A4b causing the cut height to be at the lowest setting while making a level cut. Coaster assembly in position A2b.
B.) Highest level for both casters causing the cut height to be at the highest setting while making a level cut. Coaster assembly in position A2a.
C.) Front caster A3b is lower than rear caster A4a causing a natural tilt on coaster assembly A2c while user controls tapered cut angle A1b.

FIG. 71. Side angle view demonstrating 4 different variations to an alternative method to rapidly adjust cut height and angle. Instead of using adjustable height castors shown in (FIGS. 73, 74, 75, 76, 77, 78) FIG. 71 demonstrates a method used to change height difference between caster mounting point C32a/c and coaster assembly A2.
A.) Picture of coaster assembly A2 with two different caster heights with caster mount C32a lower than caster mount C32b.
B.) Close up picture demonstrating locking pin C34b separated from adjustable height arms C35/C36 allowing the operator to freely change height of caster relative to coaster assembly A2.
C.) Picture of coaster assembly in closer to level cutting position with casters at heights C32b/C32c while locking pin C34b is still removed.
D.) Close up picture demonstrating locking pin C34 locked into lower height arm C35 setting the caster height to position C32c.

FIG. 72. Top view of adjustable coaster assembly designed to change the angle orientation of caster assemblies and example of trimmer assembly A1 moved outward by operator to reach tight spaces without having to change direction of mower.
A.) Normal position of trimmer assembly with caster assemblies aligned with coaster assembly arms.
B.) Demonstrates outward operator controlled movement along linear rails (A1f) of trimmer assembly to reach tight places, while also demonstrating user controlled angle adjustment of the caster assembly. Caster assembly has rotated towards middle of mower at point C38a.

FIG. 73. Demonstrates a front or rear view of how adjusting the heights on casters will affect the cut height. User can adjust height accordingly to match mower height to fine tune cut quality.
A.) Shows casters set at lowest height setting A3b/A4b which puts string T28d closer to the ground putting coaster assembly into position A2d.
B.) Shows casters set at the highest setting A3a/A4a which makes string T28c further away from the ground. Puts coaster assembly into position A2a. Trim assembly has a level cut A1a.

FIG. 74. Single caster with an extensive breakdown of what the assembly is made of. Front angle view. The casters are designed to easily change height. Use for changing cut height and angle. Shows added brake rotor C2d/caliper C24 for stopping 360 degree rotation, collector ring C27 for transferring electrical current under 360 degree rotation, collector brushes C9 and harness C9a further explained at FIG. 78.

FIG. 75. Demonstration of 5 pictures showing different levels of height while locked and unlocked.
A.) Shows caster in lowest height setting locked in to place at point Coa with wheel plate in position C8a.
B.) Shows caster at lowest height but with spring lock lever C6b in unlocked position so user can change height. Free to move.
C.) Shows caster with height in the middle locked into position Coa with wheel plate in position C8b.
D.) Shows caster in unlocked position C6b free to move to change height with current height in the middle.
E.) Shows caster in locked position C6a with caster in highest height with wheel plate in position C8c.

FIG. 76. Shows 3 variations of casters in locked position from high, medium, and low.
A.) Locked into lowest height C6a. Demonstrated by guides C16a and C15a at lowest position.
B.) Locked into medium height with C6a. Demonstrated by guides C16b and C15b at medium height position.
C.) Locked into highest height position with C6a. Demonstrated by guides C16c and C15c at highest position with wheel plate located at C8c.

FIG. 77. 4 different examples of caster heights locked/unlocked.
A.) Unlocked position at lowest height with spring C21b extended when C6b is unlocked.
B.) Unlocked position around medium height with spring C21b extended when C6b is unlocked.
C.) Locked in highest height position with spring C21a in normal position which pulls lock lever C6a into locked position.
D.) Spring C21b extended by unlocked C6b, free to move/change caster height with height located near middle of settings.

FIG. 78. Large Caster with Hub Motor and Two Way Brakes—By using disc brake C2d operator can manually stop 360 degree rotation of caster or controller/computer can automatically apply brakes C24 to rotor to stop angle for controlled steering. By using collector ring C27 shown in FIG. 61, electronic brakes can be applied to caster wheel C13 for stopping or a hub motor can be applied to work with rotor C2d to give a zero turn added control with steering and forward/reverse drive propulsion/regen braking. On The weed whacker the hub motor can be used to send current back to controllers T40/T41 for regenerative charging.

FIG. 79. Coaster assembly A2 with a wireless setup minus casters A3/A4 and Trim Assembly T1. FIG. 72 demonstrates different electronic mounting location.
A.) Uncovered, showing wireless setup of battery, controller/esc, receiver and wires.
B.) Covered wireless setup. Show harness for motors T1, T8, & T30a/b.

FIG. 80. Main A also defined by A13. Shows where main harness T33 travels and splits, where battery mounts, charge controller with fan, motor controller with, vent T42, pivot points S62, battery cover mounts, and right to left pivot setup for right hand cutting T11r.

FIG. 81. Same exact picture as FIG. 80 but from different view. Shows battery location T39, where harness T33 splits, cooling, charging port T33c, and right to left mount located at A11r.

FIG. 82. Top side view of the weed whacker setup for right side cutting T11r. Shows battery cover mounted to main a A13. Shows pivot bolt S56 for T11r which allows wire to travel within to prevent damage while switching cutting sides. Demonstrates routing for wiring harness T33.

FIG. 83. Front Side view of the weed whacker positioned for right side cutting A11r while showing wiring route through channel T44s/bolt T56.

FIG. 84. Top angle view of wireless setup installed within coaster assembly A2. Shows charge controller, receiver, wiring, charge port, speed controller, on/off switch, stepper/servo T30a/b, and harnesses T32e/a. User controls A16/A17 would send wireless signal to receiver.

FIG. 85. Side view of two pictures showing The weed whacker mounted to push mower/walk behind A15c. One picture is level cut A1a while the other is tapered cut A1b. Both coaster casters A3b/A4b set to lowest height setting.
A.) Shows mower A15c with main a A13a level/parallel to mower, and trim cut angle level A1a.
B.) Shows mower A15c with main a A13a level/parallel to mower while user changes cut angle to taper cut A1b.

FIG. 86—Two front view pictures of push mower/walk behind mower A15c showing difference between user controlled taper cut A1b and level normal cut A1a.
A.) Normal level cut position A1a with no controls being activated by user.
B.) Tapered cut position A1b with user activated 17b/T46b to control cut angle of trimmer assembly.

FIG. 87—Side view of two pictures demonstrating user controlled tilt of trimmer A1b from point T51b. Allows user to keep hand controls in relative same position without having to lean and adjust body to change cut angle.
A.) Level cut position A1a trigger T52a is not affected so cut angle A1a is normal.
B.) Trigger T52b is engaged allowing trim assembly to rotate into tapered cut position A1b while rotating at point T51b.

FIG. 88—Rear angle view of two pictures showing level cut A1a and user controlled tapered cut A1b on hand trimmer similar to what is sold in stores today but with ability to use user controlled taper and string spool without bumping off of ground.
A.) Normal level cutting position. No controls affected by user.
B.) User controlled taper cut A1b while pivoting at pivot T51b. Shaft T51 doesn't change angle compared to FIG. 88a. User can control pivot without moving hand trimmer angles.

FIG. 89—7 pictures demonstrating movement of wireless joystick controls for The weed whacker mounted to a zero turn steering handle.
A.) Joystick is pushed inward to extend string length T43b.
B.) Joystick in natural position, non-affected by user.
C.) Joystick is under throttle while tilting cut mechanism.
D.) Joystick pushed in direction to change tilting angle of string cut A1b.
E.) Joystick pushed in direction to move middle of trimmer assembly outward Ale.
F.) Joystick pushed in direction to throttle motor T1 in reverse for string rewinding. Operator needs to hold joystick pushed inward for 10 seconds to reverse movement of string extension turning it into a brake for rewind mechanism.
G.) Joystick pushed in direction to throttle motor T1 in forward direction.

FIG. 90—Demonstration of 360 degree pivoting wireless hand controls to mount onto a tractor/riding mower steering wheel. Designed to allow any normal tractor to be adapted for use with The weed whacker.
A.) Angle view of fully steering wheel with 360 degree pivoting wireless controls mounted.
B.) Partial top view of steering wheel demonstrating forward throttle motor controls.
C.) Partial top view of steering wheel demonstrating reverse throttle motor controls.
D.) Side view of hand control in normal un-touched position, keeping The weed whacker at normal position without motor spinning and no tilt.
E.) Side view of hand control with joystick pushed inward to extend string T43b.
F.) Side view of hand control with joystick pushed in direction to change tilt of cut angle.
G.) Side view of hand control with joystick pushed in direction to move middle of trimmer assembly outward Ale as shown in FIG. 72b to reach tight places such as between tombstones. Once returned to normal joystick position, center of cutting diameter returns back to normal position.

Like reference characters refer to like elements throughout the drawings. Additionally, reference characters in the drawings include both a unique reference to the element as well as a reference to the portion of the specification at which that element is described. For example, T9da in FIG. 60 refers to element T9 as well as the description of element T9 on pages 63-64, paragraph d.), subparagraph a.) under T9.

### DETAILED DESCRIPTION

### Assembly Identification

### Section A

A1.) Trimmer Assembly-Motor, housings, trim head, string, & more all broken down and fully defined in T-section.
a.) Normal Level Position for cutting the lawn evenly with mower (once operator adjusts casters A3, A4, & A12 to adjust height)
b.) Tapered cut position. Allows operator to cut lawn at a taper to blend the cut.
c.) Pivot Point on coaster assembly A2 to create user controlled taper.
d.) Top view of motor assembly in normal operating position.
e.) Top view of motor assembly extended outward away from middle of mower by operator to help cut between tight place such as tombstones or in between trees, etc.
f.) Linear rails extended outward to move center of trimmer assembly away from middle of mower, controlled by the operator.

A2.) Coaster Assembly—Mounting structure for Trimmer A1 and components for level 1 and 2 suspension. Naturally floats with the land with two casters A3 & A4, pivoting/fastening onto bolt S19 allowing rotation while Main A S13 determines vertical angle (direction a-arms A8 travel) of upper and lower aarm mounts A9 & A7. The use of the combination A-arms secured to A13 which uses another caster A12 to adjust to land, helps ensure coaster assembly naturally always stays parallel to allow use of only two casters on coaster assembly so operator can focus on manually adjusting side angle taper of A1. Front caster A3 leads the forward angle of string edge (T28) of trimmer assembly A1 while caster A4 holds the height of rear side of string T28 depending how land changes while moving, constantly changing the angle making a precision cut. The front wheel can raise or lower depending on land as the rear wheel can also raise or lower to naturally adjust the cut. The operator uses coaster assembly to change height of cut and change angle by setting front caster A3 lower than rear A4. Coaster assembly helps operator move past objects such as trees, poles, walls, boulders, tombstones and more through the first level suspension with belt S1 helping the assembly roll past objects. Reference FIGS. 21-24, 46-56, 70-73.
a.) Controlled by user highest cut height with both casters set evenly. Naturally level with A13 on flat land.
b.) Controlled by user lowest cut height with both casters set evenly. Naturally level with A13 but free to float with land rotating on bolt S19.
c.) Controlled by user front caster A3b is lower than rear caster A4a causing the front side of string T28 to be lower than rear side creating a different taper angle than operator controlled angle.
d.) Front caster A3 drops lower than rear caster A4 naturally by either lowering into a low point on the ground surface naturally creating a better cut quality by flowing with land, while also making operators job easy. Or the front caster drops forward under impact which would activate level 2 suspension tension on spring S15b.
e.) Rear caster A4 drops lower than front caster A3 by either lowering into a low point on ground surface naturally improving cut quality while front caster A3 is at a higher point on the ground or an impact/collision will cause this.
f.) Top view normal position, parallel with mower.
g.) Top view spacer used to change approach angle of coaster assembly.
h.) Top view two spacers used to change the approach angle of coaster assembly. Rear caster A4 is wider than front caster A3 relative to middle of mounting plate A14.
i.) Top view of impact causing spring S27d to compress allowing rear caster A4 to move closer toward middle of mounting plate A14, while forcing front caster A3 further away from middle of mounting plate A14.
j.) Top view of impact causing spring S28e to compress allowing front caster A3 to move inward closer towards middle of A14 while pushing rear caster A4 further away from middle.
k.) Upside down coaster assembly locked by pin S22a
l.) Upside down coaster assembly with pin S22 unlocked allowing coaster Two Way Cam A5 and to rotate 180 against A6.
   A3.) Front Caster-works naturally with the land to control the front angle of T28 on trim assembly A1. Responsible for changing the height of Coaster Assembly A2 along with rear caster A4. There are multiple height selections between A3a & A3b, only two settings used as reference. The front caster on right hand cutting will be rear caster during left hand positions.
a.) Highest height setting raises front side of coaster assembly A2.
b.) Lowest height setting lowers front side of coaster assembly A2
   A4.) Rear Caster-works naturally with the land to control the rear angle of T28 on trim assembly A1. Responsible for changing height the coaster assembly along with caster A3.
a.) Highest height setting for rear side of coaster assembly A2.
b.) Lowest height setting for rear side of coaster assembly A2.
   A5.) Two Way Cam-Uses two different slots/cam/limits to control rotation of coaster assembly. Slot S18 works with holes S17b & S17c to lock and unlocked coaster assembly while it travels 180 degrees on bolt S19 at point S17a. The second slot S21 controls limit of rotation movement of pin S16d while springs S15 create force to keep in centered in slot S21. Spring mount S17d connects to spring S15.
   A6.) Two way pivot-Mounts directly to A7 pivoting at point S24 while also fluidly working with springs S27 and S28 for pivoting under impact. The second pivot point allows coaster assembly A2 to rotate on bolt S19 so The weed whacker can naturally adjust to land. Key component to level 2 and 3 suspension.
a.) Normal position with both casters A3 and A4 parallel with mower creating top view A2f.
b.) One spacer used to change the approach angle of coater assembly to A2g.
c.) Two spacers used to change the approach angle of coaster assembly to A2h.
d.) Under collision, spring S27d compresses pivoting at point S24 changing approach angle of coaster assembly to A2i.
e.) Under collision, spring S27e extends pivoting at point S24 changing approach angle of coaster assembly to A2j.
   A7.) Lower A-Arm Mount connects to a-arms A8/S30/S31 while also providing a pivot/mount point for A6. By working with a-arms A8 and upper a-arm mount A9, lower a-arm mount stays parallel with main a A13.
a.) FIG. 30. A Normal position, relatively the same cutting height as mower A15 or slightly lower or above.
b.) FIG. 30 B higher than mower cut height, either working on higher grade like a hillside or after an impact.
c.) FIG. 30 C lower than cutting height of mower.
d.) FIG. 30 D FIG. 30 C level A8 aarms which places coaster assembly A2 higher than mower height.

A8.) A-Arms-S30/S31 work together mounting to upper a-arm mount A9 and lower a-arm mount A7. Allows coaster assembly A2 to raise or lower on its own freely from A13 and mower A15.
a.) Relatively normal cutting height with lower a-arm mount A7 lower than upper a-arm mount A9
b.) Lower a-arm mount A7 is higher than lower making coaster assembly A2 higher than mower cut height.
c.) Coaster assembly is lower than mower cut height. Arms allow lower a-arm mounts to be lower than upper a-arm mount A9.
d.) A-Arms S30/S31 parallel.
   A9.) Upper A-Arm Mounts-Connects to A10 while also connecting to a-arms A8/S30/S31. S30 and S31 work together to keep lower a-arm mount A7 parallel. Allows fluid motion while also working with level 4 suspension to keep coaster assembly A2 on the ground.
   A10.) Mounting/Suspension Arms-Connects A11 to A9 while allowing pivoting for compression and extension under impacts. Keeps A9 parallel to A11. Level 5 suspension.
a.) Normal position.
b.) Shock S46 compresses pivoting arms S43 and S42 towards mower A15.
c.) Spring S48 extends pivoting arms S43 and S42 away from mower A15.
   A11.) Right to left assembly further defined as S44. Connects structurally to main A13 while also giving operator ability to switch cut position from right to left. Houses level 5 suspension components but not limited to S42, S43, S46, S47, S48, S49, S50, S51, and S52. Absorbs frontal impacts by creating pivot/mounting points for suspension arms S42/S43 to compress into two way suspension arm S47. Under reverse impacts two way suspension arm with suspension arms S42/43 will pivot towards front of machine creating an opportunity for operator to get mower under control before creating damage. Lock pin S59l/r or internally mounted slide lock bolt S44i keep A11/S44 locked into right or left cutting orientation but also allow user to release lock allowing 180 degree ration to switch cut preference to either right or left cut orientation. Shown in FIG. 42/FIG. 43.
a.) Transitioning from right to left. Unlocked free to rotate to left or right orientation.
b.) Transitioning from right to left shown in center vertical position. Unlocked free to rotate.
c.) Transitioning from right to left shown closer to left position. Unlocked free to rotate.
   A11r.) Right hand cut position.
a.) Locked position securing A11 to A13 preventing any rotation.
b.) Unlocked position allowing 180 degree rotation along mounting bolt S56.
   A11l.) Left hand cut position.
a.) Locked position securing A11 to A13 preventing any rotation.
b.) Unlocked position allowing 180 degree rotation along mounting bolt S56.
   A12.) Main Caster-Mounted to front of A13. Naturally adjusts to land pivoting at points S62. Fully adjustable height works with the adjustable height settings on frame mount on A14 to keep A13 level on flat ground. A collector ring can used to collect electricity from a hub motor being used as caster wheel to charge battery shown in FIG. 73 and FIG. 77.
a.) Caster on level land making Main A (A13a) level with mower.
b.) Caster leading downhill while mower is on level land causing Main A (A13b) to rotate at point S62 to pivot downward.
c.) Caster leading uphill while mower is on level land causing Main A (A13c) to rotate at point S62 to pivot upward.
   A13.) Main A-Connects to mower through mounting plate A14. Pivots at points S62 to move naturally with land with caster A12 leading the way, or whenever but not limited to winch S64 is used to lift for storage. While housing electronics for trimmer assembly, A11 also mounts to A13 and is the point of rotation for switching from right to left positions while also creating foundation for level 5 suspension.
a.) Level position relative to mower A15 with caster A12a leading.
b.) Lower position relative to mover A15 as if The weed whacker started going downhill while mower is still on level ground with caster A12b leading.
c.) Higher position relative to mower A15 as if The weed whacker started going uphill while mower is still on level ground with caster A12c leading pivot.
d.) Winch lifting A13 for storage position. S64b is tightening.
e.) Storage position for saving space, traveling, or loading on trailer.
   A14.) Mount Plate-Connects A13 at point S62 to mower A15, typically mounting to frame of mower. Mount plate houses winch S64 and Pulley S66. Between the winch S65 and pulley S66 they tighten or loosen cable S64 to raise or lower The weed whacker for operational use or storage. Can use hydraulic ram, actuator, and other methods to lift A13 other than cable winch. Has multiple mounting holes for changing mounting height relative to mower working with adjustable height caster A12 to keep A13 level on flat land, gives operator opportunity to mount to different types of mowers by providing multiple mounting holes.
   A15.) Mower which The weed whacker connects to through mounting plate A14. Can be riding tractor (not shown), zero turn A15a, quadricycle A15b, push mower/walk behind mower A15c.
a.) Zero turn mower allows 360 degree rotation.
b.) Qaudricycle allows user to lean into hill side and use 4 wheel steering to go around obstacles like a zero turn.
c.) Walk behind/push mower to allow The weed whacker to be used in the tightest places such as small back yards.
a.) Handle bars/hand controls for push mower/walk behind.
b.) Front wheels for push mower/walk behind.
   A16.) Left hand controls—Not limited to what is defined in explanation, as right hand controls can perform same tasks and can be condensed into controls similar to shown on FIG. 56b & FIG. 57b/c. T46 controls tilt while T43 controls string extension. T45 is throttle/grip. T44 is programmable controls. T47 controls winch. Can be powered through wiring harness or wireless signal and battery. Provides user with data on electronic system such as battery voltage, amp draw, power settings, motor diagnostics, temperature of motor/battery/controllers/computer, humidity, sensors, etc.
a.) Normal string locked at length.
b.) Lengthen string by user control.
   A17.) Right hand controls—Not limited to what is defined in explanation, as left hand controls can perform same tasks and can be condensed into controls similar to shown on FIG. 56b & FIG. 57b/c. T46 controls tilt while T43 controls string extension. T45 is throttle/grip. T44 is programmable controls. T47 controls winch. Can be powered through wiring harness or wireless signal and battery. Provides user with data on electronic system such as battery voltage, amp draw, power settings, motor diagnostics, temperature of motor/battery/controllers/computer, humidity, sensors, etc.
a.) Level cut of string T28 in normal position.
b.) Taper cut of string T28 controlled by operator.
c.) Lower/Normal operational position.
d.) Controls to lift A13d.
   A18.) Trailer for demonstrating The weed whacker's ability to easily load onto a trailer or into tight places.
   A19.) Charging wiring harness. Shown on a trailer but not limited to just a trailer, can be wall plug, mower power supply, etc.
a.) Connection point to charge The weed whacker on main a A13.
b.) Wiring for charging power supply.
c.) To truck/tow vehicle power supply wall outlet, mower power supply, etc.

### Suspension/Natural Movement

### Section S

S1. Level 1 Suspension Belt-Belt rolls freely along a symmetrical set of structural pulleys S6, S3 located among the coaster assembly, while also using a compression system (level 1 suspension) using pulleys S2 & S4, S5 to constantly keep tension on belt. Structural Pulley S5 can be adapted as a tensioner incase belt stretches &/or as an assistance for absorbing frontal impact.
a.) Normal tensioned position which provides user a cushion point to absorb impacts without damaging trimmer assembly A1.
b.) Belt S1 compresses under impact moving with a combination of pulleys S2b and S4b, causing extension spring S10d to extend.
c.) Normal tensioned position of belt S1, demonstrating a tensioner for pulley S5.
d.) Impact at pulley S5 or along belt S1 which absorbs some of the impact by the spring loaded tensioner S69.
   S2. Absorbing Pulley-Symmetrical pulleys on outer edge of coaster assembly, slightly in front and rear of Trim Assembly A1. S1 rotates along S2. Works with pulley S5 to create a safe angle of approach for operator. The angle of belt S1 between Pulleys S2 & S5 helps deflects impact. Pulley S2 help keep distance between trim assembly A1 and objects while cutting. Helps keep string from getting too short by keeping distance between exterior of belt S1 and trim assembly A1.
A.) Normal non compressed position.
   r—Rear side
   f—Front side
B.) Under impact, pulley is forced from belt S1 inward creating tension on spring S10 through a mechanical combination of suspension arm S7, S8, & S9
   r—Rear side
   f—Front side
      S3. Middle Roller Pulley-Purpose is to allow belt S1 to smoothly move along pulley system during impact to keep a safe distance between object and trim assembly A1.
      S4. Tension Pulley-Keeps tension on belt whether level 1 suspension is compressed or not. Connects to parallel arm S9 and suspension arm S8 at point S8d.
a. Normal position
b. Under compression pulley moves inward pushing on belt S1 between pulleys S3 & S6.
   S5. Outer Lead/End Pulley-Outer Guide Pulleys where impact is in best position to slide freely along belt as mower passes. Works with pulley S2 to create a safe approach angle for belt S1. S5 can be modified with a tensioner (shown in FIG. 22c&d) to absorb frontal and rear impacts while also allowing adjustment tighten the belt S1.
a.) Pulley mounting bolt which connects pulley S5 tensioner S69 through slot S5b built into coaster assembly A2 and a slot built within tensioner S69e.
b.) Slot built into front and rear of coaster assembly A2 which works with the tensioner slot S69e to add tension or absorb impacts. Demonstrates bolt S5a at maximum tensioned position for normal use.
c.) Pulley mounting bolt located at impact limit along slot S5d, once operator The weed whacker clears object or impact, tensioner spring S10e will force pulley S5 back into position S5a.
d.) Demonstrates pulley S5 absorbing impact, forcing pulley bolt S5c into maximum travel position under impact.
   S6. Caster Idler Pulley-Lubricated idler pulley mounted on caster assembly. Belt S1 moves along it in a rotational manner.
   S7. Front Suspension Arm-Pivots and mounts to Coaster Assembly A2 at point S7c. Houses pulley S2 at pivot point S7d while also connecting to S9 which transfers energy to S8 at pivot point S8d. Works in parallel with tensioner arm S8.
a.) Normal position ready for impact, creates distance/cushion point between S2 and trimmer assembly A1.
b.) Impact along belt S1b or directly at pulley S2 causes front suspension arm to rotate a mounting/pivot point S7c, forcing parallel arm S9 & pulley S2 inward at point S7d.
c.) Mounting and pivot point for front suspension arm.
d.) Pivot point and mounting point connecting front suspension arm to pulley S2 & parallel arm S9.
   S8. Tensioner Arm-Rotates on lubricated bushings at point S8c with a grease fitting, uses leverage to connect tension spring S10 and mounts to parallel suspension S9 arm and tensioner pulley S4.
a.) Normal position under tension at point S8c transfers spring tension to S7 through parallel arm S9.
b.) Compressed position while absorbing impact, pressure applied along belt S1b transfers energy at pulley S2b which causes S7 to rotate at point S7c connect to parallel Arm at point S7d which forces S8 inward towards middle of mower. Point S8c moves which pulls tension spring S10c extending it
c.) Point of rotation where Tension Arm mounts to structure Coaster Assembly A2. Same structural distance to point S7c, as points S7d & S8d on parallel arm S9. Keeps level 1 suspension from binding under impact.
d.) Point of rotation where Tension Arm S8 connects to parallel arm S9. Pulley S4 mounts at point S8d.
e.) Point where tension spring S10 mounts to Tension Arm S8.
   S9. Parallel Arm-Rotates on lubricated bushings at points S8d & S7d, keeps constant distance between pulley S2 and S4 while also keeping tensioner arm S8 and front arm S7 parallel at all times.
a.) Tensioned position, S8 is applying force outward to pulley S2 from Spring S10.
b.) While absorbing impact, parallel arm moves S8d/S2/S7d inward towards middle of mower.
   S10. Level 1 Tension Spring-tension spring used to keep belt S1 tight while providing a cushion for impact without damaging trim assembly.
a.) Non tension position for loading safely.
b.) Tensioned spring with loading tensioner S11b in position to keep pulley S2 in position A.
c.) Tension spring when pulley S2 is forced inward while absorbing impact at belt Sla.
d.) Tension spring pushes pulley S5 away from center of A2.
e.) Spring extends under impact pushing pulley S5 towards center of A2.
   S11. Tensioner-Helps to make the install and removal of a tension spring safer by removing tensioner and increasing spring tension while sliding along slot s14.
a.) Non-tensioned position for safely loading spring at points S8c and S12.
b.) Tensioned position to elongate tensioner spring which creates the tension on level 1 suspension starting at belt S1.
c.) Tensioned position used to push pulley S5 outward away from center of A2.
   S12. Tensioner Bolt-Connects to tensioner spring S10 slides within tensioner slot S14 on examples S12a & S12b.
a.) Non-tensioned position. When bolt S13a is removed, replacing tension spring becomes safer and easier.
b.) Tensioned position which travels along slot S14 to create tension on spring S10b/S10d for helping operator glide past objects, by creating a distanced impact cushion.
c.) Spring bolt without slide. Could have adjustment hole to allow I-Hole bolt with a nut to act as a tensioner. Refer to S51 & S52 as an example for different design, minus slide S50.
   S13. Tensioner Lock Bolt/Pin-Used to release or lock tensioner in place to create tension on level 1 suspension.
a.) Bolt removed to allow movement on tensioner S11 along adjustment slot S14 to adjust spring stiffness.
b.) Bolt installed which creates tension on spring S10.
c.) Bolt mounting hole. Multiple holes provide different levels of spring stiffness/tension.
d.) Tensioner applying pressure to belt S1.
e.) Spring extended by tensioner S67 under impact, allows pulley S5 towards center of A2.
   S14. tensioner Slot-Slot built into coaster assembly which allows tension spring S10 to release tension or gain tension by bolt S12a & S12b traveling the distance within slot.
   S15. Level 2 Suspension Spring-Two identical springs, one on front and rear side of coaster assembly. Purpose is to assist in providing down pressure coaster assembly level with the ground at all times.
a.) Normal level position.
b.) Front Side of coaster dips down lower than rear side. Spring tension works with stop cam S21 & Pin S20 to force rear wheel A4 to the ground. Larger picture would be FIG. 24B.
c.) Spring compresses while front side of coaster assembly lifts up, extending spring S15d. Same as FIG. 25b.
d.) Rear level spring is extended creating downward force on caster A3 to level coaster assembly while front side is lifted. Same as FIG. 24A
e.) Spring compresses under no tension, while front spring S15 extends. Same as FIG. 24A & FIG. 25a.
   S16. Level Coaster Mount System-Area where the Coaster Assembly A2, Two Way Cam A5, & 2 axis pivot assembly A6 mount together. Bolt S19 which is secured to A6, sandwiches Two Way Cam S17 at pivot point S17a by Coaster Assembly A2 at point S16b. Limiting pin S16d prevents coaster assembly A2 from rotating 360 degrees to prevent damaging trimmer parts or sheering cables/hydraulics/wires.
a.) Pivot structure for coaster assembly. Houses bushings S16b, grease fitting S16g, and allows bolt S19 to connect A2, A5, & A6.
b.) Lubricated bushings help prevent premature failure and wear on pivoting parts.
c.) Mounting point for spring S15. Helps level coaster assembly by creating downward force with spring S15.
d.) Limiting pin rotates within Limit S21, works with springs S15 to level coaster A2.
e.) Grease fitting to lubricate pivot point.
   S17.) Two Way Cam—Also defined by A5. Purpose is to provide a rotational Limit S21 for Coaster Assembly A2 to prevent controls such as wiring, cables, hydraulics, from getting damaged, or flipped upside down. Second Cam S18 is strictly for rotating the coaster assembly fully 180 degrees whenever operator changes the cutting side to either right or left. Main rotation along bolt S19.
a.) Main centering mounting hole connects to bolt S19.
b.) Right hand cutting mounting hole. Release and secure pin S22 to change.
c.) Left Hand cutting mounting hole. Release and secure pin S22 to change.
d.) Spring mount for S15
   S18. 180 degree Slot/Limiter for rotating Coaster Assembly A2 180 degrees when changing cutting side from right or left. Spring loaded pin S22 automatically locks when released into holes spaced 180 degrees at top and bottom of slot limiter but when pin S22 is pulled and A2 is rotated away from top and bottom of slot, pin S22 slides along the limiter until at top or bottom allowing A2 to be orientated correctly.
a.) Locked in right side cutting position.
b.) Pin S22 unlocked to release from hole S17b allows free rotation of 180 degrees to allow user to flip The weed whacker from right to left.
c.) Rotating at point S17a, pin S22 traveling freely along slot S18 located in the middle of rotation.
d.) Coaster assembly in left hand cutting position, pin S22 is unlocked.
e.) Coaster assembly locked in left hand cutting position as pin S22 is secured to hole S17c.
   S19. Coaster Pivot Bolt-Bolt secured to two way pivot A6, connects 2 way cam A5 and Coaster Assembly A2 together. Allows level 2 suspension to pivot depending on ground angle while assisting coaster assembly to stay level with land through springs S15. Point S19g is lubricated with self-lubricating bushings S16b and a grease fitting S19G. Hollow pivot bolt provides safe place to route wiring, cables, etc.
a.) Lock nut secures A6 to coaster assembly.
b.) Lock pin/ring keeps nut from vibrating off.
   S20. Shock Slide Bolt-Mounts to Two Way Pivot A6 at point S26, slides through S23 while under compression/resistance from springs S27/S28. Allows A2 to absorb impact without damaging other components.
a.) Normal position without spacers being used to modify angle. Equal length of springs S27 & S28. Keeps A2 parallel to mower until under impact.
b.) One spacer S29b increases distance between S26b and S25d. Changes angle of coaster assembly where front wheel A3 is now longer parallel with mower.
c.) Two spacers S29c increase distance between S26c and S25d. Changes angle of coaster A2.
d.) Compression of spring S27d decreases the distance between S26d and S25d.
e.) Compression of spring S28e increases the distance between S26e and S25d.
   S21. Coaster Rotational Cam-Prevents the coaster assembly from flipping over if operator hits an object. Sets rotational limits on how far limit pin S16d can travel. Helps prevent springs S15 from being damaged, while springs S15 also help ease impact on pin S16d, while assisting A2 to stay level with land.
   S22. Spring loaded 180 rotation lock Pin-Used to lock/unlock rotation of S17/A5 between A6. Only can travel 180 degrees within slot S18 locking at holes S17b & S17c. Spring loaded to automatically lock when rotation reaches either max rotation point at top or bottom.
a.) Locked, spring applies pressure to keep pin locked during vibration.
b.) unlocked
   S23. Rotational Slide/Spring Mount/Bushing-mounts and pivots at point S25d. Allows shock slide bolt S20 to move inward and outward within slide hole S23a.
a.) Slide hole which shock slide bolt S20 travels within while under resistance from springs S27 & S28. Provides a break point to help prevent damage of machine under accident.
   S24. Lubricated Bolt/Fastener-Point where Level 3 suspension rotates to activate two way spring S28/S27. Mates A6 Two Way Pivot to Lower A-Arm Mount S7.
a.) Pivot/mounting point where Lower A-Arm Mount A7 & Two Way Pivot A6 connect together.
b.) Fastener for securing bolt/fastener.
g. Pivot Point Grease Fitting-Keeps pivot point lubricated to help prevent long term damage to tolerances on pivot point.
   S25. Lower A-Arm Mount/A7—Attaches lower and upper a-arm to keep the coaster assembly and trim head level at all points so user can control cut angle.
a.) Main pivot point/mount which uses fastener S24 to secure A7 & A6 together.
b.) Upper A-Arm Mount/Fasteners connects A7 to upper a-arm S30.
c.) Lower A-Arm Mount/Fasteners connects A7 to lower a-arm S31.
d.) Two way shock mount provides mount for rotational slide S23 so springs S27/S28 can function.
   S26. Level 3 Suspension Two Way Pivot Point/A6—Under collision which activates level 3 suspension causes a rotation at point S24a/S26g by absorbing impact in two different directions through springs S27 and S28. At point S26i, motions a, b, c, d, e allows S20 to pivot and work with a rotating S23 to let springs S27 and S28 to work smooth while S20 slides within S23.
a.) Normal springs S27a and S27b are at equal length.
b.) One spacer S29b increases distance between S26b and S25d.
c.) Two spacers S29c increases distance between S26c and S25d, more than S26b.
d.) Compression of spring S27d decreases the distance between S26d and S25d.
e.) Compression of spring S28e increases the distance between S26e and S25d.
f.) Mounting hole/slot for spring loaded lock pin S22. If located on top while in right side cut position, it will be located on bottom for left side cutting.
g.) Bushings between S26h/A6 and S25a/A5. Helps reduce friction and wear.
h.) Rotation point for S24a, bushings S26g connect at this point.
i.) Mounting area for fasteners shown in slide bolt S20.
   S27. Front Spring-Front Spring for level 3 suspension slides over and secured on S20. Works with spring S28 to absorb impacts.
a.) Normal position non compressed shown in FIG. 27A, FIG. 28A, FIG. 29A
b.) Normal position with spacer S29c to add angle to coaster assembly shown in FIG. 27B, FIG. 28B, FIG. 29B.
c.) Normal position with double spacers S29c to increase angle of coaster assembly as shown in FIG. 27C, FIG. 28C, FIG. 29C.
d.) Compressed spring which allows spring 28D to extend to full length. Compression would take place on rear side of coaster assembly. Close up picture in FIG. 27D, FIG. 28D, FIG. 29D. Tip large picture shown in FIG. 20E.
e.) Extended spring during a front impact shown in FIG. 27E, FIG. 28E, FIG. 29E and large top image of FIG. 20. B.
   S28. Rear Level 3 Spring-One of two springs used for level 3 suspension slides and secured on S20.
a.) Normal operating position, even with spring S27.
b.) Normal position with one of the spacers in position S29b to provide larger impact angle to coaster assembly along belt S1. Changes position of front caster A3 closer towards the middle of mower. Examples shown in FIGS. 27B, 28B, 29B.
c.) Normal position with two spacers in position S29c proving a larger frontal impact approach angle the coaster assembly along belt S1. Shown in FIGS. 27C, 28C, 29C.
d.) Extended spring during a front or side impact which activates level 3 suspension while compressing S27D. Shown in FIGS. 27D, 28D, and 29D.
e.) Compressed spring during a rear or side impact which activates level 3 suspension while extending spring S27E. Shown in FIGS. 27E, 28E, 29E. After impact, spring will naturally return to uncompressed position equal to natural position of spring S27.
   S29. Spacers for Level 3 Suspension-two spacers used to give operator control of what angle coaster assembly functions at. Usually in normal position coaster assembly is parallel to mower. With spacers user can modify approach angle to front caster of coaster assembly towards middle of mower changing cut angle/taper and giving operator more area to absorb impact.
a.) Spacers in normal position.
b.) One spacer in position to create slight tilt to coaster assembly which creates a larger front impact area of belt S1 while bringing front caster A3 closer to middle of mower as shown in top view FIG. 29B.
c.) Two spacers in position to create a larger tilt/angle to coaster assembly bringing front caster A3 closer to middle of mower as shown in top view FIG. 29C.
d.) Spacers in normal position making no difference to suspension
e.) Spacers in normal position making no difference to suspension.
   S30. Upper A-Arm-Upper A-Arm during right side trimming would be the lower a-arm on left side trimming. Identical to S31. Upper arm works with tensioner S35 to keep coaster assembly A2 on the ground at all times, while The weed whacker naturally adjust to land.
a.) Upper mount/pivot point for a-arm uses lubricated bushings and a grease fitting to assist in smooth movement. Mounts to A9 at point S40a with fasteners.
b.) Lower mount/pivot point for a-arm uses lubricated bushings and a grease fitting to assist in smooth movement. Mounts to A7 at point S25b with fasteners.
c.) Spring Mount which is used to create downward force on upper a-arm which transfers downward force through A-Arm Mount S25/A7 to the lower a-arm S31 to keep coaster assembly A2 on the ground.
g.) Grease fitting for lubricating pivot point.
   S31. Lower A-Arm-Identical to S30, lower a-arm works with upper a-arm to keep the coaster assembly A2 parallel. S31g is a grease fitting identical to upper and lower S31. Lower A-Arm during right side cutting will be upper a-arm during left side cutting. Tensioner S35 allows operator to change down on a-arms when switching from right to left or left to right.
a.) Upper mount/pivot point for a-arm uses lubricated bushings and a grease fitting to assist in smooth movement. Mounts to A9 at point 40b with fasteners.
b.) Lower mount/pivot point for a-arm uses lubricated bushings and a grease fitting to assist in smooth movement. Mounts to A7 at point 25c with fasteners.
c.) Spring Mount which is used to create downward force on upper a-arm which transfers downward force through A-Arm Mount S25/A7 to the lower a-arm S31 to keep coaster assembly A2 on the ground.
g.) Grease fitting for lubricating pivot point.
   S32. Bushings-Used to create a lubricated barrier between mounting points (S40a/b & S30a/S31a) and (S25b/c & S30b/S31b).
   S33. Upper A-Arm tensioner Spring-whenever tensioner S35 is setup correctly, S33 creates downward force which creates downward pressure on casters A3 & A4.
a.) Down force being created as spring extends
b.) Lower down force as spring shortens
c.) Upside down as tensioner is set up for right side cutting minimal tension as orientation from right to left is switched but tensioner has not been corrected.
d.) Transition tension from right to left.
   S34. Bottom A-Arm tensioner Spring-Two identical springs used for creating downward pressure on upper and lower a-arms while in a manner that allows user to flip from right to left easily. By using slot S37 on tensioner S32, the top spring always has more pressure than lower a-arm spring.
a.) Minimal tension as S33a is over powering any tension created.
b.) In position to start to create extra downward force as spring has flipped upward at S31c.
c.) Creating more force than S33 but minimal.
d.) Creating upward force as tensioner is set wrong.
   S35. Level 4 tensioner for A-Arms. Rotates at point S37a and locks at points S37b/c while only traveling within the parameters of slot S37d. Slot S37e helps to ease tension between springs S33/S34 during operation and while switching side orientation.

a. Right hand cutting position creating downward force on a-arm S30.

b. Transitioning between sides
c. Left side cutting position creating down force on a-arm S30 (was S31 on right side cutting)
   S36. Level 4 tensioner Lock Pin-Used for locking and unlocking the tensioner S35 depending desired cut side. Locks at points S37b/c.
a.) Locked position for tensioner on right hand side.
b.) Unlocked position.
c.) Locked position for tensioner on left hand side.
   S37. Tensioner Settings used to create downward pressure on coaster A2 depending on cut orientation.
a.) Rotational center. Where middle of tensioner pivots but is limited to the distance slot S37d provides.
b.) Right side cutting tensioner lock hole.
c.) Left side cutting tensioner lock hole.
d.) Rotational slot limiting how far the tensioner can rotate, used for changing tension depending on orientation.
e.) Spring slot helps prevent fighting between springs S33 and S34 while also aiding in the transition process of switching tensioner from side to side.
   S38. Rotational Slot Pin limits the rotation of tensioner S35. Mounts directly to A9.
a.) Right hand position along slot S37d.
b.) Middle of slot S37d in transition from right to left.
c.) Left side position within slot S37d.
   S39. Spring Slide Pin—to help prevent springs S33 and S34 from over-powering each other, the slot gives enough movement to change the trajectory of tension to help keep S33 creating downward force on upper a-arm S30 at all times.
a.) Spring S33 is creating all of the downward force.
b.) Both spring S33 and S34 creating downward force.
c.) Spring S34 is starting to overpower spring S33.
   S40. A-Arm Mounts-Connects to both upper and lower a-arms while also keeping level 5 suspension in a parallel state by mounting to Arm S42 & Arm S43 at points S41a,b,c for forward and reverse collisions. Mounting point for tensioner S35 at point S37a.
a.) Upper a-arm mount for S30a.
b.) Lower a-arm mount for S31a.
   S41. Width Adjustable Mounting Points-Part of upper a-arm mount which allows operator to change the width of the weed whacker. Purpose is to get edge of string T28 to be wider than deck width of mower A15. Not all mowers are the same width so width adjustment is needed to provide a universal adjustable unit.
a.) Mounting point with smallest width.
b.) Mounting point with middle width.
c.) Mount point with widest width.
   S42. Front Level 5 Arm/A10—Works with Arm S43 to absorb front and rear impacts by connecting to shock S46 to rotational assembly S44 and upper a-arm mount S40 at points S41a,b,c.
a.) Normal position ready to absorb a front or rear collision.
b.) Compressed towards the mower under a front collision.
c.) Extended away from mower A15 under reverse collision.
d.) Shock mounting point connects to shock absorber S46.
e.) Telescoping tube which slides within tube S42i to change the width of the weed whacker depending on width of mower.
f.) Inner and outer tubes connected together at S42f set at the widest adjustment for The weed whacker. At this position A9 travels further under a frontal or rear impact at level 5 suspension than if set in position S42h.
g.) Width adjustment holes for outer tube S42i. Allows user to change the width of the weed whacker depending on mower deck width.
h.) Width adjustment set at the narrowest width while also decreasing the stroke travel of A9 under front or rear impact of level 5 suspension.
i.) Outer adjustment tube which houses inner telescoping tube S42e to change the width of the weed whacker.
   S43. Level 5 Shock Arm-Used in front and rear impacts by either allowing compression of spring S46 or the elongation of spring S48 which allows two way arm S47 to move forward during a reverse impact.
a.) Normal position ready to absorb a front or rear collision.
b.) Compressed towards the mower under a front collision.
c.) Extended away from mower A15 under reverse collision.
d.) Shock mounting point connects to shock absorber S46.
e.) Telescoping tube which slides within tube S43i to change the width of the weed whacker depending on width of mower.
f.) Inner and outer tubes connected together at S43f set at the widest adjustment for The weed whacker. At this position A9 travels further under a frontal or rear impact at level 5 suspension than if set in position S43h.
g.) Width adjustment holes for outer tube S43i. Allows user to change the width of the weed whacker depending on mower deck width.
h.) Width adjustment set at the narrowest width while also decreasing the stroke travel of A9 under front or rear impact of level 5 suspension.
i.) Outer adjustment tube which houses inner telescoping tube S43e to change the width of the weed whacker.
j.) Shock mount for S46 which allows compression and extension under a front or rear impact for level 5 suspension.
   S44. Rotating Assembly (A11)—Mounts to Main A (A13) which rotates 180 degrees to shift entire coaster assembly A2 from right hand cutting to left hand cutting. Locks in place at point T58r and T581.
a.) Mounting/Pivot Point for Two Way Suspension Arm-Point of pivot for S47. Works with slot S44b/c
b.) Stop along slot for normal cutting position and while under compression from a front impact.
c.) Stop along slot for stopping S47c from doing damage under a reverse impact.
d.) Mounting point for suspension arm S43. Works with S44d to keep A9 parallel during front and rear impacts.
e.) Mounting point for front suspension arm S42.
f.) Bushing to help prevent wear on critical parts while under stress and to help with ease of rotation for switching sides.
g.) Grease fitting for pivot point.
h.) Lock Point to keep A11 in place with locks S58/S59.
i.) Locking slide slot to allow lock pin S45 to lock or unlock with A13 to either prevent or create rotation.
j.) Ribs/brace for structural strength.
s.) Slot within A11/S44 to allow wire/cable/hydraulics to travel within without damaging while switching from side to side.
   S45. Internal Slide Lock Pin-Spring loaded pin which slides within S44i to lock into A13 to prevent rotation but can slide out of A13 to allow operator to change between right and life cut orientation. Shown in FIG. 42.
a.) Lock pin finger knob indicates pin is locked into A13 preventing A11/S44 from rotating, internal compression spring keeps pin locked into A13.
b.) Shows lock pin is locked into A13.
c.) Lock pin finger knob indicates pin has moved along locking slide slot S44i into unlocked position which allows user to rotate A11/S44 to change cut orientation.
d.) Lock pin is visible along slot S44i but does not penetrate into A13 which indicates A11/S44 is free to rotate.
e.) Spring extended with pin locked into A13/S58c
f.) Spring compressed whenever operator, user slides pin to rotate assembly to change cut orientation.
g.) Tapered point to help lock pin align into lock hole S58c.
   S46. Level 5 Spring-Heavy duty spring designed as last line of defense under a hard frontal impacts. Connects to arm S43 and S47.
a.) Normal operating position which shows shock non-compressed.
b.) Compressed Shock as shown in FIGS. 38B, 39B, & 20C. Compresses under impact against S47. Movement of arms S42 & S43 rotate towards mower while keeping upper a-arm mount and a-arms parallel under compression.
c.) Non Compressed Shock which pulls two way arm S46c towards front of A13/A12 when lawn mower makes impact in reverse as shown in FIGS. 20F, 38C, 39C, 40B.
   S47. Two Way Level 5 Suspension Arm-Creates a rotational mount for shock absorber S46 which works in two directions. Naturally while mower is traveling forward arm rests again wall of rotational assembly S44 and pin S47d rests against slot S44b. Spring S48 aids with keeping pin S47d rested up against slot S44b.
a.) Position with arm resting against slot S44b with minimal tension on spring S48a making it easier to do maintenance such as lubrication of pivot points or changing spring.
b.) Tensioner bolt S51 goes through S52b to pull bolt S48b along slot S50b to extend tensioner spring creating pulling force towards the mower A15, helping to keep arm against wall of S44.
c.) During a reverse collision or making abrupt change of direction into reverse movement, S47 rotates at point S44a stopping at slot S44c with guide pin S47e while spring S48c extends easing any potential damage, while creating tension aiding to move S47 back into natural position.
d.) S47d where shock S46 mounts to two way suspension arm.
   S48. Level 5 Extension Spring-Used for keeping two way level 5 suspension arm S47 pulled against the wall of rotating assembly S44/A11.
a.) Tension spring under normal conditions, not tension-ed. Easier and safer to install.
b.) Under tension which helps pull S47 into resting position S47b.
c.) During a reverse impact tension spring extends helping to prevent damage and give operator chance to get mower A15 under control. Naturally helps S47 return back to position S47b.
   S49. Slide Bolt-Travels within Slot S50a/b while connecting to both spring S48 and tensioner bolt S51.
a.) Not tensioned position within slot S50a.
b.) Tensioned position pulling spring S50b within slot S50b.
   S50. Tensioner Slot-Guide for slide bolt S49 which allows spring to be tensioned with tensioner bolt S51.
a.) Non-tensioned position.
b.) Tensioned position.
   S51. Tensioner Bolt which slides through tensioner mount S52 to adjust slide bolt S49 which adds or decreases tension on spring S48.
a.) In position where slide bolt S49a is positioned at slot S50a. Minimal tension on spring S48a.
b.) Tensioned position where slide bolt S49b is positioned at slot S50b. Increased tension on spring S48b.
c.) Nut used to moving tensioner bolt.
d.) Loop part of tensioner bolt responsible to connecting to slide bolt S49a.
e.) Loop part of tensioner bolt responsible to connecting to slide bolt S49b.
   S52.) Tensioner Mount connects to S44/A11 to allow tensioner bolt S51 to adjust to move slide bolt S49. Nut S51c rests against.
a.) S51d moves bolt S49a further away at slot point S50a
b.) S51e pulling bolt S49b close at slot point S50b.
c.) Mount point connecting to S44/A11.
   S55. Mount for caster A12. Allows a caster to rotate 360 degrees while naturally adjusting to land. Pivoting at point S62.
   S56. Pivot Bolt-Partially hollow to allow wiring, cables, and hydraulics to travel through while protecting whenever rotating from right to left position. Connects A11 to A13.
   S57. Pivot Bolt Mount-Mount on A13 where bolt S56 locks within and allows A11 to rotate.
   S58. Lock Points for A11 right to left assembly which allows operator to choose right or left cut orientation.
   S58r.) Right side lock point
a.) Locked into desired orientation
b.) Unlocked which allows operator to switch to left or right and set position.
c.) Locking point for lock slide pin S45.
   S581.) Left side lock point for A11
a.) Locked into desired orientation
b.) Unlocked which allows operator to switch to right or left and set position.
   S59. Lock Pins for keeping A11 in either right or left cutting position. S59r is right and S59l is left.
S59r.) Right side lock pin for A11.
A.) Locked position to keep A11 in position.
B.) Unlocked position to allow user to change orientation to right or left.
S59l.) Left side lock pin for A11.
A.) Locked position to keep A11 in position.
B.) Unlocked position to allow user to change orientation to right or left.
   S60. Cover-Protects battery, controller, charger, and wiring/cables/hydraulic lines. Apart of A13.
   S61. Cover Mount Holes-Fastens cover to A13.
   S62. A13 Main Pivot Point-Connects to frame mount A14 at this point and allows A13 to raise or lower independently from mower A15 to adapt to the land to help make cut as natural and accurate as possible.
   S63. Drain holes/Vents-Allows any water to drain and helps to create circulation to protect electronics under high heat conditions.
   S64. Winch/Lift Cable-Used for raising or lowering Main-A A13 for operational use or for storage.
a.) Normal loose position. Allows A13 to move up and down with the land freely pivoting at point S62.
b.) Cable tightening. Starting to lift A13.
c.) Cable is tight and The weed whacker is in storage position.
   S65. Winch for lifting and lowering main a A13 while pivoting at point S62 between A13 and A14.
a.) Lowered position which gives slack in cable S64a to allow main a A13 to naturally pivot at point S62 so caster A12 can naturally adjust to land.
b.) Winch is tightening cable S64b to point S64c to put The weed whacker in storage mode pivoting at point S62 to make main a A13e nearly vertical.
   S66. Pulley for A14 to transfer cable angle from winch S65 located at bottom of mount A14 to where cable lifts main a A13.
a.) Lower pulley works with S66 & S66b to route cable S64 within A14 to lift or raise The weed whacker.
b.) Pulley works with S66a to route cable to pulley S66 to lift A13 into storage position.
   S67. Adjustable tensioner used for pulling two away suspension arm into natural position while providing user with ability to change or release tension to make maintenance easier and safer. 4.
a.) Finger position in lowest tension setting.
b.) Finger position in highest tension setting.
c.) Spring S48 mounted to middle mounting hole on tensioner.
d.) Adjustment holes for tension spring S48.
e.) Lock hole to set spring S48 in lowest tensioned position.
f.) Lock hole to set spring S48 in highest tensioner position.
g.) Pivot/Mount point for tensioner.
   S68.) Adjustable mounting holes for frame mount A14. Provides multiple positions to change heights while mounting The weed whacker to a mower A15. Works with main caster A12 to keep The weed whacker and mower even on level ground.
   S69.) Tensioner for pulley S5 which is used to keep tension on suspension belt S1 under all impacts and examples of level 1 suspension. Mounts directly to coaster assembly A2 at point S67c.
a.) In tensioned normal operating position, forces pulley bolt S5a into a position ready to absorb impacts.
b.) Tensioner demonstrating a front impact which forces pulley bolt S5c towards center of coaster assembly A2, moving suspension belt into position S1d, while extending extension spring S10e.
c.) Main pivot point for tensioner which mounts to coaster assembly A2, allowing pivot rotation to move pulley S5 inward and outward.
d.) Spring mounting point which connects tensioner to extension spring S10.
e.) Tensioner slot which works with pulley slot S5b/d to provide impact travel for pulley S5 while providing torque by keeping pivot point S69c close to slot and increasing distance between pivot point S69 and spring mount S69d.

### The Weed Whacker Trimmer Assembly

Multiple variations demonstrated to allow operator to use hand controls to extend string without bumping trimmer spool off of the ground. Versions 4 & 5 are capable of rewinding string to resupply capacity. Some components such as motor, string spools, bearing carriage T6, cables, servos, hydraulics, engage rods, bearings, etc. are interchangeable throughout the different versions.

Version 1 (FIG. 58) uses a gear reduction system with drive shaft T11, an externally mounted cable mechanism using engage pin/rod T24 to mimic ground impact, and spool casing/assembly defined in (FIG. 61) Version 1 is interchangeable with some store bought bump head spools.
Version 2 (FIGS. 60, 65C/D) uses driveshaft T49 connected directly to motor T1 with a internally mounted mechanism using engage pin/rod T24 to extend string length while protecting components from elements. Uses the same spool casing/assembly defined in (FIG. 61) or compatible with some store bought string bump heads.
Version 3 (FIGS. 62, 63, 64, 65A/B) Uses a two piece motor enclosure to house crucial components, uses a direct to motor drive shaft T10 (similar to T49) using a internally mounted mechanism to raise or lower engage rod T13 to lock or release string length. Uses spool head assembly defined within (FIGS. 62, 63, 68)
Version 4 (FIGS. 66, 67) Capable of rewinding and extending string length. Uses a two piece enclosure, a combination of motor T1, coupler T58, and engage shaft T57 to provide direct to motor rotation. Providing capability to stop rotation of drive shaft T59 while engage shaft T57 releases from spool casing T12/T57 to control rotation of spool T14 for rewinding cutting string T28. String spool mechanism fully defined in (FIG. 68D/G/H)
Version 5 (FIGS. 68, 65C/D) Capable of rewinding and extending cutting string length. Uses a one piece motor enclosure with sealable side ports to seal enclosure. Works same way as Version 4 but demonstrates cable controlled linkage and 3 different solutions (bearing carriage friction brake Tor, disc brake caliper T61aa/ab, V-brakes T61ba/bc) for stopping the rotation of drive shaft T59 to rewind string mechanism.

### Section T

T1 Motor-powers the string trimmer to cut. Controlled by throttle T45a/b.
a.) Pulley/Gear-Transfers rotational power between motor and drive shaft T11a
b.) Belt-Transfers rotational power between motor and driveshaft T11a. Can be tensioned at T16c.
c.) Cooling Fins-Allow motor to cool. Aids in cooling. Can be liquid or air cooled.
d.) Splined Drive Shaft-Splined Shaft Works directly with coupler T58 to transfer power to slide drive shaft T57a.
r.) Motor spins in reverse to rewind string T28.
   T2. Motor Mount Upper Base-Mount motor T1 to base T7 while providing a way for assembly and maintenance. Provides point T3 for pivots string T28 for taper cut.
a.) Bearing used for centering coupler T58 to prevent extra side load on motor bearings. Built into version T7 with access points for maintenance.
b.) Motor mounts to connect motor T1 to motor mount upper base.
c.) Upper motor mount base mounting holes for fastening to lower base T7.
   T3. Upper Base Pivot Point-Pivot Point Area where trim angle changes by making trim assembly A1b rotate at mounting/pivot point T7a.
a.) Cable mount to increase string length and tilt location.
   T4. Lock Pin-Goes through top of activator shaft T13 while sliding within driveshaft slot T10d controlled by bushing T5.
   T5. Centering activating cone—In order to prevent shear under load on the activator pin T4 the THE WEED WHACKER Trimmer uses two sets of bearings on versions not capable of re-wind able spool, one fixed while the other built into carriage T6 which lifts centering activating cone T5. While under tension the centering activating cone naturally centers itself thus lifting the activator pin while spinning freely on bearing T6b. Made out of bronze or a Delran or other materials which are self-lubricating for ease of sliding.
a.) Centering activating cone is in normal position which allows spool T14 to lock in place with spool casing T12 to keep string locked at length.
b.) Centering activating cone is pulling upward with bearing carriage T6 from activating arms T9 which pulls T13 upwards allowing spool T14b to unlock from spool casing T12d to increase string length T28b.
   T6. Linear Bearing Carriage-Bearing carriage slides up and down secured by guide pins & machined shape to prevent side load from twisting/breaking apart free spool activation mechanism. Whenever moved upward, releases spool to extend string length, middle is locked at length, when moved downward Shaft T57 can spin spool T14 whiles stopping rotation of driveshaft T59 to rewind string.
a.) Mounting Holes-on both sides of T6 where it mounts to activator arm T9 at location T9d. Used for moving up and down slot T7c.
b.) Bearing-used for centering with T5 to safely lift T13 for releasing spool without doing damage to parts under power from motor. Minimizes friction.
c.) Guide Holes-Holes slide along guide pins/bolts/rails, prevents sides load/twist.
d.) Friction brake pad located on bottom of bearing carriage which creates friction against top of shaft T59a when user activates string rewind mechanism.
r.) Demonstrates whenever bearing carriage has moved downward to rewind string, applying breaking force to stop rotation of drive shaft T59 whenever using friction brake.
   T7. Pivoting Base-Slight differences between T7's demonstrated in FIGS. 62, 63, 64, 65A/B, 66, and 67 relative to the versions shown in FIGS. 34C/D, 65C/D, 68 can be identified at the exterior by determining use of upper motor casing T2 or spindle drive shafts T11/T49/T59. Both setups houses main bearings T7d which keep shafts T10/T11 & T49/T59 centered for 360 degree rotation powered by motor T1. Draft shaft T11 and T49 use engage pin/rod T24 to mimic ground impact to mimic string extension whereas drive shafts T10 & T59 use a completely different engage pin/rod T57 which is capable of string extension and rewinding.
a.) Pivot point-Lubricated point where trim assembly A1a mounts to coaster assembly A2 at point T36 while providing the ability to rotate to change angle of cut A1a/b.
b.) Activating Arm T9c Mount Point where it pivots to start the process of engaging and disengaging string length.
c.) Slot which works with T9d to lift or lower T6 at point Toa to release, lock string T28, or engage string rewind.
d.) Main bearing pressed into base which houses/secures shaft T11 and T59 to base while providing precision high speed rotation. Can use two bearings to distribute load or one larger one, responsible for side load on reverse version.
e.) Internal Guides-Keep slide T6 from rotating while motor is spinning.
f.) Tilt limiter works with slot T31 to keep pivot/cut angle from going past desired angle.
g.) Access hole to adjust set screw on drive shaft.
h.) Access hole to lock motor to drive shaft with a set screw/fastener/etc.
i.) Maintenance port allows for assembly and disassembly of bearing carriage within housing T7 on versions not using upper casing T2.
j.) Motor cover protects motor from debris such as dirt or grass from accumulating near bearings or cooling ports.
k.) Mounting holes to connect lower base to upper base for disassembly and maintenance.
   T8. Stepper, Cable, Hydraulic, activation device-Area where mechanical motion is triggered to move T9 which activates free spool.
a.) Normal position where string is locked in place
b.) Stepper working with slot T9e has activation arm in position T9b to release string spool for lengthening string.
c.) Cable housing which feeds cable T8d to engage and disengage arm T9 to lock or release string T28.
   r.) Cable housing for string
d.) Cable-Slides within cable housing T8c/r which is controlled by operator controls.
   a.) Cable is extended while linkage arm T9jb is rotated upward to rewind string mechanism.
   b.) Cable shortens pulling T8hb upward, causing T8h to rotate which pulls linkage arm T9ja downward, extending string length.
   ra.) Cable pulls point T8hd upward while extending string length T8da to engage rewind mechanism.
   rb.) String T8db shortens, rotating T8h which pulls linkage arm T9ja downward from point T8he.
e.) Cable Tensioner-Purpose is removing slack in cable so operator gets maximum travel from user controls.
   r.) Tensioner for cable used to activate rewind mechanism.
f.) Extended spring to remove slack in cable and user controls while also aiding to help arm T9 return to normal position T9a whenever user's controls are in position T43a.
g.) Compressed spring while cable shortens whenever operator engages mechanism T43b to increases string T28 length.
h.) Two way tensioner used to activate spool release or reverse rewind mechanism while rotating at point T8hc.
   c.) Spool rewind position, pulls activation arm T9 downward through mechanical linkage as cable T8dra shortens.
   d.) Cable controlled spool extension mechanism pulls engage arm T9 upward as cable T8db shortens while cable T8da increases in length.
   e.) Pivot point where two way linkage connect to motor assembly T7.
   f.) Cable within housing T8cr pulls linkage arm T9jb upward while cable T8dra rotates two way linkage T8h.
   g.) Cable T8drb pulls linkage arm T9ja downward to raise engage arm T9 in order to extend string length.
   h.) Adjustable mounting points to change torque or travel distance as T8h rotates.
r.) Brake cable or hydraulics for stopping rotation of drive shaft T59 to rewinding string T28.
   a. Normal operating position which allows drive shaft T59 to spin freely.
   b. Operator controlled cable squeeze which causes brake pads T61bb/Caliper T61ab to squeeze against drive shaft T59a/disc T59d respectively to stop rotation for string rewind mechanism. For vbrakes the cable pulls T61bd/T61be towards each other to create mechanical friction stopping driveshaft T59 from rotating.
   c. Cable or hydraulic housing for braking mechanism which controls the clamping force to stop drive shaft T59 from rotating, connects to operator controls.
      T9. Activating Arm-Arm which is connected to pivot point T7b and activates free-spool by connecting to T6a from slot T9d, which moves centering cone T5, engaging T13. On Reverse versions bushing T60 and fasteners T57d/e/f clamp onto bearing T6b to move shaft T57 up or down.
a.) Normal position where string length is locked into place.
b.) Engage position where rotation from pivot point T9c lifts carriage T6 at point T6a and slot T9d through slot T7c.
c.) Pivot point for Activating Arm T9 mounted at T7b.
d.) Slot which works with slot T7c to lift carriage T6 at point T6a with a bolt/pin.
   a.) Mounts to linkage arm T9i.
e.) Mounting point where motor, cable, or hydraulics moves arm T9 which ultimately increases length of string T28 through mechanical movement. Mostly shown as slot used for servo/motor arm to lift or lower engage arm.
f.) Brace between arms to make sure both arms rotate up or down equally.
g.) Brace between arms to make sure both arms go up or down equally. Rotates and mounts cable T8d.
h.) Cable lock/set screw to stop cable sliding out of T9g so that arm T9 will move up or down.
i.) Linkage connection used to lift arm T9 through rotation of linkage arm T9j.
   a.) Linkage arm lift engage arm T9 upward to release spool to extend string.
   b.) Linkage arm forces engage arm T9 downward to full engage spool to rewind string.
   c.) Normal position of linkage arm which locks spool T14 into casing T12 to keep string at length.
j.) Pivot arm connected to cable T8d which is used to allow cable to release spool T14 or to fully engage spool T14 to rewind.
   a.) Pivots to lift arm T9 upwards allowing release of spool T14.
   b.) Pivots to force engage arm T9 downwards to fully engage spool T14 while stopping rotation of shaft T59 by creating breaking pressure.
   c.) Normal position which place arm T9 in position to keep spool T14b locked with spool housing T12d.
   d.) Pivot point connecting pivot arm T9j to linkage connection T9i.
   e.) Pivot point connecting Pivot arm T9j to body of trimmer assembly T7.

r.) Arm pushes downward on T6 which turns into a friction brake onto shaft T59 stopping any rotation on T12 while shaft T57c moves fully onto spool T14b to begin rewind process.

T10. Direct to Motor Drive Shaft-Secures to bearing T7b, while also connecting to spool assembly T12. Works more or less as an idler bearing that physically mounts T12 to T7, drive slide shaft T57 moves within to engage and disengage T14b & T12d.
a.) Ridge on shaft which rests against top of bearing within T7d.
b.) Part of shaft that fits tightly with inner diameter of bearing T7d.
c.) Part of shaft that inner diameter of bushing/centering cone T5 slides on.
d.) Inner Channel/Slot-Machined into driveshaft to allow pin T4 to connect to T13c while sliding up and down within shaft T10.
e.) Motor Mount with set screw connects to motor drive shaft T1.
   T11. Gear Reduction Drive Shaft w/Cutting Blade-Main shaft that fastens to bearing T16b at point T11c with fastener T11d. Features cutting tips T11e to prevent a trimmer from wrapping up in string or other materials which causes damage to bearing.
a.) Drive pulley/gear on main drive shaft, connects to motor pulley T1a through belt T16b. Can be gears instead of pulleys and belts.
b.) Belt/Chain for transferring power from T1a to T11a.
c.) Stop-rests against bearing T16b when securing drive shaft to motor assembly base T16. Grip-able with a wrench.
d.) Fastener with set screw-Tightens the driveshaft in place against bearing T16b, allowing 360 degree rotation.
e.) Cutting blades-Works like a roughing end-mill to rip and shred apart cables, wires, rope, etc. to help prevent damage to bearing T16b.
   T12. Spool Assembly Casing-Protects and provides internal rotation of spool T14 to drive shaft T1 or shaft T59. T12c is specifically different from the remaining T12 definitions as it is a common store bought bump head modified with a center hole at T29 which pin/bolt T24 pulls upward instead of hitting off of ground.
a.) Spool housing which is constantly connected to T13b as it slides up and down within T12d, engaging and disengaging with spool T14b. Spring T12e helps to center and push down spool T14 to assist engaging and disengaging mechanism to work to increase string length. When connecting to shaft T59, slide engage shaft T57c will fully engage into housing T12d releasing spool T14b to lengthen string, or partially engage into housing T12d while also partially engaged into spool T14b to allow normal cutting use, or fully engaged into T14b to allow rewind mechanism to work.
b.) Housing lock is where cover T12g locks into place. Secures spool T14.
c.) Traditional bump head spool assembly commonly sold in stores but with activator pin/bolt T24 used to pull up to release spool instead of hitting off of ground. Main body thread to shaft, spool sits on a spring within body and there a cover (T12ca) to secure components within.
   a.) Cover for spool casing holds spool T29 and spring T29c within casing.
   b.) Cover with tapered spline works with spool spline T29e to lock and unlock spool for extending or lengthening string T28b. Spring T29c assists with forcing spool T29 to lock after use of activation shaft T24. The taper assists with aligning the spline/gear to spool spline T29e when re-engaging to lock string at length.
   c.) Cover rotational guide to keep spool tip T29a/b centered while rotating at high rpm when spool spline T29e disconnects with casing cover spline T12cb.
   d.) Cover locking mechanism locks into spool casing T12ce to secure components within.
   e.)
   f.) Shaft mounting point where spool casing mounts to drive shaft T11/T49.
   g.) Shaft mounting point where spool casing mounts to drive shaft T11/T49.
d.) Part of spool where Shaft T13d slides within T14b to engage and disengage spool to increase string length.
e.) Spring keeps spool T14 pushed against T12f so that T13 or T57 can function properly.
f.) Centering pin on cover to keep spool T14 spinning on center when T13 or T57 is engaged and disengaged.
g.) Mounts to T12b which ultimately secures spool T14 and spring T12e within enclosed area where string comes out.
h.) Cutting blades to help prevent string, rope, cable, etc. from wrapping around drive shaft causing damage to bearing T7d or T16b.
   T13. On/off spool release shaft-Shaft which travels up and down within T10. Limited slot T10d allows pin T4 ability to connect with centering cone T5 which when activated raises thus loosing contact between T13d & T14b. The shaft slides within T12d while constantly remaining contact. When T13 slides upward and loses contact with spool T14b it allows spool to free spin to lengthen string T28.
a.) Engaged position connects T12d to T14b to lock string at length.
b.) Disengaged position disconnects T12 from T14b to allow free rotation of spool T14 for increasing string length.
c.) Pin Point which locks into centering cone T5. Whenever engage arm T9 moves to release string, the pin point slides upward along slot T10d with pin T4, to release from spool T14b.
d.) Hex or splined shape which grabs/matches spool internal spline T14b and releases/locks for cutting and increasing string length.
e.) Taper for aligning spool T14b and activator shaft T13 when re-engaging power to the spool.
f.) Centering tip continues contact with center of spool T14 whenever releasing upward and engaging spool release, assists with re-engaging by keeping spool T14 centered at point T12f.
g.) Spring to create constant down force to keep pin T4 locked in place within T5, while keeping spool T14 centered with centering pin T12f.
   T14. String Spool-Holds cutting string and unwinds the string to increase diameter whenever shaft T13d/T57c slides upward disengaging the driveline. T57 can fully disengage within T12d to allow spool to work in reverse while carriage T6 creates a friction brake/vbrake/disc brake to stop rotation of shaft T59, allowing spool T14 to spin backwards to refill string without rewinding new string on spool by hand.
a.) Spool sides keep string T28 within while wrapping around middle T14d, providing a supply of string. Spool sits centered on top of T12f and rests against spring T12e and stays centered with T13f or T57g. Allows user to have a supply of string to be released by operator.
b.) Built in spline shape which allows T13d/T57c to slide in and out, to lock and release or rewind string T28. When locked in place spool stays at same speed as rest of parts under power by T1. Whenever rewind mechanism is used, only the spool will have power from the motor T1, while brake mechanism Tor, T61aa/ab, T61ba/bb stops rotation of T12/T59, shaft T57 will disengage from T12d while T6 applies friction brakes to shaft T59.
c.) Smooth Taper hole which you feed one long string through and release out of area T12g on both sides for auto rewind.
d.) Center of spool. String T28 wraps around the middle while staying centered between sides T14a.
   T15. Linear Slides-Secondary Bearing Carriage T17 moves along linear slides to activate spool extension. The purpose of linear slides are to let bearing carriage T17 to travel up or down to engage and disengage spool T14, while allowing parts to function free of rotational force from motor by using a bearing within bearing carriage T17 and centering cone T25.
a.) Linear side stop/faster secures spring T18 between carriage T17 and stop T19.
   T16. Main Body-Main Structure of the trimmer assembly. Houses pivot points T16a, main shaft bearings T16b, motor T1, linear slides T18, (Top Bearing Not Shown).
a.) Main pivot point to allow user to tilt trim angle, connects to coaster assembly A2 at point T36.
b.) Main bearings. One located on bottom of housing, the other is inside of T16 (not shown). Keeps shaft T11 centered while bearing slide carriage T17 engages and disengages string length mechanically.
c.) Tensioner for belt. Allows motor to move closer or further away from drive shaft pulley T11a.
   T17. Secondary Bearing Linear Carriage-Houses the secondary bearing T17c slides along linear slides T18 which naturally centers with cone T25 which pulls activation shaft T24 upward through hollow drive shaft T11 connecting to T29 string spool.
a.) Normal position resting against base T16. At this position string spool T29 is locked in place under rotation.
b.) Whenever operator extends string cable, cable T23b pulls upward while connected at points T23c. This mimics the motion of bumping spool head T12 against the ground while using activator rod T24 to pull up on bottom of spool T29. When pulled upward T29 releases from T12c long enough to spin at a different speed thus lengthening string.
c.) Bearing which allows the string to release to increase length while everything else continues to spin. Allows rod to mimic hitting off of the ground by pulling shaft T24 to pull upward under power without shearing pin T24.
   T18. Linear Slide Spring-Applies constant linear downward force to T17. Located between T17 & T19 while fixed along Linear Slide T15.
a.) Normal position with light downward pressure pushing T17 against base T16.
b.) Whenever operator goes to extend string the springs compress between T19 & T17 creating force that quickly pushes T17 back down against base T16, allowing rod T24 to go downward, moving spool downward with assistance from spring T29c locking string at length.
   T19. Linear Slide Stop & Linkage Platform-Springs T18 keep pressure between T17 & T19. For cable activated free spool the platform provides a stable platform for adjustment and mounting platform to allow cable T23 to pull T17 upward which extends string. Can be modified for electronic mechanism for string extension.
   T20. Linkage responsible for connecting T27 to motor housing T7g. Motor assembly T7/A1b rotates and mounts to coaster assembly A2 at point T7a changing cut angle whenever linkage T20 raises or lowers.
   T21. Cable Tube-Method of spool activation, as operator squeezes lever, cable tension transfers linear movement to T17 through a hollow cable tube.
   T22. Cable tensioner-Hollow Threaded Adjustment which adds or subtracts tension to cable T23 between T17 and lever/button T43 shown in FIGS. 56/57. Could be mounting point for hydraulic piston or motor controlled spool activation.
   T23. Cable-Cable which slides within housing T21. Connects lever/controls T43 to T17c, which allows cable to move carriage T17 upwards under tension to pull pin T24, releasing spool.
a.) Normal position under normal tension. String locked at length.
b.) String release position when operator pulls lever T43b, compressing springs T18b as cable pulls carriage T17 upward.
c.) Split cable mounting positions on bearing carriage T17 to pull upward equally to lengthen string.
   T24. Activation Pin/bolt-Instead of requiring contact with the ground to extend string, the activation pin pulls spool T29 upward by T25/T17/T23 to release contact between spool spline T29e and spool casing spline T12cb to allow string to lengthen cutting diameter when using drive shaft T11. Pulled upward by T6/T5/T4 through slot T49a when using direct to motor drive shaft T49.
a.) Normal position where string T28 is locked at length. Points to top of Pin T24 where a nut is locked in place with cotter pin resting up against T25.
b.) Unlocked position where string T28 is released to increase length, mimics ground impact to pull T29b upward.
c.) Lock pin bottom which connects to spool T29. Responsible for mimicking bumping trimmer head off of ground but instead the operator activate spool release at controls T43 without ever having to hit the ground.
d.) Lock Slot Cone/Bushing allows locking mechanism to rest within bushing to prevent damage under rotation.
e.) Lock Cone Bushing houses locking mechanism T29f while rotating within spool bushing T29 to prevent shear damage to lock pin/fastener/nut T4.
f.) Rotating t lock mechanism which is used to release spool T29 from activation shaft T24 so operator can remove spool from casing T12c to rewind.
   a.) Set perpendicular from shaft T24 which locks into bushing lock slot T29d.
   b.) Rotating lock is rotated 90 degrees to vertical which is parallel with shaft T24 to unlock from bushing lock slot. To unlock, user must push upward on spool T29, compressing spring T29c, providing enough space to rotate locking mechanism into vertical position.
g.) Fastener/Nut which secures into activation centering cone T25, to allow bearing carriage T17 to move activation pin T24 upward to lengthen string. Fastener/Nut provides adjustment to remove slop/movement within linkage.
h.) Lock Pin/Cotter Pin prevents fastener/nut from vibrating free under high rpm.
   T25. Centering Cone-Essential part used to lift activation pin T24 while also centering within the bearing located on T17. The centering cone matching with bearing helps prevent shear of delicate parts.
a.) Normal locked position where string is locked at one length.
b.) Release string position. Pulled upward by T17.
c.) Taper for aligning with carriage bearing T17c.
   T26. Rotating cable tensioner for adjusting slack between operator controls A16/A17
   T27. Tilting Linkage used in taper cutting mechanism. Mechanical movement to tilt trim assembly A1b.
a.) Angle of linkage demonstrating level cut position A1a.
b.) Rotating at point T27d as cable T30da shortens, raising linkage connector T20 upward to change cut angle of T7/A1b.
c.) Adjustable mounting positions provide options to mount cable T30ca/da to adjust mechanical leverage and stroke travel for cut angle relative to string cable length T30ca/T30da.
   a.) Level cutting position A1b. Cable distance between tensioner T26 and tilting linkage T27ca is longer compared to cable T30da.
   b.) Tilt cable T30da shortens changing angle of titling linkage T27b while rotating at point T7a.
   c.) Each mounting hole for cable T30ca/da has a different spacing from pivot point T27d to change torque and height linkage arm S20 is raised or lowered relative to the distance the operator controlled cable travels T30ca/da
d.) Mounting/pivoting position connecting coaster assembly A2 to tilt linkage creating a mechanical advantage responsible for changing cut angle A1a/b.
e.) Adjustable mounting holes for rotating cable tensioner T26.
f.) Tilting linkage mounting point which connects to tilt linkage T20.
   T28. Cutting String-Responsible for cutting grass/vegetation. The cutting string lengthens when T43b is pulled by operator. Length is controlled by a cutting blade built within guard T50 to keep string from getting too long to function properly.
a.) String locked at length.
b.) String free to increase in length.
c.) Highest height on casters with both front A3 and A4 set evenly. Creates highest cut height.
d.) Lowest height on casters with both front A3 and A4 set evenly. Creates lowest cut height.
e.) Normal width position.
f.) Center of string rotation slides outward away from middle of mower to reach tight spaces such as between tombstones or between trees without having to change direction of mower. Operator controlled.
g.) Linear slide which moves center of trim head assembly away from middle of mower. Retracts back to normal width position once operator releases controls.

db.) Lowest height on casters with both front A2 and A3 set evenly. Lowest cut height with user controlled taper cut.

bb.) Rear caster A4 is higher than front caster A3 creating a natural tilt to the cut as the coaster assembly A2c natural moves with the land. The operator also tilts A1.

T29. String Spool-Normal bump off of ground trimmer spool assembly used commonly today but with hole bored into bottom bump tip T29a/b to connect engage bolt/pin T24 to centering cone T25 controlled by bearing carriage T6/T17 allow operator to raise or lower to mimic ground impact to extend string. Responsible for holding T28. Connects and releases driveline shown in example to cut and add length to string T28. T24 pulled upward by T17 mimics ground bump to release spool found on current hand trimmers. Reference FIG. 59, 60, 61 to see an example.
a.) Normal position with string locked at length, locking spool spline T29e into casing cover spline T12ce together
b.) T24 pulls spool upward mechanically by user at T43b to mimic point T29a/b hitting off of ground to increase length of string.
c.) Spring which slides over T24 and forces spool T29 downward locking spool spline T29e into spool casing spline T12ca. Spring compresses whenever T24 pulls spool T29 upward.
d.) Bushing at point where engage pin T24 connects to bump tip T29a/b to allow free rotation between spool and engage pin whenever pulled upward, disengaging from internal locking mechanism. Activation lock bushing T24e rotates within spool bushing T29d whenever trim assembly uses direct to motor drive shaft T49.
   a.) Locked position which locks string at length at point T29e and T12cb.
   b.) Pulled upward, unlocking spool spline T29e from casing spline T12cb.
e.) Spool gear/spline for locking rotation within spool casing spline T12 to keep string at one length, when pulled upwards by activator shaft T24.
f.) String slot which provides place for operator to rewind string around spool, while also working with casing holes T12cg to extend string.
g.) Spool tip rotates within spool casing cover T12ca to keep centered when string release is activated. Bushing T29d mounts within tip.
   T30. User Controlled Pivot-Tilting force created by electric power servo/stepper T30a/T30b, cable T30c/T30d, or hydraulic movement T30e/T30f. User can fine tune cut angle with control T46.
a.) Normal position level cut with servo/stepper with user control in position T46a.
b.) Tapered position cut with servo/stepper creating tapered cut from position T46b. Servo/Steppers allow user controls to be buttons, levers, joysticks, potentiometers, twist sensors, automated by ground sensors, & more.
c.) Normal level cut with cable controls with user control in position T46a tensioner used on lever T46 and with T30c/d to remove slack in cable.
   a.) Cable distance between tensioner T26 and tilting linkage T27ca is longer compared to cable T30da.
   b.) Cable distance between tensioner T26 and tilting linkage T27ca is shorter compared to cable position T30ca in order to change cut angle A1b.
d.) Cable controlled tapered cut while user controls in position T46b. Can be controlled by cable twist throttle, cable break lever, foot pedal, wireless motor controlling cable movement at coaster assembly A2.
   a.) Cable distance between tensioner T26 and tilting linkage T27ca is shorter compared to cable position T30ca thus changing cut angle A1b.
e.) Hydraulic controlled level cut position user control in position T46a.
f.) Hydraulic controlled taper cut with user control in position T46b. User can use hydraulic lever like a brake lever, joystick which would mimic a servo/stepper to control hydraulic pressure like vehicle ABS system.
   T31. Pivot Controlled Slot-Keeps the cut angle at pure level (T31a, c, e) or max taper point (T31b, d, f). Can be modified to allow reverse tapered cut by extending slot. Not shown. User can control and position angle rapidly between points T31d/c using the operator hand controls T46a/b for fine tune cut angle while the rest of machine naturally adapts to all land. With stepper/servo A30a/b slot can be eliminated as the motor will hold position with a gear reduction built in for torque, letting user to manually control trim/level position like a RC plane or car.
a.) Normal level cut along angle slot controlled with Servo/Stepper T30a.
b.) Tapered cut along the angle slot at maximum tilting point controlled by servo/stepper.
c.) Normal level cut along angle slot controlled with cable T30ca. Pulled back to normal position with assistance from return spring not shown.
d.) Tapered cut along the angle slot at maximum tilting point controlled by cable T30da.
e.) Normal level cut along angle slot controlled with hydraulics. Pulled back to normal position with assistance from return spring not shown.
f.) Tapered cut along the angle slot at maximum tilting point controlled hydraulics.
   T32. Wire/Cable/Hydraulic-Feeds either but not limited to electronic signal+power, cable movement, or hydraulic pressure to control the cut angle, motor power/speed, string extension, and any possible sensors needed such as motor temp, ground sensors, etc.
a.) Servo/Stepper/Motor feed line.
b.) Cable line used for tilting trim head A1b.
c.) Hydraulic pressure feed line before it merges into T33 to create level or taper cut.
d.) Electric motor speed control wire/cable string extension. Cable string extension could be modified for hydraulics to mimic same linear motion or stepper/servo.
e.) Electric motor speed control wire/power/signal for string extension with stepper/servo T8a/b. On version shown in FIG. 65 the model uses a cable to engage arm T9b for string extension T28b through T8c, d, e, f, and g.
   T33. Wiring Harness/Cable/Hydraulics-Transfers either hydraulic fluid/pressure, cable movement control, or electronic power and signal between operator and trimmer A17/A17/A1. Travels along A2, A5, A6, A7, A8, A9, A10, A11, into A13 before splitting into T33a/b. Wireless controls and battery built into coaster assembly A2 bypass the need for any significant harness.
a.) Harness/Cable/Hydraulics splits into T33d/T33e for operator controls and back to tilt assembly T30/T31/T32 or to controller which ends up sending signal to motor T1, T8 & T30. Travels from A13 to A14 where it gains harness from lift winch S65, then travels up mower A15 before splitting into T30d/e to lead to user controls A16/A17. Can split earlier to add foot controls if user desires for tilt, lift, or motor throttle.
b.) Wiring harness to battery T39, Controller T41, or charge controller T40. Controlled by hand controls A16 harness T33d/A17 harness T33e sent from harness T33a. Sends signal back to motor T1 or servo/steppers T8/T30 through harness T30.
c.) Wiring harness which goes to charge controller T40 to battery T39 or charge controller T.
d.) Left hand control wiring harness/cable/or hydraulics. Delivers on/off power, string length increase from lever T43 and T44 control allows user to change amperage which increases wattage for motor depending on thickness of lawn, cutting speed, and power consumption.
e.) Right hand control wiring harness which leads to A17. Controls throttle T49, up and down from the winch T47, tilt control T46.
f.) Harness to wireless setup for battery T34, ESC T35, & Receiver T37. Requires hand controls A16/A17 to be wireless for motor T1, T8, T30.
   T34. Wireless Charger & Battery-Battery with built in battery charger for wireless system built within coaster assembly A2. Eliminates the need to run wire from coaster assembly A2 to hand controls A16 & A17 as shown with T33, a, b, d, and e. BMS (battery management system) to prevent over discharge and over charging while balancing each cells. T34 shows charger, T34a represents coaster assembly battery.
a.) Battery for wireless system with Battery Manage System (BMS) to keep battery cells balanced. Powers motor T1, T8a/b, T30a/b, controller ESC, receiver, sensors, and anything else needed to modification.
   T35. ESC Speed Controller-Takes power from battery T34 or T39, receives input from hand controls A16/A17, controls speed of motor T1, controls servo/stepper/motor T30a to position T30b through wireless receiver. Receives wireless signal from wireless hand controls A16/A17 (Radio Controlled).
   T36. Trimmer Assembly Pivot Point-Coaster assembly A2 mounting point for trimmer assembly at points T16a or T7a; simply defined as A1a/b.
   T37. Receiver-Receives signal from user and sends input to controller for speed controller to change speed on T1 and powers and controls servo/stepper T30a/b & T8a/b. Receives signal from wireless hand controls A16/A17.
   T38. On off Switch-controls power supply for wireless setup. Must be on to operate. Kills power when turned off.
   T39. Battery-Installed within A13. Allows user to have sufficient electricity to power The weed whacker for the largest jobs. Recharges at point T33c. Has built in BMS and battery charger T40 keeps battery fueled. Vent T42 and holes/vents S63 help to keep battery cool.
   T40. Charge Controller-Controls amperage which goes into battery T39 to recharge. Built in so operator can always have access to charger no matter the location. Fan can be used to keep cool. Can be powered by on board power supply from alternator on mower.
   T41. Controller-Sends and receives signal to/from A16/A17 and sends power to motor T1, servo T8 or T30. T45 is throttle. T46 changes tilt of cut. T44 modifies power settings for speed of motor/wattage/amperage, tilt, string extend, on/off. T43 extends string. Can receive and send data/signal/current to caster A12 for regenerative charging from wheel rotation. A fan can be used to keep cool.
   T42. Vent for keeping battery and controller, and charger cool. Provides airflow for fans on controllers T40/T41.
   T43. Lever or button for Extending String-User string extension controls responsible for either electrical signal, cable movement, or hydraulic pressure to power the mechanical motion to extend string T28. Can be sent wirelessly for servo/stepper/motor controlled models.
a.) Normal position with string T28a locked in position.
b.) User activated string extension.
   T44. On/Off/Programming Controls/LED screen-Turns unit on or off. Allows user to change speed of tilt, motor speed, string extension parameters and allows customization of amperage which changes the wattage of T1 which ultimately affects overall horsepower of the weed whacker. Can be self-powered with own battery for wireless controls or wired directly into harness. Wireless transfer of data to trimmer motors & controllers can be sent through Bluetooth, RC, Wi-Fi, etc.
a.) Up on control menu or adjusting setting such as but not limited to trim/angle, up or down with winch, tilt speed, amperage, preset power settings, views on controller screen, etc.
b.) Select on controls/hold for on/off.
c.) Down on control menu or adjusting setting.
d.) Menu to allow user to pick what setting change is required.
e.) Back allows user to return/hold for on/off.
f.) Hand trimmer controls.
   T45. Throttle—Can be twist, thumb, foot, or button controlled. Changes speed of T1 through wireless or wired controls A16/A17.
a.) Joystick controlled forward rotation of motor.
b.) Joystick controlled reverse rotation of motor.
c.) Twist throttle.
d.) Throttle trigger for hand trimmer.
e.) Thumb throttle.
   T46. Control for Cutting Angle-Allows operator to change the cutting angle of the trimmer such as A1a and A1b by mechanical motion through but not limited to cable/hydraulic movement by brake lever/twist throttle mechanism, foot pedal, etc. Or signal for electro mechanically powered tilt.
a.) Level position with user not affecting controls.
b.) Taper cut position with user manually controlling tilt angle.
c.) Joystick/Direction Pad-Returns to normal when released.
d.) Hand trimmer tilt trigger in normal position A1a.
e.) Hand trimmer trigger engage, changing tilt angle A1b.
   T47. Winch Control-Up and down controls for the winch lifts A13 for storage or lowers for operational use. For an example refer to FIG. 9 A, B, C.
   T48. Volt Meter/Gage/Screen-Allows operator to know how much power is left in the battery. To monitor system parameters such as temp, moisture, and amp draw, etc.
   T49.) Direct drive spindle shaft-Connects motor T1 to spool T12c for use with traditional bump off of the ground spool string setup, but without having to bump off of the ground. Requires activating shaft T24 to use a bushing at activating point on tip of spool T29d to create less friction for rotation to extend string when activated.
a.) Activation slot with pin T4 and activation cone T5 to pull activation pin/bolt upward to disengage locking mechanism within trimmer spool T29.
b.) Setscrew/Spine/Fastener to connect driveshaft to motor T1 to power rotation of drive shaft.
c.) Shaft fastener secures drive shaft to main bearings T
d.) Shaft stop works with fastener T49c to squeeze tightly against main bearing T7d, securing rotating shaft within casing T7.
e.) Area of drive shaft which center and secures within main bearing T7d, fastened between T49c and T49d.
f.) Part of shaft which connects to spool casing at point T12cf.
   T50. Guard-Helps prevents debris/projectiles from hitting operator. Blade built within guard to prevent string T28 from getting too long to function properly.
   T51. Hand trimmer structure/shaft-Mounts and protects but not limited to batteries, controller, throttle, on off switch, charge port.
a.) Rotating base.
b.) Pivot point for trimmer head.
c.) Handle throttle to control motor speed.
d.) Leverage handle.

### T52.

T53. Operator Handle-Area for user to hold and gain leverage, control machine.
T54. User controlled rapid width extension demonstrated in FIG. 72. To reach difficult places, middle of motor assembly slides outward to cut between tight spots.
a.) Normal position resting position.
b.) Operator controlled movement which slides/forces motor assembly outward.
   T55. Joystick controls to operate The weed whacker. Demonstrates what each direction of joystick does to change The weed whacker function.
a.) Normal Position, where operator can push joystick inward to extend string T43b
b.) Joystick direction changes tilt mechanism of trimmer assembly A1.
c.) Joystick direction changes throttle speed of motor T1.
d.) Joystick direction moves middle of trim assembly outward to reach tight places.
e.) Joystick direction controls motor T1 and causes motor to rotate in reverse.
f.) Operator can control motor speed and tilt angle all at once as demonstrated in FIG. 89 C.
   T56. Mounting clamp/Casing for electronic control for non-rotating hand controls which would be used on zero turn, push mower, quadricycle, etc.
a.) Clamping mechanism used to secure controls to mower hand controls.
   T57. Slide Shaft-Transfers power from motor T1 to spool T14 and T12. By sliding, shaft can lock string T28 at length by engaged both spool T14 and T12, rewind string by only engaging spool T14, or increase string length T28 by releasing spool T14 and only engaging T12.
a.) Top of shaft slides within coupler T58.
   a. Normal position, top of shaft placed in middle of coupler T58.
   b. Extending string T28, top of shaft slides upward further into coupler T58 toward motor T1 releasing T57cb from spool T14b.
   c. Rewinding string T28 position. Top of shaft T28 slides downward towards bottom of coupler T58 while still retaining splined connection to transfer power from motor while T47cc releases from T12 to fully engage spool T14b.
b.) Middle of shaft. Indent in shaft with a smaller diameter than T57d to allow bushing T60 to lift or lower shaft.
   c.) Top of indent in shaft to allow two piece bushing T60 to pull shaft upward whenever extending string T28.
   d.) Bottom of indent in shaft to allow two piece bushing T60 to push shaft downward to engage reverse spool wind-up.
c.) Bottom of splined/hex/geared shaft responsible for locking into spool T14b and spool casing T12d to control string extend/string length lock/string rewinding mechanism.
   a.) Normal position. String T28 locked at length.
   b.) In position for increasing string T28 length. Shaft disconnected from spool T14b. Allows spool T14 to spin freely to lengthen string T28.
   c.) In position for rewinding string T28. Shaft is in full contact with spool T14b while disconnected from T12d.
   d.) Taper for bottom of spline T57c assists with re-aligning and re-engaging back into splines/gear at top of spool T14b.
   e.) Smooth area used to disengage from spool casing T12d whenever fully engaging spool T14b for rewinding string.
   f.) Taper for top of spline T57c assists with re-aligning and re-engaging back into the splines/gear located at top of spool casing T12d.
d.) Threads on Shaft-Threads for fastening nut T47e to shaft to mount bushing T60.
   a.) Lock pin hole for securing nut to threads to prevent nut from loosening while rotating.
e.) Lock Pin-Nut for tightening bushing T60 onto shaft T57 at pint T57d.
   a.) Hole for cotter pin on nut to secure at point T47da.
f.) Spacer/Washer-Spacer for helping to secure pushing T60 within/to bearing T6b.
g.) Centering cone for keeping spool T14 centered with shaft T57 whenever T14b disconnects with T57cb.
   T58. Coupler-Centers and rotates around bearing T2a. Motor splined shaft T1d slides/locks into place at top while slide shaft T57a slides up or down within the bottom section of coupler. Coupler is internally splined to match T1d and T57a.
a.) Top of couple rests on bearing T2b between motor.
b.) Fastener applies pressure between T58a and bearing T2b.
c.) Lock pin/set screw for securing nut/fastener to coupler.
d.) Set screw connects coupler to motor shaft T1d
   T59. Main Shaft-physically mounts to bearing T7d within base T7 which connects to spool assembly T12. Does not connect to motor T1 directly like shaft T11 on a different version. Carriage T6 applies friction pressure to top T59a to stop shaft rotation to let spool T14 rewind string T28.
a.) Top of shaft which rests against top of bearing T7d. Carriage T6 moves downward to apply friction to stop shaft rotation so slide shaft T57cr can disengage from T12d to fully engage with spool T14b to allow motor T1r to spin in reverse to rewind string T28.
   a.) Drive shaft friction brake top, creates a surface for carriage friction brake Tod to grab whenever moved downward to stop rotation of drive shaft T59.
b.) Fastener for securing shaft T59 to bearing T7d.
c.) Set screw for fastener. Keeps fastener from vibrating loose.
d.) Drive shaft disc brake used for stopping rotation of shaft T59 for rewinding string T28 with the motor T1.
   a.) Free spinning drive shaft disc rotor for normal cutting operations, caliper T61aa is not clamped against disc rotor.
   b.) Caliper T61ab clamp against disc rotor to stop rotation of drive shaft T59/Spool Casing T12, to allow activation shaft T57 to move vertically downward fully engaging into spool T14b to rewind the string T28r.
e.) Set screw for fastener. Keeps fastener from vibrating loose.
f.) Drive shaft fastener/shaft stop to allow drive shaft T59 to clamp against bearing T7d to secure it to trim assembly A1 while allowing rotational movement of drive shaft T59.
g.) Friction brake
   T60. Two Piece Bushing for locking between flanges T57ba/b while securing to bearing T6b.
a.) Flange for bushing. Rests against T57b and bearing T6b while spacer T57e/f secures against the other side of bearing.
b.) Ring Clip/Fastener
   T61. Drive shaft brake mechanism to stop drive shaft rotation to rewind string T28 around spool T14. Uses friction brakes, caliper for disc brakes, or vbrake, but not limited.
a.) Brake caliper used for clamping against disc T59d to stop rotation of drive shaft T59.
   a.) Unlocked caliper allows free rotation of drive shaft disc T59da.
   b.) Locked caliper clamps against drive shaft rotor T59db to stop rotation of drive shaft T59.
b.) Vbrake/Cantilever brakes used to squeeze against drive shaft T59 to stop rotation of drive shaft for rewind string mechanism.
   a.) Brake pads are released off of drive shaft T59 to allow free rotation during normal use.
   b.) Brake pads squeeze against drive shaft T59 to stop rotation to allow mechanical reversal of spool T14 to rewind the string T28.
   c.) Spring loaded pivot points for braking mechanism, after engaging brakes T61bb, the springs force the pads T61ba outward to allow free rotation of drive shaft T59.
   d.) Cable pivot point for one of the two brake pad arms. When operator rewinds string T28r, this part moves towards cable clamp T61be to stop rotation of drive shaft T59.
   e.) Cable clamp/set screw to allow adjustment and create a stopping point of cable to allow brake mechanism to clamp against drive shaft T59 to stop rotation. When operator rewinds string T28r the distance between T61bd/T61be decreases.
c.) Friction brake placed under bearing carriage T6, which allows free rotation of drive shaft T59 until moved downward applying friction to top of drive shaft T59a to stop rotation so reverse string mechanism can work properly.
   a.) Bearing carriage T6 is in normal operating position or in position to release spool T14 to increase string length. There is a gap between friction brake and top of shaft T59a to allow free rotation of driveshaft.
   b.) Bearing carriage Tor is forced downward to create mechanical friction, stopping rotation of drive shaft T59.
      T62. Steering wheel for tractor.
a.) Center and rotation point of steering wheel for riding lawn mower.
   T63. 360 degree wireless hand control provides The weed whacker controls without the need of a wiring harness. By using a 360 degree pivoting handle, controls can be mounted to a steering wheel on a riding lawn mower where a typical harness would get twisted and bound up whenever turning the wheel. Built into hand controls are a circuit board to control functions, wiring card to send and receive data to The weed whacker, battery for wireless power, on off switch, small screen to display voltage, led light to tell operator if unit is on.
a.) Handle grip for operator allows user to grip hand controls firmly while controlling functions of the weed whacker.
b.) 360 degree swivel point for hand controls. Connects hand grip to wheel mount T63e.
c.) Steering wheel mount connects steering wheel to 360 degree hand controls.
d.) Fastener secures wheel mount to steering wheel by creating ability to tighten mount.
e.) Mount pivot base which connects to 360 degree pivot point, connects to rotation point S63b.

### Caster Assembly

### Section C

C1. Grease Fitting-Lubrication fitting for allowing addition of a lubricant to reduce wear and reduce friction of rotation.
C2. Main Lubricated Shaft-Lubricated shaft which allows caster assembly to rotate 360 degrees. Hollow with holes/slots to allow flow of grease. A disc brake rotor can connect to shaft to stop and control 360 degree rotation.
a.) Fastener for shaft. Can be a nut, cotter pin, lock pin or more. Can be a nut with set screw so user can adjust tension without preventing smooth 360 rotation.
b.) Lubricated bushing helps make 360 degree rotation smooth. Replaceable, helps prevent wear to steel parts.
c.) Spacer for helping to prevent top of caster body C3 from rubbing off of coaster assembly, helping to ensure a smooth 360 degree rotation.
d.) Slotted Brake Disc Rotor-Used for stopping 360 degree rotation of caster. Benefit is for a zero turn going sideways on hillside. By using brakes operator can stop casters from spinning so user can travel horizontally along hillside safely. Slots allow cooling and can be used with a encoder to measure position/direction of wheel and send data back to controller to apply automatic braking to keep caster pointed proper direction while working with operator hand controls used for steering mower/zero turn. As zero turn mower turns, rotor is released to allow natural alignment as encoder/laser reads and deciphers location/direction of wheel, then automatically locks brake caliper C24.
e.) Grease channel-Area for grease to release out of shaft to lubricate housing.
f.) Mounting/feed point for grease fitting-feed point to allow grease to travel/fed through shaft.
   C3. Main Body-Main structure which rotates on shaft C2, controls height at C5 and pivot points C, houses slots C25 & C26, pivot points C20 & C18.
   C4. Spacer—While caster rotates 360 degrees the spacer gives clearance to prevent collision between mounting point and top of body C3.
   C5. Height Presets-Predetermined slots along main structure C3 which allows user to change height accurately and quickly. A spring loaded lock C6 slides into place along slots which is responsible for changing height of wheel C13.
   C6. Spring Loaded Lock Lever-Pull back to release height. Once height is determined release lever and spring will pull it against C5 to lock in place. Lever pivots at point C11 and lock bolt C12 travel along two slides first is slide C7 which assists in moving along slide C10. Connects to spring C21 at point C23.
a.) Locked Position keeps caster in desired height.
b.) Unlocked allowing Height Arms C17 & C19 to move freely
c.) Pivot point connecting to lower arm S17.
   C7. Lock Slot-Slot built within C6 which allows lock bolt C12 to slide up or down while traveling along slot C10 which is mounted to lower arm C17.
   C8. Caster Level Wheel Arm-Connects C17 & C19 to C10. Travels along slots C26 & C25 pivoting from C18 & C20 respectively. Directly changes height of caster by mounting to wheel C13 at point C14.
a.) Lowest height setting.
b.) Middle height setting.
c.) Highest height setting.
   C9. Brushes which rotate along collector ring C28a to transfer electrical current and signal to caster wheel hub motor C13 and to controller/battery.
a.) Wiring harness which transfers current between brushes and wheel hub motor C13.
   C10. Lower Height Arm Lock Slot-Located within Lower Height Arm C17, this slot works with slot C23 to lock and unlock the height arms to change the height of the caster. Limits rotation of C6.
   C11. Lock Pivot Point-Point where height lock pivot to lock and unlock for height adjustment connect to lower arm C17 at point C6c.
   C12. Lock Pin-Travels freely between slot C7 & C10. When unlocked spring elongates C30 naturally pulling back into a predetermined height C5 while shortening spring C21.
a.) Locked position with high already determined and fixed.
   a.) Lowest height setting.
   b.) Middle height setting
   c.) Highest height setting
b.) Unlocked position allowing height to change.
   C13. Caster Wheel-Wheel with lubricated axle. Can be a hub motor to allow for recharging battery, forward assist, or applying brakes.
a.) Hub motor. Works with a collector ring C27 and brushes C9. Optional would allow slotted disc rotor C2d to work with Caliper/Encoder C24 to use a stepper/servo to mimic braking to lock casters at a certain angle for steering assist. A16/A17 pushed forward or backwards will send signal to controller, locking or unlocking caliper C24 so that hub motor within wheel can either assist zero turn with forward, reverse propulsion or braking/regenerative braking on hills or rough terrain. Would make a zero turn four wheel drive. Monitors speed to work with zero turn.
b.) Disc brake-helps with slowing or stopping wheel.
   C14. Wheel Axle-Axle which connects wheel to plate C8.
a.) For a hub motor to recharge battery, the axle will have a slot machined into it to allow wires to transfer safely to center of wheel hub motor.
   C15. Lower Arm to Wheel Mount-Point where lower arm C17 connects to plate C10. Travels along slot C26 for preset max height/lowest height & rigidity.
a.) Mounting point at top of slot C26 for lowest height setting.
b.) Mounting point at middle of slot C26 for height in middle.
c.) Mounting point at lowest point of slot C26 for highest height setting.
   C16. Top Arm to Wheel Plate Mount-Point where top height arm C19 connects to wheel plate C8. Travels along slot C25.
a.) Mounting point at top of slot C25 for lowest height setting.
b.) Mounting point at middle of slot C25 for height in middle.
c.) Mounting point at lowest point of slot C25 for highest height setting.
   C17. Lower Height Arms-Travels along slot C26. Travels parallel to arm C19 to keep plate C10 parallel. Pivot C11 & slot C10 combine with lock C6 & spring C21 to lock & unlock for height adjustment.
   C18. Lower Height Arm Main Pivot Point-Location where Lower Height Arm rotates and mounts on Caster Body C3.
   C19. Upper Height Arms-Works with Lower Height Arms C17 to change the height of casters by moving Main Height Arm C14 along slots C26 & C25.
   C20. Upper Arm Main Pivot Point—Where Upper Height Arm C19 mounts and pivots on Caster body C3.
   C21. Tension Spring-Creates tension on Lock Arm C6 to keep the caster height locked in plate along Height Presets C5.
a.) Normal position with lock arm T6 setting the height.
b.) Tension spring extended by T6 to allow change of height.
   C22. Tensioner Spring Mount-Connects C21 to lower arm C17.
   C23. Spring Mount Slot Lock Lever-Connects tensioner spring C21 to lock arm C6.
   C24. Brake Caliper with or without encoder/laser-Mounts to zero turn or anything which casters shaft C2 mounts to. Responsible for stopping 360 degree rotation of casters. Encoder/laser measures rotation of caster. By sending data back to controller, allowing a caliper to become automated stopping caster at certain angles to allow precision steering with propulsion or braking working with zero turn steering system. Makes downhill or horizontal hills safer.
a.) Hydraulic hose/cable provides pressure squeeze pads C24b against rotor C2d. Operator/User provides pressure through a foot/hand pedal. Can be controlled by automation with electronic controls to apply/release pressure to control steering angle.
b.) Brake pads squeeze and release on/off of rotor C2d to stop rotation.
   C25. Limit Slot-Guides and limits the distance upper arm C19 can travel to change height of caster.
   C26. Limit Slot-Guides and limits the distance lower arm C17 can travel to change height of caster.
   C27. Collector ring is used to send current to hub wheel C13 and controller/battery.
a.) Each individual ring is responsible for a separate wire C27a as brushes C9 rotate along each ring.
b.) Individual wires connect to each collector ring C27a.
c.) Wiring harness of all individual wires C27b which goes to controller/battery.
   C28. Brake Caliper-Used for stopping/slowing caster wheel C13. By using collector ring C27, electronic brakes can be used. Otherwise cable to hydraulic braking require a gyro found on BMX bicycles. Zero turns are dangerous while going downhill. Having the ability to apply brakes to the front casters can help user get machine under control.
   C29. 3rd Slot Mounting Point-Connects lower arm C17 to wheel plate C8. Used on larger casters to help provide structural strength while still providing ability to change height.
   C30. Fastener secures caster shaft to allow 360 degree rotation.
   C31. Caster shaft rotates 360 degrees within C32a/b/c lubricated by grease fitting C1 and bushings C32d/e.
   C32. Height adjustment tube which moves up or down through arms C35 and C36 while in a parallel position. Allows operator to fine adjust cut height to match mower deck cut height.
a.) Caster height set at lowest height position dropping the cut height of trimmer.
b.) Caster height set a slightly lower than highest setting.
c.) Caster height set to highest height setting.
d.) Lower lubricated bushing provides a slippery surface between top of caster for C33 and height adjustment tube C32, creating a smooth surface for caster shaft C31 to rotate.
e.) Upper lubricated bushing provides a slippery surface between top of height adjustment tube C32 and fastener C30, creating a smooth surface for caster shaft C31 to rotate.
f.) Upper mount point for height arm C36 which works with lower mount point C32g to keep caster parallel when changing height.
g.) Lower mount point for height arm C35 which works with upper mount point C32f to keep caster parallel when changing cut height.
   C33. Tradition caster fork which allows rotation of caster wheel C13. Rotates 360 degrees at caster shaft C31.
a.) Caster wheel bolt connects wheel C13 to fork C33.
   C34. Quick release lock pin allows operator/user to remove or secure pin at point C35d into adjustment points C37 to change the cut height of string T28.
a.) Quick release lock pin secured preventing C32 from moving up or down to change height of cut.
b.) Quick release lock pin removed allowing operator/user ability to change height of cut to match mower deck height.
   C35. Lower height arm is used to lock height into desired position. Works with height arm C36 to keep adjustable height tube C32 parallel while changing cutting height. Connects C32 and coaster assembly A2 at points C32g and C38h.
a.) Lowest height position shortens the length of distance between ground and trimmer string T28.
b.) Slightly lower height position than highest height setting.
c.) Highest height setting increases distance between ground and trimmer string T28.
d.) Lock holes provide mounting point for quick release pin C34 to change height at points C37.
   C36. Upper height arm works with lower height arm C35 to keep adjustable height tube C32 parallel whenever operator/user adjusts height of trimmer string T28.
a.) Lowest height position parallel to lower arm C35a.
b.) Slightly lower cutting height than highest height setting parallel to lower arm C35b.
c.) Highest height position parallel to lower arm C35c.
   C37. Height adjustment holes provide ability to change height at point C35d with quick release pin C34. User can choose setting to match cut height with mower deck.
   C38. Adjustable caster angle mount allows operator the ability to change angle orientation of center rotation point caster shaft C31 relative to center of trimmer string rotation T28.
a.) Main pivot/mount point where adjustable caster angle mount mounts to coaster assembly A2
b.) Locked in middle position which aligns C38 with coaster frame A2.
c.) Locked in adjustment position which rotates center of caster shaft C31 towards middle of mower while moving further away from center of rotating string T28.
d.) Adjustment hole which is used in example C38c.
e.) Adjustment hole which would rotate mount further from middle of mower while moving it closer to center of rotating string T28.
f.) Middle mounting hole which is unused when locked in at C38c.
g.) Upper adjustment arm C36 mounting point, where arm pivots to change height.
h.) Lower adjustment arm C35 mounting point, where arm pivots to change height.

What is claimed is:

1. A weed whacker assembly, comprising:
a motor;
a motor mount; the motor being secured to the motor mount, the motor mount defining a carriage guide;
a linear bearing carriage slidably connected to the carriage guide, the linear bearing carriage being movable between an upper position and a lower position within the carriage channel, the linear bearing carriage defining a centering cone channel therein, the linear bearing carriage being biased towards the lower position of the carriage, the centering cone channel having a centering cone therein;
a drive shaft, the drive shaft having a first end portion and a second end portion, the drive shaft being operatively connected to the motor at the first end portion of the drift shaft, the drive shaft passing through the centering cone; the drive shaft defining a pin slot above the centering cone;
a spool assembly, the spool assembly being operatively connected to the second end portion of the drive shaft, the spool assembly having a string spool therein, the string spool having cutting string wound thereon; and
a spool shaft slidably disposed within the drive shaft, the spool shaft having an upper end and a lower end, the upper end of the spool shaft having a pin protruding through the pin slot of the drive shaft, the spool shaft moving between an upper position and a lower position in connection with movement of the linear bearing carriage, the lower end of the spool release shaft engaging the string spool;
whereby upward movement of the linear bearing carriage raises the spool shaft to dispense cutting string from the string spool, and downward movement of the linear bearing carriage lowers the spool shaft.

2. The weed whacker assembly according to claim 1, further comprising an activating arm having a pivot end portion, a free end portion, and a central portion therebetween, the pivot end portion of the activating arm being pivotally secured to the motor mount, the central portion of the activating arm being operatively connected to the linear bearing carriage.

3. The weed whacker assembly according to claim 1, wherein upward movement of the spool shaft disengages the spool shaft from the string spool to permit free rotation of the string spool.

4. The weed whacker assembly of claim 1, wherein upward movement of the spool shaft pulls the string spool upward to dispense cutting string.

5. A weed whacker assembly, comprising:
a motor;
a motor mount; the motor being secured to the motor mount, the motor mount defining a carriage guide;
a coupler secured to the motor shaft;
a drive shaft, the drive shaft having a first end portion and a second end portion, the drive shaft being slidably connected to the coupler at the first end portion of the drift shaft;
a linear bearing carriage slidably connected to the carriage guide, the linear bearing carriage being movable between an upper position and a lower position within the carriage channel, the linear bearing carriage having a bushing therein, the drive shaft being rotatably secured within the bushing at a predetermined position on the drive shaft;
a spool assembly, the spool assembly having a string spool therein, the string spool having cutting string wound thereon, the second end of the drive shaft releasably engaging the spool assembly; and
a hollow shaft surrounding the drive shaft between the linear bearing carriage and the spool assembly, the hollow shaft being connected to the linear bearing carriage and the spool assembly;
whereby maintaining the linear bearing carriage in a central position maintains the engagement of the string spool by the drive shaft and permits free rotation of the spool assembly with the string spool, raising the linear bearing carriage disengages the drive shaft from the string spool to permit free rotation of the string spool to extend the cutting string, and lowering the linear bearing cartridge causes the drive shaft to engage the string spool while pushing the hollow shaft into the spool assembly to resist rotation of the spool assembly to rewind the cutting string.

6. The weed whacker assembly according to claim 5, wherein the drive shaft has a reduced diameter portion, and the bushing is rotatably secured to the reduced diameter portion.

7. The weed whacker assembly according to claim 5, further comprising a brake, the brake selectively engaging the hollow shaft.

8. A weed whacker assembly, comprising:
a motor;
a motor mount; the motor being secured to the motor mount, the motor mount having a bearing secured therein;
a drive shaft, the drive shaft having a first end portion and a second end portion, the drive shaft being operatively connected to the motor at the first end portion of the drift shaft, the first end portion of the drive shaft further passing through the bearing secured to the motor mount;
a spool assembly, the spool assembly being operatively connected to the second end portion of the drive shaft, the spool assembly having a string spool therein;
a first linear slide extending upward from the motor mount;
a linear slide stop disposed at a top portion of the first linear slide stop;
a secondary bearing linear carriage secured to the first end portion of the drive shaft, the secondary bearing linear carriage moving along the first linear slide between an upper position and a lower position;
an activation rod having an upper end and a lower end, the upper end of the activation rod being operatively connected to the secondary bearing linear carriage, the lower end of the activation rod being connected to the string spool; and
a first spring secured on the first linear slide between the first linear slide stop and the secondary bearing linear carriage, the first spring biasing the secondary bearing linear carriage towards its lower position.

9. The weed whacker assembly according to claim 8, further comprising:
a second linear slide extending upward from the motor mount, the linear slide stop extending between a top portion of the first linear slide stop and a top portion of the second linear slide stop; and
a second spring secured on the first linear slide between the second linear slide stop and the secondary bearing linear carriage, the second spring biasing the secondary bearing linear carriage towards its lower position.
